(19) United States
(12) Patent Application Publication
(10) Pub. No.: US 2024/0169317 A1
(43) Pub. Date: May 23, 2024

(54) WORKFLOW ENSEMBLE SYSTEMS

(71) Applicant: Salesforce, Inc., San Francisco, CA (US)

(72) Inventors: Monica Wilkinson, San Rafael, CA (US); Kiona Davies, Oakland, CA (US); Eli Weiner, Berkeley, CA (US); Neil Brady, Indianapolis, IN (US)

(21) Appl. No.: 17/991,578

(22) Filed: Nov. 21, 2022

(51) Int. Cl. G06Q 10/10

(52) U.S. Cl. CPC G06Q 10/103

(57) ABSTRACT

A method of managing a workflow includes generating for a user, a workflow ensemble channel that includes a subset of workflow threads determined for the user from a plurality of workflow channels based on at least one thread-relevance parameter and providing the workflow ensemble channel for display in a user interface on a user computing device of the user. The method further includes determining an action request associated with the user for a workflow thread from among the subset of workflow threads, in which the action request satisfies at least one action-relevance parameter, and responsive thereto, providing the action request for display in the workflow ensemble channel. The method further includes receiving an action response responsive to the action request, and responsive to the action response, updating a response status for the action request, and providing the response status for display in the workflow ensemble channel.

### TECHNICAL FIELD

The present disclosure generally pertains to systems and methods for managing workflows. More specifically, embodiments of the present disclosure pertain to managing workflows using a group-based communication system.

### BACKGROUND

Group-based communication systems provide a communication platform that enables users to communicate with one another, such as to share information and content that may be of interest to one another. A group-based communication system may include a plurality of channels to which various users may be subscribed. The channels may respectively correspond to a topic of interest to a group of users subscribed to the respective channel. Users may share information and content pertaining to a respective channel by posting and accessing the information and content within the respective channel.

As one example, group-based communication systems may be utilized in the workplace. Group-based communication systems may help groups of users stay on the same page and make decisions faster. Improved group-based communication systems may lead to greater collaboration amongst users, increased access to information, and/or faster and better decision-making. These, in turn, may lead to improved productivity, higher quality work outputs, and/or enhanced customer satisfaction.

### SUMMARY

Aspects, features, and advantages of the presently disclosed subject matter are set forth in part in the following summary. Further aspects and advantages may be apparent from the description or through practicing the presently disclosed subject matter.

In one aspect, the present disclosure pertains to methods of managing a workflow. In another aspect, the present disclosure pertains to workflow management systems. In yet another aspect, the present disclosure pertains to non-transitory computer-readable medium storing computer-executable instructions configurable to cause at least one processor to perform a method of managing a workflow.

In some aspects, the techniques described herein relate to a method of managing a workflow, the method including: generating a workflow ensemble channel for a user including a subset of workflow threads from a plurality of workflow channels, the subset of workflow threads for the user based on at least one channel-relevance parameter, wherein the user to has been automatically subscribed to the plurality of workflow channels based on the at least one channel-relevance parameter; providing the workflow ensemble channel for display in a group-based communication system interface on a client device of the user; receiving an action request associated with the user for a workflow thread of the subset of workflow threads; responsive to determining that the action request satisfies at least one action-relevance parameter, providing the action request for display in the workflow ensemble channel, receiving, from the user and via the group-based communication system interface, a user action response to the action request; responsive to the user action response, updating a response status for the action request; and providing the response status for display in the workflow ensemble channel.

In some aspects, the techniques described herein relate to a method, wherein the action request is further provided for display in a workflow channel associated with the workflow thread.

In some aspects, the techniques described herein relate to a method, further including: responsive to the user action response, automatically causing the user to be unsubscribed from a workflow channel associated with the workflow thread.

In some aspects, the techniques described herein relate to a method, further including: determining a swarming indication based on group-based communication system content; and generating the action request responsive to the swarming indication, wherein the action request includes an invitation for the user to join a swarm associated with at least one of the plurality of workflow channels.

In some aspects, the techniques described herein relate to a method, further including: responsive to the user action response, determining a next action request associated with an additional user, wherein the next action request satisfies at an additional action-relevance parameter associated with the additional user; and responsive to determining that the next action request satisfies the additional action-relevance parameter, providing the next action request for display in an additional workflow ensemble channel, the additional workflow ensemble channel having been generated for the additional user, wherein the additional workflow ensemble channel includes the workflow thread, and wherein the action request defines a link in an action chain associated with the workflow and the next action request defines an additional link in the action chain.

In some aspects, the techniques described herein relate to a method, further including: receiving, from the additional user and via the group-based communication system interface, a next action response responsive to the next action request; responsive to the next action response, updating a next response status for the next action request; providing the next response status for display in the workflow ensemble channel for the user; and providing the next response status for display in the additional workflow ensemble channel for the additional user.

In some aspects, the techniques described herein relate to a method, wherein the action request includes a request to approve or reject deal terms.

These and other aspects, features, and advantages thereof are further understood with reference to the following detailed description, the accompanying drawing figures, and the appended claims. The foregoing summary is not intended to identify key features or essential features of the claimed subject matter, nor to limit the scope of the claimed subject matter.

### BRIEF DESCRIPTION OF THE DRAWING FIGURES

Embodiments of the present disclosure are described in detail below with reference to the attached drawing figures, in which:

FIG. 1 schematically depicts one example of an environment within which a group-based communication system may be implemented;

FIG. 2A schematically depicts one example of a user interface for a group-based communication system;

FIG. 2B schematically depicts the user interface of FIG. 2A during a synchronous multimedia collaboration session;

FIG. 2C schematically depicts the user interface of FIG. 2A with a connect-pane having been activated;

FIG. 2D schematically depicts the user interface of FIG. 2A with a collaborative document having been initiated;

FIG. 3 schematically depicts one example of an automation system for a group-based communication system;

FIG. 4A schematically depicts the user interface of FIG. 2A including one example of a workflow ensemble channel;

FIG. 4B schematically depicts an update to a user response status for the workflow ensemble channel depicted in FIG. 4A;

FIG. 4C schematically depicts one example of a workflow-pane corresponding to the workflow ensemble channel depicted in FIGS. 4A and 4B;

FIG. 4D schematically depicts one example of a response history-pane corresponding to the workflow-pane depicted in FIG. 4C;

FIG. 5 schematically depicts one example of a group-based communication system that includes a workflow ensemble system;

FIG. 6A schematically depicts example channel-relevance parameters that may be utilized to build a workflow ensemble channel;

FIG. 6B schematically depicts example thread-relevance parameters that may be utilized to build a workflow ensemble channel;

FIG. 6C schematically depicts example action-relevance parameters that may be utilized to build a workflow ensemble channel;

FIG. 7 schematically depicts one example of a data ensemble for a workflow ensemble channel;

FIG. 8A schematically depicts one example of a workflow channel-builder-interface;

FIG. 8B schematically depicts one example of a workflow ensemble channel-builder-interface;

FIG. 8C schematically depicts one example of ensemble-relevance logic that includes a plurality of ensemble-relevance parameters linked by logical operators;

FIG. 9A shows a flow chart depicting one example of a method of managing a workflow;

FIGS. 9B and 9C shows a flow chart depicting one example of a method of generating a workflow ensemble channel;

FIGS. 9D-9H shows a flow chart depicting another example of a method of generating a workflow ensemble channel;

FIGS. 9I and 9J show a flow chart depicting yet another example of a method of generating a workflow ensemble channel;

FIG. 10 shows a flow chart depicting one example of a method of user subscription management with respect to a workflow ensemble channel;

FIG. 11 shows a flow chart depicting one example of a method of action chain management with respect to a workflow ensemble channel; and

FIG. 12 shows a flow chart depicting one example of a method of workflow swarming with respect to a workflow ensemble channel.

The drawing figures illustrate example embodiments of the presently disclosed subject matter. The claims are not limited to the example embodiments depicted in the drawing figures. The aspects and features depicted in the drawing figures are not necessarily to scale. Repeat use of reference characters in the specification and drawing figures represent the same or analogous aspects or features.

### DETAILED DESCRIPTION

The following detailed description references the accompanying drawing figures that illustrate example embodiments of the presently disclosed subject matter. The present disclosure, including the example embodiments depicted in the drawing figures, describe features, aspects, and advantages of the disclosed subject matter by way of explanation and not limitation. Various modifications, combinations, and variations may be made to the example embodiments or to aspects or features thereof without departing from the scope of the presently disclosed subject matter. Thus, the present disclosure encompasses such modifications, combinations, and variations. The present disclosure provides sufficient detail to enable those skilled in the art to practice the claimed subject matter. The present disclosure is, therefore, not to be taken in a limiting sense. The scope of the invention is defined only by the appended claims, along with the full scope of equivalents to which such claims are entitled.

References to “one example,” “an example,” or “examples,” as well as references to “one embodiment,” “an embodiment,” or “embodiments,” mean that the feature or features being referred to are included in one example, embodiment, instance, or implementation, of the presently disclosed subject matter, or in at least one feature, structure, or act thereof. Separate reference to one example,” “an example,” or “examples,” as well as separate references to “one embodiment,” “an embodiment,” or “embodiments,” do not necessarily refer to the same example or embodiment and are also not mutually exclusive unless so stated and/or except as will be readily apparent to those skilled in the art from the description. For example, a feature, structure, or act described in one example or embodiment may also be included in other examples or embodiments but is not necessarily included. Thus, the presently disclosed subject matter may include a variety of combinations and/or integrations of the examples and embodiments described herein.

The present disclosure provides systems and methods for managing workflows using a group-based communication system. The presently disclosed group-based communication systems include workflow ensemble channels. The workflow ensemble channels include system-generated workflow content that is determined to be relevant and/or timely to a respective user based at least in part on one or more ensemble-relevance parameters. The workflow content that is relevant and/or timely to a respective user may be automatically identified, aggregated, filtered, generated, updated, and/or consolidated based on the ensemble-relevance parameters. The workflow content may include workflow channels, workflow threads, action requests, and/or other contextual information. Workflow ensemble channels that include such workflow automatically generated for the respective users. A user may access the workflow content from the workflow ensemble channel, for example, rather than navigating to the respective workflow channels. In one example, the workflow ensemble channels may be distinctive and/or unique as to respective ones of a plurality of users. For example, the respective workflow ensemble channels may include system-generated workflow content that is distinctive and/or unique as to the respective user.

In one example, the workflow content may include action requests for a user. An action request may include a request for a user to perform a specified action, such as approve or reject deal terms for a contract. A group-based communication system may include numerous action requests for respective users dispersed through various channels. The group-based communication system may generate a workflow ensemble channel for respective ones of the plurality of users, thereby allowing the respective user to access from the workflow ensemble channel, the actions requests and/or other workflow content that is relevant and/or timely to the respective user. For example, the other workflow content may include contextual information that may be helpful to the user when responding to the action request. The action requests and/or other workflow content may be automatically added to the workflow ensemble channel when relevant and/or timely to the user, and the action requests and/or other workflow content may be automatically removed from the workflow ensemble channel when no longer relevant to the user. In one example, a user may be automatically subscribed to a workflow channel when the workflow channel includes relevant workflow content, and the workflow channel and/or relevant workflow content may be added to the user's workflow ensemble channel. Additionally, or in the alternative, a user may be automatically unsubscribed from a workflow channel when the workflow channel does not include relevant workflow content, and the workflow channel and/or workflow content may be removed from the user's workflow ensemble channel.

The presently disclosed group-based communication systems may notify users when it is their turn to contribute to a workflow, such as when it is their turn to perform work and/or to make a decision. In one example, a plurality of action requests may define an action chain for a workflow. The plurality of action requests may be associated with respective ones of a plurality of users. The respective action requests in the action chain may be related to one another in series or parallel. The respective action requests may be added to the respective user's workflow ensemble channel when they become timely for the user, such as when it becomes time for the respective user to respond to the action request. For example, when one user completes an action request, the completed action request may be removed from the user's workflow ensemble channel, and a subsequent action request in the action chain, such as a subsequent action request that depends upon the then-completed action request, may be added to another user's workflow ensemble channel.

In one example, the presently disclosed workflow ensemble channels may allow users to initiate and/or participate in swarming, and or to initiate and/or participate in a swarm. As used herein, the term “swarming invitation” refers to inviting a group of users to participate in responding to an action request. As used herein, the term “swarm” refers to a group of users who accept a swarming invitation to participate in responding to the action request. As used herein, the term “swarming response” may refer to the act of responding to the action request associated with the swarming invitation. As used herein, the term “swarming” refers to the act of participating in a swarm. The group-based communication system may automatically provide a swarming invitation to a group of users based at least in part on one or more ensemble-relevance parameters. For example, the ensemble-relevance parameters may include a subject matter parameter that may indicate one or more types of subject matter, such as one or more areas of subject matter expertise, associated with a respective user. The group-based communication system may automatically identify users to invite to the swarm and automatically provide a swarming request to such users. The swarming invitation may be provided by automatically generating an action request for the respective user and adding the action request to the workflow ensemble channel for the respective user. The user may be automatically subscribed to a workflow channel associated with the swarm, for example, in connection with the swarming invitation and/or responsive to the user providing a swarming response indicating that the user has accepted the swarming invitation. The group-based communication system may automatically generate the workflow channel associated with the swarm, and/or an existing workflow channel may be automatically identified. Users may be unsubscribed from the workflow channel at the conclusion of the swarm, and workflow content associated with the swarm may be removed from the respective workflow ensemble channels.

The system-generated workflow ensemble channels provide a collaborative structure around the process of getting work done, including responding to action requests such as those associated with approving deal terms. The system-generated workflow ensemble channels pull together the people and information needed to perform work at respective points in the workflow, thereby allowing people to get work done collaboratively and more effectively. In one example, the presently disclosed group-based communication systems may generate workflow ensemble channels based on workflow content residing on one or more separate or distinct business management systems. Additionally, or in the alternative, the presently disclosed group-based communication systems may synchronize workflow content with respective business management systems, such as when workflow content is updated, changed, and/or generated.

The presently disclosed workflow ensemble channel may be automatically updated based on changes to workflow content and/or action taken by users. Such changes and/or actions may roll through to the respective workflow channels and action requests. In one example, action taken with respect to one workflow channel may trigger an action request in another workflow channel, or an action request in one workflow channel may depend on action taken in another workflow channel. The respective actions may be automatically added and/or removed from the respective workflow ensemble channels based on ensemble-relevance parameters used to determine whether the workflow content is relevant and/or timely for a respective user. Additionally, or in the alternative, messages and/or events from a collaboration dialogue may automatically trigger changes to a workflow channel, such as adding or removing workflow content to the workflow channel and/or subscribing or unsubscribing users from the workflow channel. Such changes may appear in the respective user's workflow ensemble channel. In one example, collaboration amongst users takes place in-channel or in-thread but may appear to the respective users as taking place in the respective user's workflow ensemble channel. The users may include any number of roles (e.g., approver, observer, worker, collaborator, supervisor, subordinate, or assistant). The ensemble-relevance parameters may provide a basis for adding or removing workflow content as to a respective workflow ensemble channel. Additionally, or in the alternative, the ensemble-relevance parameters may provide a basis for subscribing and/or unsubscribing users from workflow channels. The ensemble-relevance parameters may be a configurable attribute that may be housed in a datastore associated with the group-based communication system and/or a respective business management system. The ensemble-relevance parameters may be user defined and/or based on user action.

The presently disclosed systems and methods for managing workflows provide improvements to group-based communication system technology, including technical benefits to the computing devices utilized to implement group-based communication systems. Because the system-generated workflow content provided to users in the respective workflow ensemble channels is limited to the content that is determined to be relevant and/or timely to a respective user, processing demands are reduced for the servers and other computing devices associated with the group-based communication system. For example, processing demands are reduced at least because the ensemble-relevance parameters focus the processing demands on the content that is determined to be relevant and/or timely to a respective user. As such, the group-based communication system need not process content that does not satisfy the ensemble-relevance parameters. Additionally, the workflow ensemble channels reduce the need for users to switch between channels, which reduces processor capacity associated with repeatedly processing the content associated with the respectively different channels. For example, by providing action requests and contextual information together in a respective user's workflow channel, a user may consume fewer processing resources querying the group-based communication system to search for and access the contextual information associated with the action request. Thus, the presently disclosed systems and methods for managing workflows avoid processing content that a user does not need to see, while also more effectively and more efficiently providing the content that is determined to be relevant and/or timely to a respective user. Further, by automatically unsubscribing users from workflow channels when the workflow channel does not include relevant workflow content, the group-based communication system need not consume processing capacity on such workflow channels. Likewise, the automated features of the presently disclosed system and methods, such as automatically subscribing users to channels that satisfy the workflow relevance parameters, automatically generating action requests and/or swarming invitations, etc., helps focus the processing resources of the group-based communication system on the users, actions, and workflows, or segments thereof, that are determined to be relevant and timely.

Additionally, the presently disclosed systems and methods for managing workflows provide improvements to group-based communication system technology that may include and/or lead to greater collaboration amongst users, increased access to relevant and timely information, increased productivity, and/or faster and better decision-making. The improvements to group-based communication system technology may additionally or alternatively include and/or lead to reduced idle-time in workflow, decreased decision making time, increased collaborative problem solving, improved productivity, higher quality work outputs, and/or enhanced customer satisfaction. These and other advantages or improvements to group-based communication technology may be attributable to one or more of the aforementioned and/or following aspects and features of the presently disclosed systems and methods for managing workflows, including what is desired to be protected by Letters Patent as set forth in the claims.

### I. Group-Based Communication System

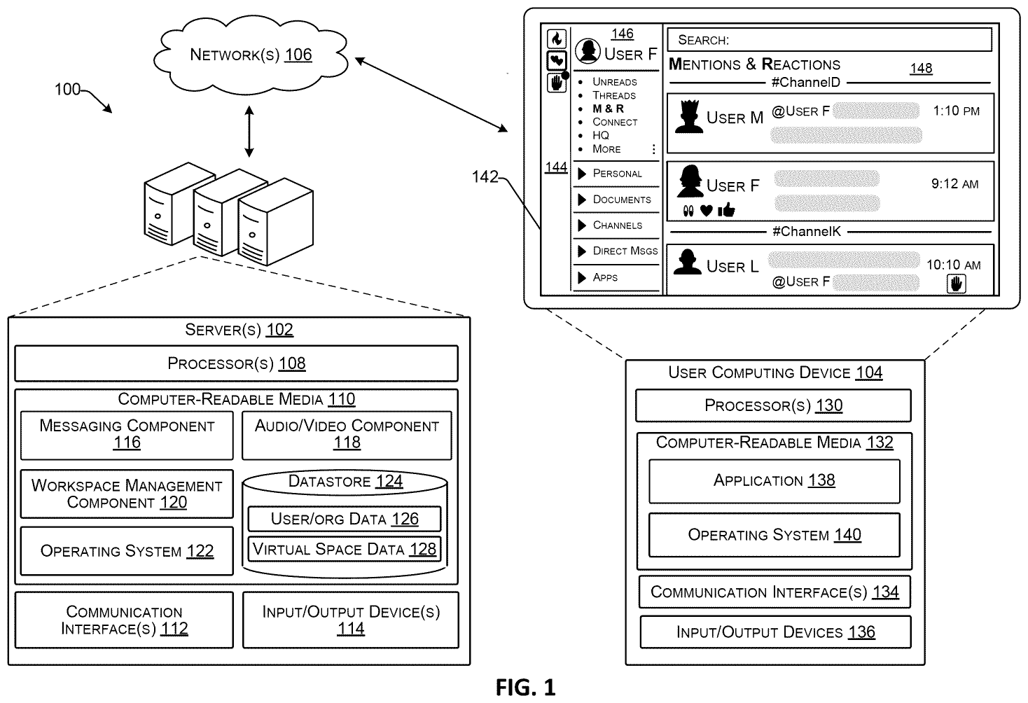

FIG. 1 schematically depicts one example of a group-based communication system 100. The group-based communication system 100 may be associated with a communication platform that may leverage a network-based computing system to enable users of the communication platform to exchange data. In one example, the communication platform may be “group-based” such that the platform, and associated systems, communication channels, messages, collaborative documents, canvases, audio/video conversations, and/or other virtual spaces, have security (that may be defined by permissions) to limit access to a defined group of users. In one example, such groups of users may be defined by group identifiers. The group identifiers may be associated with common access credentials, domains, or the like. In one example, the communication platform may be a hub, offering a secure and private virtual space to enable users to chat, meet, call, collaborate, transfer files or other data, or otherwise communicate between or among one another. As described above, a group may be associated with a workspace, enabling users associated with the group to chat, meet, call, collaborate, transfer files or other data, or otherwise communicate between or among one another in a secure and private virtual space. In one example, members of a group or workspace may be associated with the same organization. In one example, members of a group or workspace may be associated with different organizations (e.g., entities with different organization identifiers).

In one example, the group-based communication system 100 may include one or more servers 102. In one example, the servers 102 may include one or more types of computing devices that may be embodied in any number of ways. For example, the one or more servers may include functional components and data implemented on a single server, a cluster of servers, a server farm or data center, a cloud-hosted computing service, a cloud-hosted storage service, and so forth.

In one example, the servers 102 may communicate with a user computing device 104 via one or more networks 106. The servers 102 and the user computing device 104 may transmit, receive, and/or store data (e.g., content, information, or the like) using the networks 106, as described herein. The user computing device 104 may be any suitable type of computing device, e.g., portable, semi-portable, semi-stationary, or stationary. At least one example of the user computing device 104 may include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the group-based communication system 100 may include multiple (e.g., tens of, hundreds of, thousands of, millions of) user computing devices. In one example, user computing devices, such as the user computing device 104, may be operable by users to, among other things, access communication services via the communication platform. A user may be a person, a group of people, a bot, an employer, an enterprise, an organization, and/or the like.

The one or more networks 106 may include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Particular components included in a network 106 may depend at least in part upon the type of network, the environment selected, or both. Protocols for communicating over such networks 106 are well known and are not described herein in detail.

In one example, the servers 102 may include one or more processors 108, one or more computer-readable media 110, one or more communication interfaces 112, and one or more input/output devices 114.

In one example, the one or more processors 108 may respectively include a single processing unit or multiple processing units and may include single or multiple computing units or multiple processing cores. The processors 108 may be implemented as one or more microprocessors, microcomputers, microcontrollers, digital signal processors, central processing units (CPUs), graphics processing units (CPUs), state machines, logic circuitries, and/or any devices that manipulate signals based on operational instructions. For example, the processors 108 may include one or more hardware processors and/or logic circuits of any suitable type specifically programmed or configured to execute the algorithms and processes described herein. The one or more processors 108 may be configured to fetch and execute computer-readable instructions stored in the computer-readable media. The computer-readable instructions, when executed by the processors 108, may cause the processors to perform the functions described herein.

The computer-readable media 110 may include volatile and/or nonvolatile memory. The computer-readable media 110 may include removable and/or non-removable media. The computer-readable media 110 may be implemented in any type of technology for storage of data, such as computer-readable instructions, data structures, program modules, or other data. The computer-readable media 110 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium capable of storing the desired data and that may be accessed by a computing device. Depending on the configuration of the servers 102, the computer-readable media 110 may be a type of computer-readable storage media and/or may be a tangible non-transitory media to the extent that when mentioned, non-transitory computer-readable media exclude media such as energy, carrier signals, electromagnetic waves, and signals per se.

The computer-readable media 110 may store any number of functional components that are executable by the processors 108. In many implementations, these functional components include instructions or programs that are executable by the processors 108 and that, when executed, specifically configure the processors 108 to perform the actions attributed above to the servers 102. By way of example, the functional components stored in the computer-readable media 110 may include a messaging component 116, an audio/video component 118, a workspace management component 120, an operating system 122, and/or a datastore 124.

In one example, the messaging component 116 may process messages between users. The messaging component 116 may receive an outgoing message from a user computing device 104 and may send the message as an incoming message to a second user computing device 104. The messages may include direct messages 222 sent from an originating user to one or more specified users and/or communication channel messages sent via a communication channel from the originating user to the one or more users associated with the communication channel. Additionally, the messages may be transmitted in association with a collaborative document, canvas, or other collaborative space. In one example, the canvas may include a flexible canvas for curating, organizing, and sharing collections of information between users. In one example, the collaborative document may be associated with a document identifier (e.g., virtual space identifier, communication channel identifier, etc.) configured to enable messaging functionalities attributable to a virtual space (e.g., a communication channel) within the collaborative document. The collaborative document may be treated as, and include the functionalities associated with, a virtual space, such as a communication channel. The virtual space, or communication channel, may provide a data route for exchanging data between and among systems and devices associated with the communication platform.

In one example, the messaging component 116 may establish a communication route between and among various user computing devices, allowing the user computing devices to communicate and share data between and among one another. In one example, the messaging component 116 may manage such communications and/or sharing of data. In one example, data associated with a virtual space, such a collaborative document, may be presented via a user interface. Metadata associated with a message transmitted via the virtual space, such as a timestamp associated with the message, a sending user identifier, a recipient user identifier, a conversation identifier and/or a root object identifier (e.g., conversation associated with a thread and/or a root object), and/or the like, may be stored in association with the virtual space.

In various examples, the messaging component 116 may receive a message transmitted in association with a virtual space (e.g., direct message instance, communication channel, canvas, collaborative document, etc.). In various examples, the messaging component 116 may identify one or more users associated with the virtual space and may cause a rendering of the message in association with instances of the virtual space on respective user computing devices 104. In various examples, the messaging component 116 may identify the message as an update to the virtual space and, based on the identified update, may cause a notification associated with the update to be presented in association with a sidebar of the user interface associated with one or more of the users associated with the virtual space. For example, the messaging component 116 may receive, from a first user account, a message transmitted in association with a virtual space. In response to receiving the message (e.g., interaction data associated with an interaction of a first user with the virtual space), the messaging component 116 may identify a second user associated with the virtual space (e.g., a member of the virtual space). In one example, the messaging component 116 may cause a notification of an update to the virtual space to be presented via a sidebar of a user interface associated with a second user account of the second user. In one example, the messaging component 116 may cause the notification to be presented in response to a determination that the sidebar of the user interface associated with the second user account includes an affordance associated with the virtual space. In such examples, the notification may be presented in association with the affordance associated with the virtual space.

In various examples, the messaging component 116 may be configured to identify a mention or tag associated with the message transmitted in association with the virtual space. In one example, the mention or tag may include an @mention (or other special character) of a user identifier associated with the communication platform. The user identifier may include a username, real name, or other unique identifier associated with a particular user. In response to identifying the mention or tag of the user identifier, the messaging component 116 may cause a notification to be presented on a user interface associated with the user identifier, such as in association with an affordance associated with the virtual space in a sidebar of a user interface associated with the particular user and/or in a virtual space associated with mentions and reactions. The messaging component 116 may be configured to alert a particular user that they were mentioned in a virtual space.

In one example, the audio/video component 118 may be configured to manage audio and/or video communications between and among users. In one example, the audio and/or video communications may be associated with an audio and/or video conversation. In one example, the audio and/or video conversation may include a discrete identifier configured to uniquely identify the audio and/or video conversation. In one example, the audio and/or video component 118 may store user identifiers associated with user accounts of members of a particular audio and/or video conversation, such as to identify users with appropriate permissions to access the particular audio and/or video conversation.

In one example, communications associated with an audio and/or video conversation (“conversation”) may be synchronous and/or asynchronous. The conversation may include a real-time audio and/or video conversation between a first user and a second user during a period of time and, after the first period of time, a third user associated with the conversation (e.g., a member of the conversation) may contribute to the conversation. The audio/video component 118 may be configured to store audio and/or video data associated with the conversation, such as to enable users with appropriate permissions to listen and/or view the audio and/or video data.

In one example, the audio/video component 118 may be configured to generate a transcript of the conversation and may store the transcript in association with the audio and/or video data. The transcript may include a textual representation of the audio and/or video data. In one example, the audio/video component 118 may use known speech recognition techniques to generate the transcript. In one example, the audio/video component 118 may generate the transcript concurrently or substantially concurrently with the conversation. In one example, the audio/video component 118 may generate a textual representation of the conversation, for example, while the conversation is being conducted. In one example, the audio/video component 118 may generate the transcript after receiving an indication that the conversation is complete. The indication that the conversation is complete may include an indication that a host or administrator associated therewith has stopped the conversation, that a threshold number of meeting attendees have closed associated interfaces, and/or the like. The audio/video component 118 may identify a completion of the conversation and, based on the completion, may generate the transcript associated therewith.

In one example, the audio/video component 118 may be configured to cause presentation of the transcript in association with a virtual space with which the audio and/or video conversation is associated. For example, a first user may initiate an audio and/or video conversation in association with a communication channel. The audio/video component 118 may process audio and/or video data between attendees of the audio and/or video conversation and may generate a transcript of the audio and/or video data. In response to generating the transcript, the audio/video component 118 may cause the transcript to be published or otherwise presented via the communication channel. In one example, the audio/video component 118 may render one or more sections of the transcript selectable for commenting, such as to enable members of the communication channel to comment on, or contribute to, the conversation. In one example, the audio/video component 118 may update the transcript based on the comments.

In one example, the audio/video component 118 may manage one or more audio and/or video conversations in association with a virtual space associated with a group (e.g., organization, team, etc.) administrative or command center. The group administrative or command center may be referred to herein as a virtual (and/or digital) headquarters associated with the group. In one example, the audio/video component 118 may be configured to coordinate with the messaging component 116 and/or other components of the servers 102, to transmit communications in association with other virtual spaces that are associated with the virtual headquarters. The messaging component 116 may transmit data (e.g., messages, images, drawings, files, etc.) associated with one or more communication channels, direct messaging instances, collaborative documents, canvases, and/or the like, that are associated with the virtual headquarters. In one example, the communication channels, direct messaging instances, collaborative documents, canvases, and/or the like may have associated therewith one or more audio and/or video conversations managed by the audio/video component 118. The audio and/or video conversations associated with the virtual headquarters may be associated with, or independent of, one or more other virtual spaces of the virtual headquarters.

In one example, the workspace management component 120 may manage one or more workspaces. In one example, the communication platform may be partitioned into different workspaces, which may be associated with different groups of users, as described above. A workspace may be associated with a group identifier and one or more user accounts may be mapped to, or otherwise associated with, the group identifier. Users corresponding to such user accounts may be “members” of the group.

In one example, the workspace management component 120 may manage workspace membership. The workspace management component 120 may receive requests to associate users with respective workspaces and the workspace management component 120 may associate respective user accounts corresponding to such users with group identifiers associated with the respective workspaces. For example, responsive to receiving a request to add a user to a workspace, the workspace management component 120 may associate a user account of the user with a group identifier of the workspace. The workspace management component 120 may disassociate user accounts and group identifiers, for example, when a user is removed from a workspace.

In one example, the workspace management component 120 may manage cross-workspace data integration, as described herein. For example, the workspace management component 120 may detect updates to data associated with a workspace and may integrate such updated data into user interfaces presented via user computing devices of users associated with the workspace. Such data integration may be “cross-workspace” such that, regardless of which workspace a user is logged in to, the user may receive updated data associated with the workspaces of which the user is a member and/or access data associated with the workspaces of which the is a member (pending permissions, as described below). The workspace management component 120 may detect updates to data associated with a workspace and may integrate such updated data into user interfaces presented via user computing devices of users associated with the workspace. Similarly, the workspace management component 120 may facilitate cross-workspace operations. For example, the workspace management component 120 may facilitate messages between workspaces, searches between or across multiple workspaces, and the like. Additional details of operations that may be performed by the workspace management component 120 are described below.

In one example, the operating system 122 may manage the processors 108, the computer-readable media 110, the hardware, the software, etc. of the servers 102.

In one example, the datastore 124 may be configured to store data in a manner that allows the data to be accessed, managed and/or updated. In one example, the datastore 124 may be integrated with the servers 102, as shown in FIG. 1. In other examples, the datastore 124 may be located remotely from the servers 102 and may be accessible to the servers 102 and/or user devices, such as the user computing device 104. The datastore 124 may include multiple databases, which may include the user/org data 126 and/or the virtual space data 128. Additional or alternative data may be stored in the data store and/or one or more other data stores.

In one example, the user/org data 126 may include data associated with users of the communication platform. In one example, the user/org data 126 may store data associated with user profiles (which may also be referred to as “user accounts”) and/or data associated with users, including, but not limited to, one or more user identifiers corresponding to organizations or entities associated with respective users, one or more communication channel identifiers corresponding to communication channels to which the user has been granted access, one or more group identifiers corresponding to groups (or, organizations, teams, entities, or the like) associated with respective users, an indication whether respective users are designated an owner or manager of any communication channels, and/or an indication whether respective users have any communication channel restrictions. Additionally, or alternatively, the user/org data 126 may include a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In one example, the user/org data 126 may include permission data associated with permissions of respective users of the communication platform. In one example, permissions may be set automatically or by an administrator of the communication platform, an employer, enterprise, organization, or other entity that utilizes the communication platform, a team leader, a group leader, or other entity that utilizes the communication platform for communicating with team members, group members, users, or the like. Permissions associated with a respective user may be mapped to, or otherwise associated with, an account or profile within the user/org data 126. In one example, permissions may indicate which users may communicate directly with other users, which channels a user is permitted to access, restrictions on respective channels, which workspaces the user is permitted to access, restrictions on respective workspaces, and the like. In one example, the permissions may support the communication platform by maintaining security for limiting access to a defined group of users. In one example, such users may be defined by common access credentials, group identifiers, or the like, as described above.

In one example, the user/org data 126 may include data associated with one or more organizations of the communication platform. In one example, the user/org data 126 may store data in organization profiles. An organization profile may store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In one example, the virtual space data 128 may include data associated with one or more virtual spaces associated with the communication platform. The virtual space data 128 may include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In one example, the virtual space data may store data associated with respective virtual spaces separately, such as based on a discrete identifier associated with the respective virtual space. In one example, a first virtual space may be associated with a second virtual space. In such examples, first virtual space data associated with the first virtual space may be stored in association with the second virtual space. For example, data associated with a collaborative document generated in association with a communication channel may be stored in association with the communication channel. For another example, data associated with an audio and/or video conversation conducted in association with a communication channel may be stored in association with the communication channel.

A virtual space of the communication platform may be assigned a discrete identifier that uniquely identifies the virtual space. In one example, the virtual space identifier associated with the virtual space may include a physical address in the virtual space data 128 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In one example, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In one example, the datastore 124 may be partitioned into discrete items of data that may be accessed and managed separately. For example, the discrete items of data may include data shards. By using data shards, many technical tasks may be simplified, such as data retention, unfurling (e.g., detecting that message contents include a link, crawling the link's metadata, and determining a uniform summary of the metadata), and integration. In one example, data shards may be associated with organizations, groups (e.g., workspaces), communication channels, users, or the like.

In one example, respective organizations may be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. The organization may be the owner of the database shard and has control over where and how the related data is stored. In one example, a database shard may store data related to two or more organizations (e.g., as in a shared virtual space).

In one example, respective groups may be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. The group may be the owner of the database shard and has control over where and how the related data is stored.

In one example, a virtual space may be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. The communications via the virtual space may be synchronous and/or asynchronous. In one example, a group or organization may be the owner of the database shard and may control where and how the related data is stored.

In one example, respective users may be associated with a database shard within the datastore 124 that stores data related to a particular user account. For example, a database shard may store electronic communication data associated with a respective user, which enables the user to communicate and exchange data with other users of the communication platform in real time or near-real time. In one example, the user may be the owner of the database shard and has control over where and how the related data is stored.

The communication interfaces 112 may include one or more interfaces and hardware components for enabling communication with various other devices (e.g., the user computing device 104), such as over the networks 106 or directly. In one example, the communication interfaces 112 may facilitate communication via Websockets, Application Programming Interfaces (APIs) (e.g., using API calls), Hypertext Transfer Protocols (HTTPs), etc.

The servers 102 may be equipped with various input/output devices 114, such as a display device, various user interface controls (e.g., buttons, joystick, keyboard, mouse, touch screen, etc.), audio speakers, connection ports, and so forth.

In one example, the user computing device 104 may include one or more processors 130, one or more computer-readable media 132, one or more communication interfaces 134, and one or more input/output devices 136.

In one example, the processors 130 may respectively include a single processing unit or multiple processing units and may include single or multiple computing units or multiple processing cores. The processors 130 may include any of the types of processors described above with reference to the processors 108 and may be the same as or different than the processors 108.

The computer-readable media 132 may include any of the types of computer-readable media 132 described above with reference to the computer-readable media 110 and may be the same as or different from the computer-readable media 110. Functional components stored in the computer-readable media may include at least one application 138 and an operating system 140.

In one example, the application 138 may be a mobile application, a web application, or a desktop application, which may be provided by the communication platform, or which may be an otherwise dedicated application. In one example, respective user computing devices associated with the group-based communication system 100 may have an instance or versioned instance of the application 138, which may be downloaded from an application store, accessible via the Internet, or otherwise executable by the processors 130 to perform operations as described herein. The application 138 may be an access point, enabling the user computing device 104 to interact with the servers 102 to access and/or use communication services available via the communication platform. In one example, the application 138 may facilitate the exchange of data between and among various other user computing devices, for example via the servers 102. In one example, the application 138 may present user interfaces, as described herein. In one example, a user may interact with the user interfaces via touch input, keyboard input, mouse input, spoken input, or any other type of input.

A non-limiting example of a user interface 142 is shown in FIG. 1. As illustrated in FIG. 1, the user interface 142 may present data associated with one or more virtual spaces, which may include one or more workspaces. In one example, the user interface 142 may integrate data from multiple workspaces into a single user interface so that the user (e.g., of the user computing device 104) may access and/or interact with data associated with the multiple workspaces that the user is associated with and/or otherwise communicate with other users associated with the multiple workspaces. In one example, the user interface 142 may include a first region 144, or pane, that includes indicators (e.g., user interface elements or objects) associated with workspaces with which the user (e.g., account of the user) is associated. In one example, the user interface 142 may include a second region 146, or pane, that includes indicators (e.g., user interface elements, affordances, objects, etc.) representing data associated with the workspaces with which the user (e.g., account of the user) is associated. In one example, the second region 146 may represent a sidebar of the user interface 142. Additional details associated with the second region 146 and indicators are described below.

In one example, the user interface 142 may include a third region 148, or pane, that may be associated with a data feed (or, “feed”) indicating messages posted to and/or actions taken with respect to one or more communication channels and/or other virtual spaces for facilitating communications (e.g., a virtual space associated with direct message communications, a virtual space associated with events and/or actions, etc.) as described herein. In one example, data associated with the third region 148 may be associated with the same or different workspaces. In one example, the third region 148 may present data associated with the same or different workspaces via an integrated feed. In one example, the data may be organized and/or is sortable by workspace, time (e.g., when associated data is posted or an associated operation is otherwise performed), type of action, communication channel, user, or the like. In one example, such data may be associated with an indication of which user (e.g., member of the communication channel) posted the message and/or performed an action. In examples where the third region 148 presents data associated with multiple workspaces, at least some data may be associated with an indication of which workspace the data is associated with.

In one example, the operating system 140 may manage the processors 130, computer-readable media 132, hardware, software, etc. of the servers 102.

The communication interfaces 134 may include one or more interfaces and hardware components for enabling communication with various other devices (e.g., the user computing device 104), such as over the networks 106 or directly. In one example, the communication interfaces 134 may facilitate communication via Websockets, APIs (e.g., using API calls), HTTPs, etc.

The user computing device 104 may be equipped with various input/output devices 136, such as a display device, various user interface controls (e.g., buttons, joystick, keyboard, mouse, touch screen, etc.), audio speakers, connection ports and so forth.

While techniques described herein are described as being performed by the messaging component 116, the audio/video component 118, the workspace management component 120, and the application 138, techniques described herein may be performed by any other component, or combination of components, which may be associated with the servers 102, the user computing device 104, or a combination thereof.

### A. Example User Interface for a Group-Based Communication System

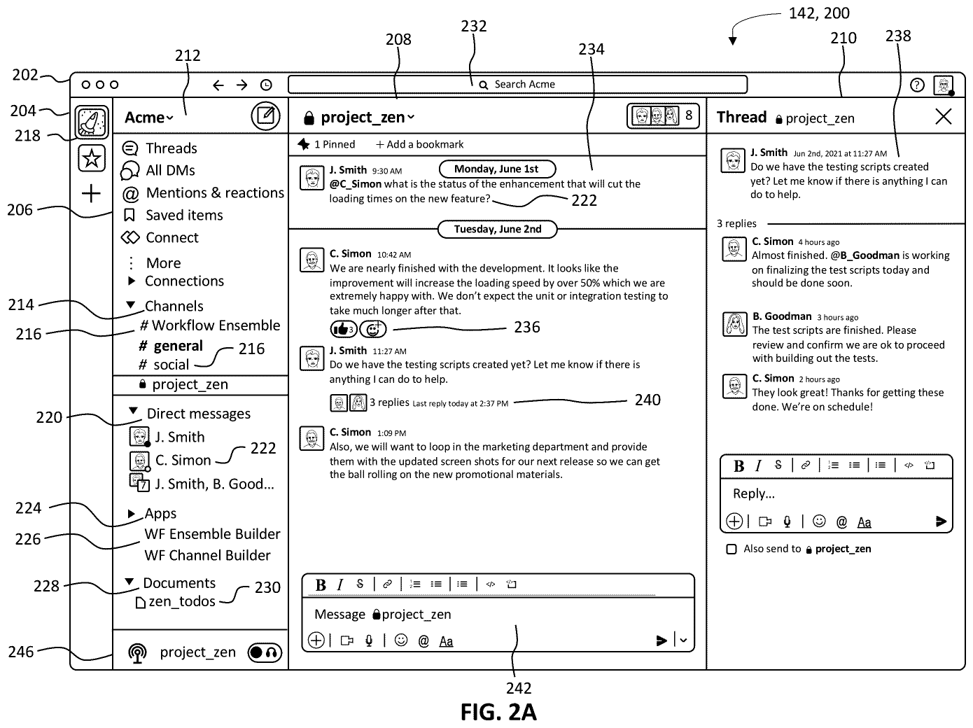

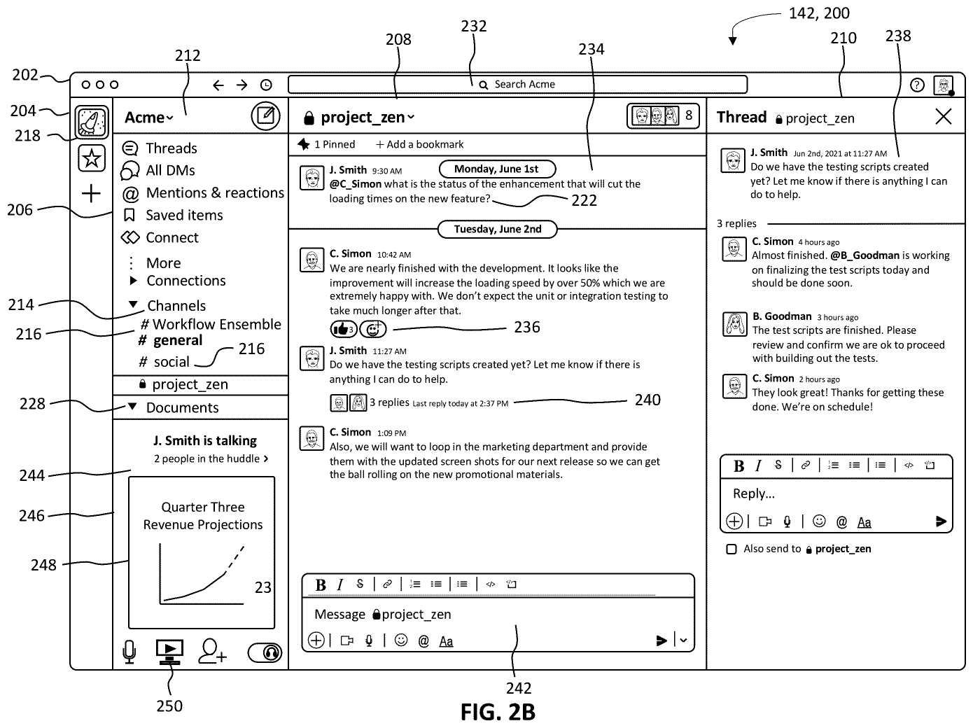

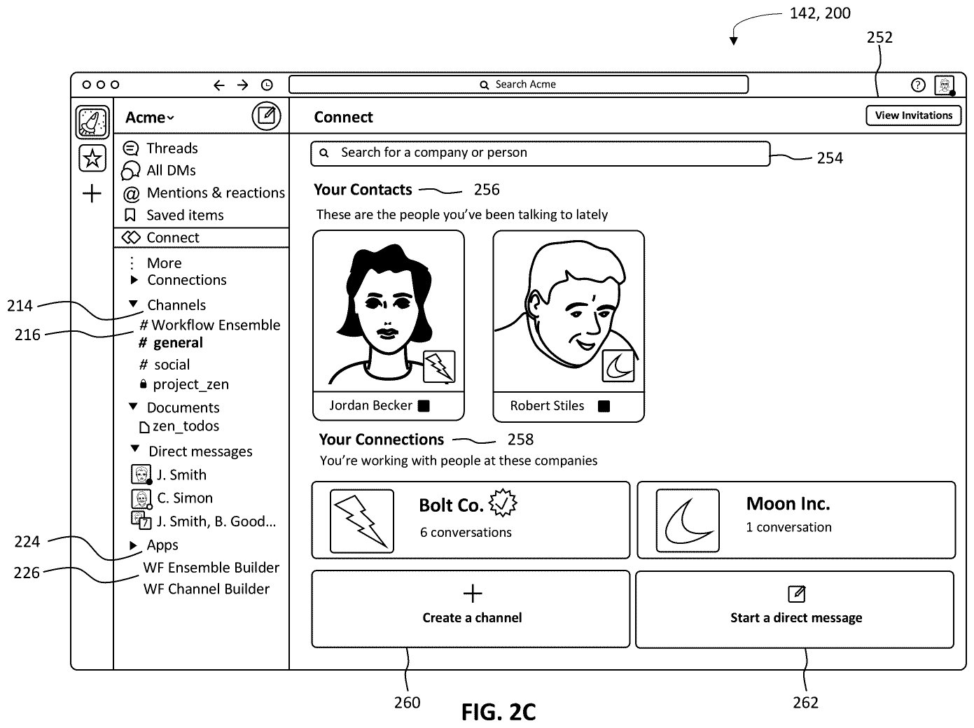

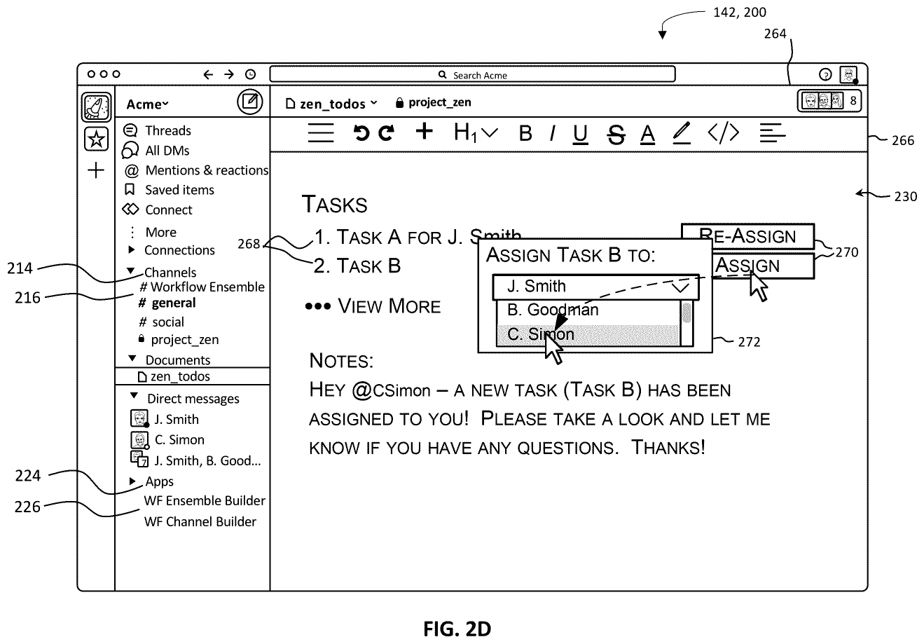

FIG. 2A illustrates a user interface 200 of a group-based communication system 100. The group-based communication system 100 may include communication data such as messages, queries, files, mentions, users or user profiles, interactions, tickets, channels, applications integrated into one or more channels, conversations, workspaces, or other data generated by or shared between users of the group-based communication system. In some instances, the communication data may include data associated with a user, such as a user identifier, channels to which the user has been granted access, groups with which the user is associated, permissions, and other user-specific information.

The user interface 200 may include a plurality of objects such as panes, text entry fields, buttons, messages, or other user interface components that are viewable by a user of the group-based communication system. As depicted, the user interface 200 may include a title bar 202, a workspace-pane 204, a navigation-pane 206, a channel-pane 208, and a thread-pane 210. The workspace-pane 204 allows a user to navigate between various workspaces 212 of the group-based communication system. The navigation-pane 206 allows a user to navigate between various portions of the group-based communication system, such as within a respective workspace 212. In one example, the navigation-pane 206 may include a channels-list 214. The user may select a channel 216 from the channels-list 214, such as from among a plurality of channels 216 associated with the respective workspace 212. In one example, the plurality of channels 216 may include at least one workflow ensemble channel.

In one example, the group-based communication system 100 may include a plurality of workspaces 212. The user may select a workspace 212 from the workspace-pane 204, such as from among a plurality of workspaces 212. The plurality of workspaces 212 may be respectively associated with different groups of users. The workspaces 212 may be respectively associated with a group identifier. One or more user identifiers may be mapped to, or otherwise associated with, the group identifier. Users corresponding to such user identifiers may be referred to as members of the group. In one example, the user interface 200 may include a workspace-pane 204 for navigating between, adding, or deleting various workspaces 212 in the group-based communication system. The user may switch between workspaces 212 by clicking a workspace-button 218 associated with a respective workspace 212. For example, a user may be a part of a workspace 212 for Acme, where the user is an employee of or otherwise affiliated with Acme. The user may also be a member of a local volunteer organization that also uses the group-based communication system 100 to collaborate. To navigate between the two workspaces 212, the user may click the respective workspace-button 218 to change from one workspace 212 to another, such as from the Acme-workspace to the volunteer organization-workspace, as shown. A workspace 212 may include one or more channels 216 that are unique to the workspace 212 and/or one or more channels 216 that are shared between one or more workspaces 212. For example, the Acme company may have one or more channels 216 for respective Acme projects, such as Project Zen, one or more channels 216 for social discussions, and/or one or more channels 216 for general company matters. A user may be associated with one or more of the channels 216 within a workspace 212. In one example, an organization, such as a particular company, may have a plurality of workspaces 212, and the user may be associated with one or more workspaces 212 belonging to the organization. In yet other embodiments, a particular workspace 212 may be associated with one or more organizations or other entities associated with the group-based communication system. In one example, a workflow ensemble channel may be allocated to a workspace 212 that is dedicated to the workflow ensemble channel. A workspace 212 that includes a workflow ensemble channel, such as a workspace that is dedicated to a workflow ensemble channel, may sometimes be referred to as a workflow ensemble workspace.

The navigation-pane 206 may be sorted and organized into hierarchies or sections depending on the user's preferences. In one example, all of the channels 216 to which a user has been granted access may appear in the navigation-pane 206. In other embodiments, the user may choose to hide certain channels 216 or collapse sections containing certain channels 216. Items in the navigation-pane 206 may indicate when a new message or update has been received or is currently unread, such as by bolding the text associated with a channel 216 in which an unread message is located or adding an icon or badge (for example, with a count of unread messages) to the channel name.

In one example, the navigation-pane 206 may include a direct messages-list 220. The user may select a direct message 222 from the direct messages-list 220, such as from among a plurality of direct messages 222. The direct messages 222 may be between a first user and a second user, or between a first user and two or more second users.

In one example, the navigation-pane 206 may include an applications-list 224. The user may select an application 226 from the applications-list 224, such as from among a plurality of applications 226. In one example, the plurality of applications 226 may include a workflow ensemble channel-builder, as shown. Additionally, or in the alternative, in one example, the plurality of applications 226 may include a workflow channel-builder, as shown.

In one example, the navigation-pane 206 may include a collaborative document-list 228. The user may select a collaborative document 230 from the collaborative document-list 228, such as from among a plurality of collaborative documents 230.

In one example, the title bar 202 may include a search bar 232 that may allow users to search for content located in the current workspace 212 of the group-based communication system, such as files, messages, channels, members, commands, functions, and the like. Users may refine their searches by attributes such as content type, content author, and by users associated with the content. Users may search within specific workspaces 212, channels 216, direct message conversations, or documents. In one example, the title bar 202 may include navigation commands allowing a user to move backwards and forwards between different panes, as well as to view a history of accessed content. The title bar 202 may include additional resources such as links to help documents and user configuration settings.

In one example, the group-based communication system 100 may additionally or alternatively store permissions data associated with permissions of respective users of the group-based communication system, indicating which channels 216 a user may view or join. Permissions may indicate, for example, which users may communicate directly with other users, which channels 216 a user is permitted to access, restrictions on respective channels 216, which workspaces 212 the user is permitted to access, and restrictions on respective workspaces 212.

B. Channels within the Group-Based Communication System

In one example, the group-based communication system 100 may include a channel-based platform, as shown in FIG. 2A. Within the group-based communication system, communication may be organized into channels 216. The channels 216 may be respectively dedicated to a particular topic or set of users. Channels 216 are generally long-lasting, persistent discussions of a particular topic. For example, a discussion within a channel 216 may persist for hours, days, months, or years. The discussion within a channel 216 may provide a historical log of user activity. Members of a particular channel 216 may post messages within the channel 216 that are visible to other members of the channel 216 together with other messages in the channel 216. Users may select a channel 216 for viewing to see only those messages relevant to the topic of the channel 216 without seeing messages posted in other channels 216 on different topics. For example, a software development company may have different channels 216 for respective software products being developed. Software developers working on a respective software project may converse on a generally singular topic (e.g., the particular software development project) without noise from unrelated topics (e.g., other software development projects). Because the channels 216 are generally persistent and directed to a particular topic or group, users may conveniently refer to previous communications for reference. In one example, the channel-pane 208 may display information related to a channel 216 that a user has selected in the navigation-pane 206. For example, a user may select the channel 216 named “project_zen” to discuss the ongoing software development efforts for Project Zen. In one example, the channel-pane 208 may include a header that includes information about the channel 216, such as the channel name, the list of users in the channel 216, and other channel controls.

The channel-pane 208 may include one or more messages 234 that respectively include content posted into the channel 216, such as by a user. Users may post text, images, videos, audio, or any other file into the channel 216 as a message 234. In one example, particular identifiers (in messages or otherwise) may be denoted by prefixing them with predetermined characters. For example, channels 216 may be prefixed by the “#” character (as in #project_zen) and username may be prefixed by the “@” character (as in @austin_a). The messages 234 may include an indication of which user posted the message and the time at which the message was posted. In one example, users may react to the messages 234 by selecting a reaction button 236 that allows users to select an icon (sometimes called a reactji), such as a thumbs up, to be associated with the message. Users may respond to the messages 234 of another user with a new message 234.

In one example, channels 216 may be respectively separated into one or more threads 238. A respective thread 238 may aggregate messages related to a particular topic or conversation, for example, to separate high-level messages from detailed messages, and/or to make the topic or conversation easier to follow and to submit replies. A selected thread 238 may be displayed in the thread-pane 210. By displaying the selected thread 238 in the thread-pane 210, the channel-pane 208 may remain uncluttered with content from the detailed portion of the respective topic or conversation of the threads 238. A thread reply preview 240 may be presented under the message 234 that begins the thread 238. The thread reply preview 240 may show information related to the thread 238, such as the number of replies and the members who have replied. Thread replies may appear in the thread-pane 210 that may be separate from the channel-pane 208 and may be viewed by other members of the channel 216 by selecting the thread reply preview 240 in the channel-pane 208.

In one example, one or both of the channel-pane 208 and the thread-pane 210 may include a composition-pane 242 that allows users to compose and transmit messages 234 to the members of the channel 216 or to those members of the channel 216 who are following the thread 238 (e.g., when the message is sent in a thread 238). The composition-pane 242 may have text editing functions such as bold, strikethrough, and italicize. The composition-pane 242 may also allow users to format their messages or attach files such as collaborative documents, images, videos, or any other files to share with other members of the channel 216.

### C. Synchronous Multimedia Collaboration Sessions

FIG. 2B illustrates a user interface 200 of a group-based communication system 100 after a user has elected to initiate or join a synchronous multimedia collaboration session 244. The synchronous multimedia collaboration session 244 may be shown in a synchronous multimedia collaboration session-pane 246. The synchronous multimedia collaboration sessions 244 may provide ambient, ad hoc multimedia collaboration in the group-based communication system. Users of the group-based communication system 100 may conveniently join and leave these synchronous multimedia collaboration sessions at any time, without disrupting the synchronous multimedia collaboration session 244 for other users. In one example, synchronous multimedia collaboration sessions may be based around a particular topic, a particular channel 216, or a set of users, while in other embodiments, synchronous multimedia collaboration sessions may exist without being tied to any channel 216, topic, or set of users.

The synchronous multimedia collaboration session-pane 246 may display a synchronous multimedia collaboration session 244 conducted for a plurality of users in a channel 216, or for one or more users associated with a direct message 222. A synchronous multimedia collaboration session 244 may be started for a particular channel 216 or for a direct message conversation between one or more members of the channel 216. Users may start a synchronous multimedia collaboration session 244 in a channel 216 as a means of communicating with other members of the channel 216 who are presently online. For example, a user may have an urgent decision and want immediate verbal feedback from other members of the channel 216. As another example, a synchronous multimedia collaboration session 244 may be initiated with one or more other users of the group-based communication system 100 through direct messaging. Starting a synchronous multimedia collaboration session 244 allows the user to start an immediate audio and/or video conversation with other members of the channel 216 without requiring scheduling or initiating a communication session through a third-party interface.

Synchronous multimedia collaboration sessions may be short, ephemeral sessions from which no data is persisted. Alternatively, in one example, synchronous multimedia collaboration sessions may be recorded, transcribed, and/or summarized for later review. In other embodiments, contents of the synchronous multimedia collaboration session 244 may automatically be persisted in a channel 216 associated with the synchronous multimedia collaboration session. Members of a particular synchronous multimedia collaboration session 244 may post messages within a thread 238 associated with that synchronous multimedia collaboration session 244 that are visible to other members of the synchronous multimedia collaboration session 244 together with other messages in the thread 238.

The multimedia in a synchronous multimedia collaboration session 244 may include any or all of audio, video, screen sharing, collaborative document editing, whiteboarding, co-programming, or any other form of media. Synchronous multimedia collaboration sessions may also permit a user to share the user's screen with other members of the synchronous multimedia collaboration session. In one example, members of the synchronous multimedia collaboration session 244 may mark-up, comment on, draw on, or otherwise annotate a shared screen. At least some of the content from a synchronous multimedia collaboration session 244 may be saved and persisted after the synchronous multimedia collaboration session 244 has ended.

In one example, a user may start a synchronous multimedia collaboration session 244 via a toggle in the synchronous multimedia collaboration session-pane 246 shown in FIG. 2B. Once a synchronous multimedia collaboration session 244 has been started, the synchronous multimedia collaboration session-pane 246 may be expanded to provide information about the synchronous multimedia collaboration session 244. The information about the synchronous multimedia collaboration session 244 may include how many members are present, which user is currently talking, and/or which user is sharing the user's screen. Additionally, or in the alternative, the information about the synchronous multimedia collaboration session 244 may include a screen share preview 248 that depicts a screen view shared by a user, such as a view of the user's desktop, or a view of a particular application or presentation being shared by the user. Changes to the user's screen, such as the user advancing to the next slide in a presentation, will automatically be depicted in the screen share preview 248. In one example, the screen share preview 248 may be actuated to cause the screen share preview 248 to be enlarged, for example, such that the screen share preview 248 is displayed as a separate pane within the group-based communication system. The synchronous multimedia collaboration session-pane 246 may include tools for the synchronous multimedia collaboration session 244 allowing a user to mute the user's microphone or invite other users. In one example, the synchronous multimedia collaboration session-pane 246 may include a screen share button 250 that allows a user to share the user's screen with other members of the synchronous multimedia collaboration session. In one example, the screen share button 250 may provide a user with additional controls during a screen sharing session. For example, the user may be provided with additional screen share controls to specify which screen to share, to annotate the shared screen, or to save the shared screen.

When no synchronous multimedia collaboration session 244 is active, the synchronous multimedia collaboration session-pane 246 may be associated with a currently selected channel 216 or a currently selected direct message 222, such that when a synchronous multimedia collaboration session 244 is initiated, the synchronous multimedia collaboration session 244 may be associated with the currently selected channel 216 or the currently selected direct message 222. Similarly, when a synchronous multimedia collaboration session 244 is active, the synchronous multimedia collaboration session-pane 246 may be associated with a channel 216 in which the synchronous multimedia collaboration session 244 was initiated. In one example, the synchronous multimedia collaboration session-pane 246 may instead be unassociated with any channels 216 or direct messages 222.

D. Connecting within the Group-Based Communication System

FIG. 2C illustrates a user interface 200 displaying a connect-pane 252 that provides tools and resources for users to connect across different organizations. A respective organization may have a separate (e.g., private) instance of the group-based communication system 100 or may not yet belong to the group-based communication system 100. For example, a first software company may have a joint venture with a second software company with whom they wish to collaborate on jointly developing a new software application. The connect-pane 252 may enable users to determine which other users and organizations are already within the group-based communication system, and to invite those users and organizations currently outside of the group-based communication system 100 to join.

The connect-pane 252 may include a connect search bar 254, a recent contacts-list 256, a connections-list 258, a create-channel button 260, and a direct-message button 262. The connect search bar 254 may allow a user to search for users within the group-based communication system. In one example, only users from organizations that have connected with the user's organization will be shown in the search results. In other embodiments, users from any organization that uses the group-based communication system 100 may be displayed. In still other embodiments, users from organizations that do not yet use the group-based communication may also be displayed, allowing the searching user to invite them to join the group-based communication system. In one example, users may be searched for via their group-based communication system 100 username or their email address. In one example, email addresses may be suggested or autocompleted based on external sources of data such as email directories or the searching user's contact list.

In one example, external organizations as well as respective users may be shown in response to a user search. External organizations may be matched based on an organization name or internet domain, as search results may include organizations that have not yet joined the group-based communication system 100 (similar to searching and matching for a particular user). External organizations may be ranked based in part on how many users from the user's organization have connected with users of the external organization. Responsive to a selection of an external organization in a search result, the searching user may be able to invite the external organization to connect via the group-based communication system.

In one example, the recent contacts-list 256 may display users with whom a user has recently interacted. The recent contacts-list 256 may display the user's name, company, and a status indication. The recent contacts-list 256 may be ordered based on which contacts the user most frequently interacts with or based on the contacts with whom the user most recently interacted. In one example, the recent contacts-list 256 may respectively define an actuatable control that allows the user to initiate an action with the respective one of the contacts on the recent contacts-list 256, such as a direct message 222, an invitation to a channel 216, or other appropriate action.

In one example, the connections-list 258 may display a list of organizations (e.g., companies) with which the user has interacted. For a respective organization, the name of the organization may be displayed along with a logo and an indication of how many interactions the user has had with the organization, for example the number of conversations. In one example, the connections-list 258 may respectively define an actuatable control that allows the user to initiate an organization-wide action, such as sending an organization-wide invitation to a channel 216, displaying recent contacts associated with an organization, or taking any other appropriate organization-wide action.

In one example, the create-channel button 260 allows a user to create a new channel 216 that may be shared between two different organizations. Selecting the create-channel button 260 may allow a user to name the channel 216 and enter a description for the channel 216. In one example, the user may select one or more external organizations or one or more external users to add or invite to the channel 216. In other embodiments, the user may add external organizations or external users to the channel 216 after the channel 216 is created. In one example, the user may elect whether to make the channel 216 private (e.g., accessible only by invitation from a current member of the channel 216).

In one example, the direct-message button 262 allows a user to conveniently start a direct message 222 with external users at an external organization. In one example, the external user identifier at an external organization may be supplied by the user as the external user's username or as the external user's email address. In one example, an analysis of the email domain of the external user's email address may affect the message between the user and the external user. For example, the external user's identifier may indicate (for example, based on an email address domain) that the user's organization and the external user's organization are already connected. In some such embodiments, the email address may be converted to a group-based communication system-username. Alternatively, the external user's identifier may indicate that the external user's organization belongs to the group-based communication system 100 but is not connected to the user's organization. In some such embodiments, an invitation to connect to the user's organization may be generated in response. As another alternative, the external user may not be a member of the group-based communication system 100, and an invitation to join the group-based communication system 100 as a guest or a member may be generated in response.

### E. Collaborative Documents

FIG. 2D illustrates a user interface 200 displaying a collaborative document-pane 264. The collaborative document-pane 264 may include a collaborative document 230 and a collaborative document toolbar 266. The collaborative document-pane 264 may allow users to create and modify a collaborative document 230 simultaneously or asynchronously. The collaborative document 230 may integrate with the group-based communication system 100 and may both initiate workflows and store the results of workflows. In one example, the collaborative document 230 may support editable text and/or objects, including group-based communications system objects, images, files such as audio or video, tasks, tickets, links, messages, and/or events, that may be ordered, added, deleted, and/or modified. In one example, the collaborative document 230 may include an editable text section that members may input, modify, and/or comment on synchronously or asynchronously, such as in a collaborative effort to refine the text.

The collaborative document toolbar 266 may provide the ability to bold, italicize, underline, or otherwise format text, the ability to undo or redo actions, the ability to insert and format pictures and shapes, or any other word processing functionality to modify the content within the collaborative document 230. The collaborative document 230 may include multiple sections that provide different functionality to different users. The collaborative document 230 may be saved to and/or selected from the collaborative document-list 228.

In embodiments, sections of the collaborative document 230 may have individual permissions associated with them. For example, a collaborative document having sections with individual permissions may provide a first user permission to view, edit, or comment on a first section, while a second user does not have permission to view, edit, or comment on the first section. Alternatively, a first user may have permissions to view a first section of the collaborative document, while a second user has permissions to both view and edit the first section of the collaborative document. The permissions associated with a particular section of the document may be assigned by a first user via various methods, including manual selection of the particular section of the document by the first user or another user with permission to assign permissions, typing or selecting an “assignment” indicator, such as the “@” symbol, or selecting the section by a name of the section. In further embodiments, permissions can be assigned for a plurality of collaborative documents at a single instance via these methods. For example, a plurality of collaborative documents each has a section entitled “Group Information,” where the first user with permission to assign permissions desires an entire user group to have access to the information in the “Group Information” section of the plurality of collaborative documents. In embodiments, the first user can select the plurality of collaborative documents and the “Group Information” section to effectuate permissions to access (or view, edit, etc.) to the entire user group the “Group Information” section of each of the plurality of collaborative documents. The collaborative document may include one or more tasks 268 along with one or more corresponding assignment options 270, as shown. An assignment dropdown menu 272 may be displayed in response to a user selecting one of the one or more assignment options 270. For example, the dropdown menu 272 may provide a list of users to whom a task 268 may be assigned.

### F. Automation in the Group-Based Communication System

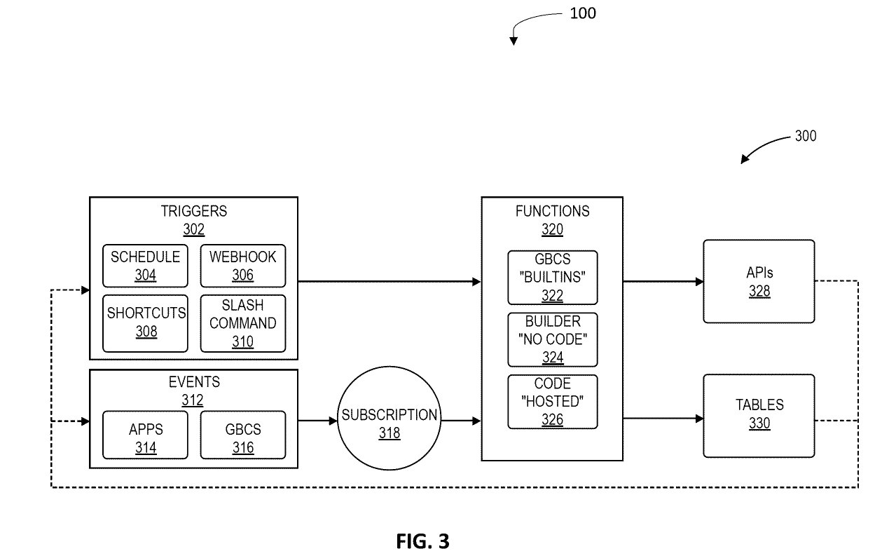

FIG. 3 depicts one example of an automation system 300 that may be utilized with the group-based communication system 100. In various embodiments, the automation system 300 may include triggers 302 that are configured to invoke execution one or more functions 320, for example, responsive to user instructions. A trigger 302 may include and/or operate according to at least one of a schedule 304, a webhook 306, a shortcut 308, or a slash command 310. In one example, the schedule 304 operates like a timer so that a trigger may be scheduled to fire periodically or once at a predetermined point in the future. In one example, an end user of an event-based application may set a schedule for the firing of a trigger 302, such as once-an-hour or every day at a specified time, such as at 9:15 AM.

A webhook 306 is a software component that listens at a webhook URL and port. In one example, a trigger 302 fires when an appropriate HTTP request is received at the webhook URL and port. In one example, a webhook 306 may require proper authentication such as by way of a bearer token. In other embodiments, triggering may be dependent on payload content.

Another source of a trigger 302 is a shortcut 308. In one example, a shortcut 308 may be global to a group-based communication system 100. For example, the shortcut 308 may be agnostic with respect to a channel 216 and/or a workspace 212. Global shortcuts 308 may trigger functions 320 that are able to execute without the context of a particular message or channel 216. Additionally, or in the alternative, a shortcut 308 may be message- or channel-based. Such message- or channel-based shortcut 308 may be specific to a particular message and/or channel 216 and may operate in the context of the particular message or channel 216.

In one example, triggers 302 may be provided by way of slash commands 310. Slash commands 310 may serve as entry points for functions of the group-based communication system 100, integration of the group-based communication system 100 with external services, or message responses for the group-based communication system 100. In one example, slash commands 310 may be entered by a user of a group-based communication system 100 to trigger execution of application functionality. Slash commands 310 may be followed by slash-command-line parameters that may be passed along to any function 320 of the group-based communication system 100 invoked, for example, in connection with a trigger 302.

In one example, a function 320 may be invoked when a respective one of the events 312 matches one or more conditions as predetermined in a subscription 318. Events 312 may be subscribed to by any number of subscriptions 318. The respective subscriptions 318 may specify different conditions and may trigger a different function. In one example, events are implemented as messages of the group-based communication system 100 that are received in one or more channels 216. For example, all events may be posted as non-user visible messages in an associated channel 216, which is monitored by subscriptions 318. App events 314 may be group-based communication system-messages with associated metadata that are created by an application in a channel 216. Events 312 may also be direct messages 222 received by one or more users of the group-based communication system 100, which may be an actual user or a technical user, such as a bot. The term “bot” refers to a technical user of a group-based communication system 100 that automatically performs at least one task or function. A bot may be controlled programmatically to perform various tasks or functions. A bot may monitor and help process activity associated with the group-based communication system 100, such as within respective channels 216 or workspaces 212. A bot may post messages and upload files, react to messages or activity of users, as well as be invited or removed from channels 216 and/or workspaces 212 in the group-based communication system 100.

Events 312 may include any event associated with a group-based communication system 100, such as events 312 relating to the creation, modification, or deletion of a user account in a group-based communication system 100 or events 312 relating to messages in a channel 216, such as creating a message, editing or deleting a message, or reacting to a message. Events 312 may also relate to creation, modification, or deletion of a channel 216 or the membership of a channel 216. Events 312 may also relate to user profile modification or group creation, member maintenance, or group deletion.

Subscription 318 may indicate one or more conditions that, when matched by events, trigger a function 320. In one example, a set of event subscriptions may be maintained in connection with a group-based communication system 100 such that when an event occurs, information regarding the event is matched against a set of subscriptions 318 to determine which (if any) of the functions 320 should be invoked. In one example, the events 312 to which a particular application may subscribe are governed by an authorization framework. In one embodiment, the event types matched against subscriptions may be governed by permission scopes that may be maintained by an administrator of a particular group-based communication system 100.

Functions 320 may be triggered by one or more triggers 302 and/or one or more events 312 to which the respective function 320 is subscribed. Functions 320 may take zero or more inputs, perform processing (potentially including accessing external resources), and may return zero or more results. Functions 320 may be implemented in various forms. The functions 320 may include built-ins 322 associated with the core functionality of a particular group-based communication system 100, such as creating a user or a channel 216. The functions 320 may include no-code builder functions 324 developed by a user of a group-based communication system 100, for example, in connection with an automation user interface such as workflow ensemble channel-builder or a workflow channel-builder. The functions 320 may include hosted-code functions 326 that are implemented by way of applications of the group-based communication system 100 that are developed as software code in connection with a software development environment.

These various types of functions 320 may in turn integrate with APIs 328. In one example, APIs 328 may be associated with third-party services that functions 320 employ to provide a custom integration between a particular third-party service and a group-based communication system 100. Examples of third-party service integrations include video conferencing, sales, marketing, customer service, project management, and engineering application integration. The triggers 302 for such functions 320 may include a slash command 310. The slash command 310 may trigger a hosted-code function 326 that makes an API call to a third-party video conferencing provider by way of one of the APIs 328. As shown in FIG. 3, the APIs 328 may themselves also become a source of any number of triggers 302 or events 312. In one example, completion of a video conference may trigger at least one of the functions 320 to send a message that initiates an API call to the third-party video conference provider to download and archive a recording of the video conference and store the recording in a channel 216.

In addition to integrating with APIs 328, functions 320 may persist and access data in tables 330. In one example, tables 330 are implemented in connection with a database environment associated with a serverless execution environment in which a particular event-based application is executing. In one example, tables 330 may be provided in connection with a relational database environment. In other embodiments, tables 330 are provided in connection with a database mechanism that does not employ relational database techniques. As shown in FIG. 3, in one example, reading or writing certain data to one or more of tables 330, such as data matching one or more predefined conditions, may be a source of one or more triggers 302 or events 312. For example, when tables 330 maintain ticketing data in an incident-management system, a count of open tickets exceeding a predetermined threshold may trigger a message being posted in a channel 216 for incident-management.

### II. Workflow Ensembles

### A. Workflow Ensemble Channels

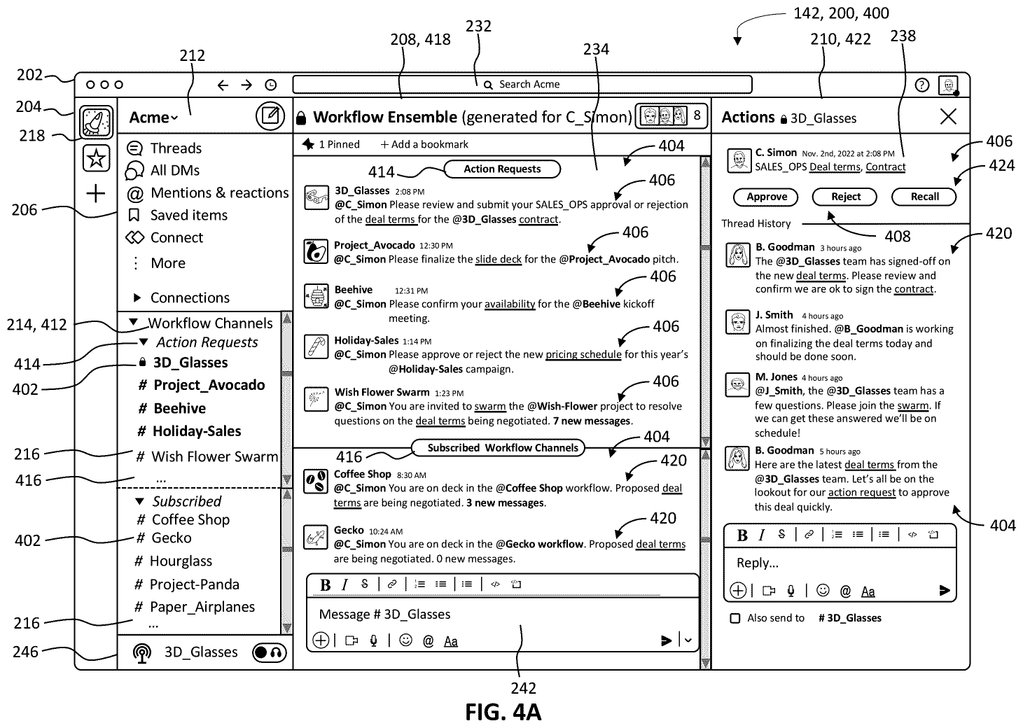

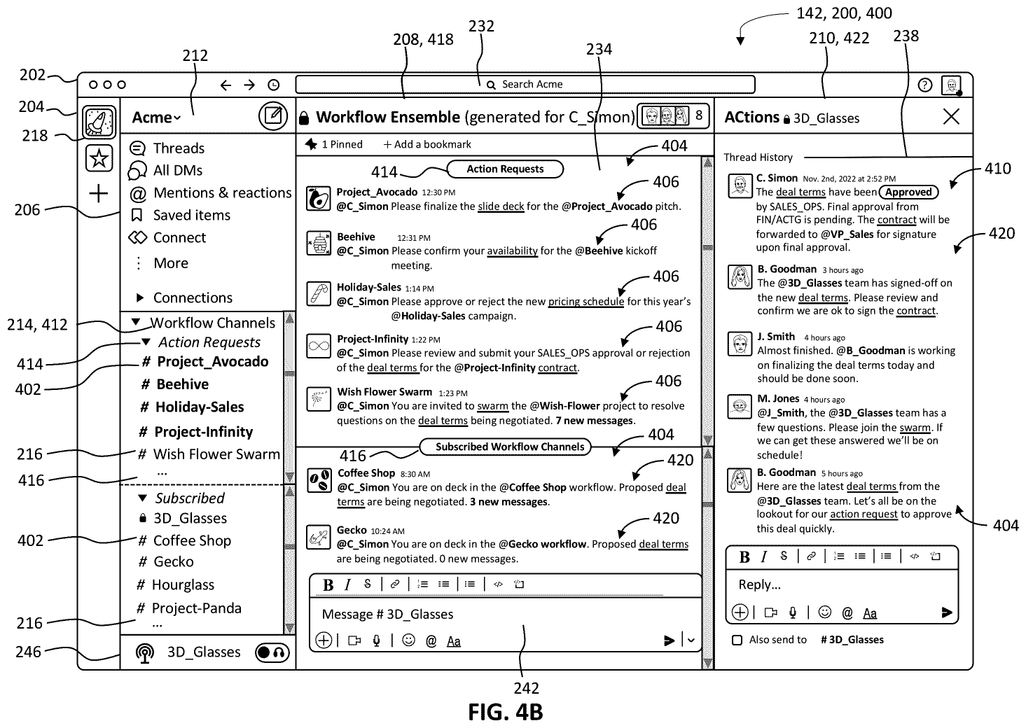

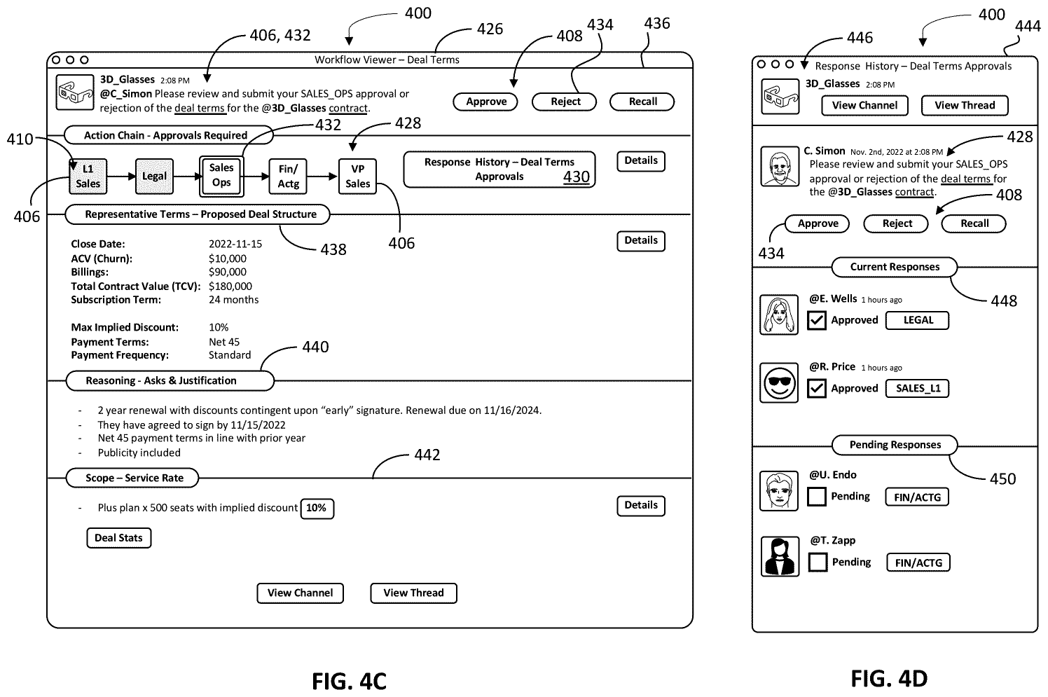

FIGS. 4A-4G schematically depict features of a user interface 200 for a group-based communication system 100 that includes a workflow ensemble channel 400. The workflow ensemble channel 400 may include system-generated workflow content that is automatically determined to be relevant to a respective user based on one or more ensemble-relevance parameters.

A group-based communication system may provide a workflow ensemble channel 400 for display in a user interface 200 that includes system-generated workflow content that is automatically determined to be relevant to a respective user based on the one or more ensemble-relevance parameters. The one or more ensemble-relevance parameters may differ as among respective users of the group-based communication system 100, and as such, the system-generated workflow content included in a respective workflow ensemble channel 400 may differ as among respective users. The respective users may thus receive on their user computing device 104, a workflow ensemble channel 400 that includes system-generated workflow content that differs among respective users at least based on the ensemble-relevance parameters associated with the respective user.

As shown in FIGS. 4A and 4B, the system-generated workflow content may include one or more workflow channels 402, one or more workflow threads 404, and/or one or more action requests 406. In one example, the system-generated workflow content may include one or more action responses 408 and/or one or more response statuses 410 corresponding to a respective action requests 406. The workflow content, including one or more of a workflow channel 402, a workflow thread 404, an action request 406, an action response 408, or a response status 410, may be automatically generated for a respective user based on the one or more ensemble-relevance parameters. The user may be automatically subscribed to workflow channels 402 that satisfy the one or more ensemble-relevance parameters. The workflow channels 402 may be included in the workflow ensemble channel 400. Additionally, or in the alternative, the workflow threads 404, action requests 406, action responses 408, and/or response statuses 410 that satisfy the one or more ensemble-relevance parameters may be included in the workflow ensemble channel 400.

A workflow channel 402 may include workflow content associated with a workflow, such as a process of performing work, providing a service, managing an organization, manufacturing products, processing information, transforming materials, or the like. Additionally, or in the alternative, a workflow channel 402 may include one or more features of the channels 216 described herein with reference to a group-based communication system 100. The workflow channels 402 included in a workflow ensemble channel 400 may define a subset from among a plurality of workflow channels 402. The subset of workflow channels 402 included in a workflow ensemble channel 400 for a respective user may satisfy the one or more ensemble-relevance parameters associated with the respective user.

A workflow thread 404 may include workflow content associated with a particular topic or conversation pertaining to a workflow channel 402. For example, a workflow thread 404 may include workflow content associated with one or more tasks, steps, actions, milestones, deliverables, schedules, budgets, or the like. Additionally, or in the alternative, a workflow thread 404 may include one or more features of the threads 238 described herein with reference to a group-based communication system. The workflow threads 404 included in a workflow ensemble channel 400 may define a subset from among a plurality workflow threads 404. The subset of workflow threads 404 included in a workflow ensemble channel 400 for a respective user may satisfy the one or more ensemble-relevance parameters associated with the respective user. The subset of workflow threads 404 included in a workflow ensemble channel 400 may correspond to one or more workflow channels 402. For example, a respective workflow channel 402 that is included in the workflow ensemble channel 400 may have at least one workflow thread 404 that is included in the workflow ensemble channel 400. In one example, a subset of workflow threads 404 may be automatically generated from a plurality of workflow channels 402. Additionally, or in the alternative, the subset of workflow threads 404 may include a plurality of workflow threads 404 generated by the system or reproduced from a respective workflow channel 402.

An action request 406 may be associated with a respective user and/or with a respective workflow thread 404. An action request 406 may define a portion of a workflow thread 404. Alternatively, an action request 406 may be provided separately from a workflow thread 404, such as in the case of an impromptu request, such as from one user to another. In at least one example, a workflow thread 404 may include a plurality of action requests 406 respectively corresponding to one or more tasks, steps, actions, milestones, deliverables, schedules, budgets, or the like that are associated with the workflow thread 404. The plurality of action requests 406 may be specified for performance in a particular sequence. A workflow thread 404 may include one or more action requests 406 that are assigned to a respective user, such as for completion or oversight by the user. Additionally, or in the alternative, the workflow thread 404 may include one or more action requests 406 that are relevant to the respective user, though not specifically assigned to the user. For example, a workflow ensemble channel 400 for a first user may include a first one or more action requests 406 that are assigned to the first user and a second one or more action requests 406 assigned to a second user. The first one or more action requests 406 may precede, follow, or depend upon the second one or more action requests 406. Additionally, or in the alternative, the second one or more action requests 406 may precede, follow, or depend upon the first one or more action requests 406.

The action requests 406 included in a workflow ensemble channel 400 may define a subset from among a plurality of action requests 406. The subset of action requests 406 included in a workflow ensemble channel 400 for a respective user may satisfy the one or more ensemble-relevance parameters associated with the respective user. The subset of action requests 406 included in a workflow ensemble channel 400 may correspond to one or more workflow threads 404. For example, a respective workflow thread 404 that is included in the workflow ensemble channel 400 may have at least one action request 406 that is included in the workflow ensemble channel 400. In one example, a subset of action requests 406 may be automatically generated from a plurality of workflow threads 404, such as from the subset of workflow threads 404 included in the workflow ensemble channel 400. Additionally, or in the alternative, the subset of action requests 406 may include a plurality of action requests 406 generated from a respective workflow thread 404.

An action response 408 may include an indication of a user response to an action request 406. By way of example, an action request 406 may include a request for a user to approve or reject an action, and the action response 408 may include an indication from the user that the action request 406 is approved or rejected. As another example, an action request 406 may include a request for a user to complete an action, and the action response 408 may include an indication form the user that the action request 406 is complete, in progress, not yet started, postponed, flagged for follow-up, or the like. A response status 410 may include a current status of an action request 406. The current status of an action request 406 indicated by a response status 410 may include in-queue, pre-queue, or post-queue. An action request 406 that has a response status 410 of “in-queue” may indicate that the action request 406 has been provided to a respective user's workflow ensemble channel 400. An action request 406 that has a response status 410 of “pre-queue” may indicate that the action request 406 remains in queue, for example, with a contingency upon, or with a sequence that follows, one or more other action requests 406. An action request 406 that has a response status 410 of “post-queue” may indicate that the respective user has submitted an action response 408 to the action request 406, such as an action response 408 indicating that the action request has been completed. In one example, the response status 410 may include an indication of the action response 408, such as whether the respective user completed or postponed the action request 406, whether the respective user approved or rejected the action request 406, or the like. An action request 406 that has a response status 410 of “pre-que” or “post-queue” may nevertheless be included in a respective user's workflow ensemble channel 400, for example, provided that the action request 406 satisfies the one or more ensemble-relevance parameters. Additionally, or in the alternative, action responses 408 and/or response statuses 410 that satisfy the one or more ensemble-relevance parameters may be included in the respective user's workflow ensemble channel 400.

As shown in FIGS. 4A and 4B, the one or more workflow channels 402 may be included in a channels-list 214, such as a workflow channels-list 412. The channels-list 214 or workflow channels-list 412 may be included in the navigation-pane 206. In one example, the workflow channels-list 412 may include an action requests-list 414 that identifies workflow channels 402 that have at least one action request 406, such as an action request 406 requiring an action response 408 from the user. By way of example, the action requests-list 414 indicates that the user has action request 406 requiring action response 408 with respect to at least the following workflow channels: 3D_Glasses, Project_Avocado, Beehive, Holiday-Sales, and Wish-Flower Swarm. The workflow channels-list 412 may include a subscribed-list 416 that identifies workflow channels 402 have been subscribed to, but that do not have an action request 406, such as an action request 406 requiring an action response 408 from the user. By way of example, the subscribed-list 416 indicates that, in addition to the workflow channels 402 shown in the action requests-list 414, the user has been automatically subscribed to at least the following workflow channels: Coffee Shop, Gecko, Hourglass, Project-Panda, and Paper_Airplanes.

The workflow threads 404 that satisfy the ensemble-relevance criteria may be included in a channel-pane 208, such as a workflow ensemble channel-pane 418. Workflow threads 404 corresponding to one or more workflow channels 402 may be provided in the channel-pane 208 or workflow ensemble channel-pane 418. For example, workflow threads 404 corresponding to a workflow channel 402 selected from the workflow channels-list 412 may be provided in the workflow ensemble channel-pane 418. Additionally, or in the alternative, a plurality of workflow threads 404 respectively corresponding to a plurality of workflow channels 402 may be provided in the workflow ensemble channel-pane 418.

The workflow threads 404 may include one or more workflow messages 420 associated with the respective workflow thread 404. For example, the one or more workflow messages 420 may include direct messages 222 among users. Additionally, or in the alternative, the one or more workflow messages 420 may include action requests 406, and/or direct messages 222 associated with the action requests 406. In one example, the one or more workflow messages 420 may be automatically generated, such as by a bot. For example, the action requests 406 and/or the direct messages 222 associated with the action requests 406 may be automatically generated.

In one example, the action requests 406 included in a workflow ensemble channel-pane 418 may be sorted or separated from other workflow messages 420. As shown in FIGS. 4A and 4B, the workflow ensemble channel-pane 418 may include an action requests-list 414 that includes a plurality of action requests 406 corresponding, for example, to respective ones of a plurality of workflow channels 402. By way of example, the action requests-list 414 shown in the workflow ensemble channel-pane 418 includes workflow threads 404 that include an action request 406 corresponding to at least the following channels: 3D_Glasses, Project_Avocado, Beehive, and Holiday-Sales, and Wish Flower Swarm. Additionally, or in the alternative, the workflow ensemble channel-pane 418 may include a subscribed-list 416 that includes a plurality of workflow messages 420, such as direct messages 222 associated with the action requests 406. By way of example, the subscribed-list 416 shown in the workflow ensemble channel-pane 418 includes workflow threads 404 corresponding to at least the following channels: Coffee Shop, and Gecko.

An action requesting 406 may be selected by a user. When selected, the action request 406 may be displayed in a thread-pane 210, such as an actions-pane 422. If no action request 406 has been selected, the actions-pane 422 may display an action request 406 by a default selection. The default selection may be applied to an action request 406 that satisfies a priority ranking, such as an action request 406 that is determined to be a top priority, for example, based on the one or more ensemble-relevance criteria. By way of example, the actions-pane 422 includes an action request 406 for the workflow thread 404 corresponding to the workflow channel 402 titled 3D_Glasses. As shown, the action request 406 requests approval or rejection of deal terms for a contract. The action request 406 may include hyperlinks to contextual information. For example, as shown, the deal terms and the contract may be accessed by hyperlinks included in the action request 406. The hyperlinks may be automatically generated, such as by a bot. The hyperlinks may provide context associated with the action request 406 that may be helpful for a user when responding to the action request 406.

The actions-pane 422 may include for an action request 406, one or more action response-options 424. By way of example, the one or more action response-options 424 include buttons that are respectively operable to approve or reject the action request 406. Clicking the respective button may be operable to submit an action response 408 responsive to the action request 406. As shown, in one example, the one or more action response-options 424 may include a button operable to recall an action response 408. Additionally, or in the alternative, the actions-pane 422 may include one or more workflow messages 420 associated with the action request 406 shown in the actions-pane 422. The workflow messages 420 may include a thread history associated with the action request 406. The workflow messages 420 may provide context associated with the action request 406 that may be helpful for a user when responding to the action request 406.

As shown in FIG. 4B, when the user submits an action response 408, the workflow ensemble channel 400 may include a response status 410. The response status 410 may be included in a workflow message 420 displayed, for example, in the actions-pane 422. For example, the response status 410 may be added to the thread history for the action request 406 shown in the actions-pane 422. The response status 410 indicates that the deal terms have been approved. As shown, the workflow channel 402 titled 3D_Glasses has been automatically moved from the action requests-list 414 to the subscribed-list 416, and the action requests-list 414 in the workflow channels-list 412 and the workflow ensemble channel-pane 418 has been updated to include a workflow thread 404 corresponding to a workflow channel 402 titled Project-Infinity. The actions-pane 422 continues to display the thread history corresponding to the action request 406 associated with the workflow channel 402 titled 3D_Glasses, including the response status 410 for the action request 406. A next action request 406 may be subsequently displayed in the actions-pane 422, for example, upon being selected by the user.

As depicted in FIGS. 4A and 4B, in one example, a user may initiate a swarm, and one or more users may be requested to join the swarm. A workflow channel 402, a workflow thread 404, and/or an action request 406 may be generated for the swarm. A request to join a swarm may be presented in a workflow ensemble channel 400, such as in the form of a workflow channel 402, a workflow thread 404, and/or an action request 406. By way of example, FIGS. 4A and 4B include a workflow channel 402 titled Wish Flower Swarm. As shown, the workflow ensemble channel-pane 418 may include workflow thread 404 associated with the swarm. By way of example, the workflow ensemble channel-pane 418 shown in FIGS. 4A and 4B includes a workflow thread 404 associated with the workflow channel 402 titled Wish Flower Swarm. The workflow thread 404 includes an action request 406 inviting the user to join the swarm. In one example, a user may initiate a swarm associated with an action request 406, and one or more users may be requested to join the swarm. The swarm may be included in the thread history for the action request 406. By way of example, actions-pane 422 shown in FIGS. 4A and 4B includes a swarm associated with an action request for the 3D_Glasses channel.

Referring to FIG. 4C, in one example, a user may access a workflow-pane 426 that includes various items of workflow content associated with a respective workflow thread 404. The workflow content in the workflow-pane 426 may provide context that may be helpful to users when responding to action requests 406. The workflow content may be automatically generated for inclusion in the workflow-pane 426, for example by a bot, and/or by one or more triggers 302 (FIG. 3). Additionally, or in the alternative, the workflow content may be automatically generated based at least in part on one or more ensemble-relevance criteria. The workflow-pane may be accessed by clicking a hyperlink displayed in association with the respective workflow channel 402, workflow thread 404, or action request 406. By way of example, FIG. 4C shows an example workflow-pane 426 corresponding to the workflow thread 404 associated with deal terms for the workflow channel 402 titled 3D_Glasses. The workflow-pane 426 shown in FIG. 4C may be accessed via a hyperlink titled “deal terms” displayed in the actions-pane 422 (FIGS. 4A and 4B) for the workflow channel 402 titled 3D_Glasses.

As shown in FIG. 4C, in one example, the workflow-pane 426 may include an action chain 428. The action chain 428 may include a sequence or chain of action requests 406 associated with a workflow. The action chain 428 may include a plurality of action requests 406 that respectively define a link in the sequence or chain. The plurality of action requests 406 may be related to one another in series and/or parallel. For example, the action chain 428 shown in FIG. 4C includes a plurality of action requests 406 that are related to one another in series. By way of example, the action chain 428 pertains to a workflow thread 404 that includes a plurality of action requests 406 for approval or rejection of deal terms for a contract associated with the workflow channel 402 titled 3D_Glasses. The action chain 428 may include a response status 410 of one or more action requests 406 that have received an action response 408. For example, as shown in FIG. 4C, the response status 410 for action requests 406 that have received an action response 408 is indicated by shading, and action requests 406 that are awaiting an action response 408 are unshaded. In one example, a response history for the action chain 428 may be accessible from the workflow-pane 426, for example, by clicking a response history-button 430.

In one example, the workflow-pane 426 may include an indication of an action request 406 that is currently awaiting an action response 408 in the action chain 428, which may sometimes be referred to as a current-action request 432. A current-action request 432 may be conspicuously identified for example, by a distinctive border, highlighting, or the like, such as by a double-lined border as shown in FIG. 4C. Additionally, or in the alternative, the current-action request 432 in the action chain 428 may be displayed in a current-action request-pane 436. The current-action request 432 may be accompanied by one or more action response-buttons 434 corresponding to respective action responses 408 available for the current-action request 432. The current-action request-pane 436 may be displayed in the workflow-pane 426 for a user that has a current-action request 432 in the action chain 428. The current-action request-pane 436 may be omitted from the workflow-pane 426 for a user that does not have a current-action request 432, and/or the current-action request-pane 436 may be removed for a user upon having submitted an action response 408 to the current-action request 432.

In one example, the workflow-pane 426 may include an indication one or more terms associated with the respective workflow thread 404, which are sometimes referred to as representative terms 438. The representative terms 438 may be individually or collectively representative of one or more features of the respective workflow, and may include one or more terms that are considered basic, fundamental, essential, key, or the like. By way of example, the representative terms 438 shown in FIG. 4C includes a representation of a proposed deal structure for a contract associated with the workflow channel 402 titled 3D_Glasses.

In one example, the workflow-pane 426 may include an indication of a basis, an explanation, or a reasoning for one or more terms associated with the respective workflow thread 404, such as for the representative terms 438. The indication of such a basis, explanation, or reasoning may sometimes be referred to as workflow reasoning 440. By way of example, as shown in FIG. 4C, the workflow reasoning 440 may include one or more requests or “asks” and/or a justification for making or granting such requests or “asks” with respect to the proposed deal structure for the contract associated with the workflow channel 402 titled 3D_Glasses.

In one example, the workflow-pane 426 may include an indication of scope associated with the respective workflow thread 404, which may sometimes be referred to as a workflow scope 442. By way of example, as shown in FIG. 4C, the workflow scope 442 may include a service rate for the contract associated with the workflow channel 402 titled 3D_Glasses, such as a number of users to be serviced and/or a discount to be applied to the service fee.

In one example, the representative terms 438, the workflow reasoning 440, and/or the workflow scope 442 may be input by a user and/or automatically generated for inclusion in the workflow-pane 426. For example, at least a portion of the representative terms 438, the workflow reasoning 440, and/or the workflow scope 442 may be input by way of one or more workflow messages 420, such as messages associated with the workflow thread 404 or workflow channel 402. Additionally, or in the alternative, at least a portion of the representative terms 438, the workflow reasoning 440, and/or the workflow scope 442 may be automatically generated, for example, based at least in part on one or more workflow messages 420. For example, an action response 408 to an action request 406 that was previously approved may be included in the representative terms 438. Additionally, or in the alternative, a workflow message 420 that includes reasoning for the action request 406 or action response 408 may be included in the workflow reasoning 440. Additionally, or in the alternative, a workflow message 420 and/or an action response 408 to an action request 406 that was previously approved may be included in the workflow scope 442.

FIG. 4D shows an example response history-pane 444 that includes a response history 446 for one or more action requests 406 and/or action responses 408 associated with a respective workflow thread 404. The response history 446 may include or correspond to one or more of the action requests 406 and/or action responses 408 included in the workflow-pane 426. The response history 446 may include a response status 410 for one or more of the action requests 406 and/or action responses 408. By way of example, the response history-pane 444 shown in FIG. 4D includes a response history 446 corresponding to the workflow thread 404 associated with deal terms for the workflow channel 402 titled 3D_Glasses. The response history 446 shown in FIG. 4D may be accessed via a response history-button 430 included, for example, in the workflow-pane 426, as shown in FIG. 4C.

The response history 446 may include a current response-list 448. The current response-list 448 may include a list of one or more action responses 408 and a response status 410 for the respective action responses 408. Additionally, or in the alternative, the response history 446 may include a pending response-list 450. The pending response-list 450 may include a list of one or more action requests 406 that are awaiting a response, for example, as indicated by a response status 410 for the respective action request 406. Additionally, or in the alternative, the response history 446 may include a current-action request 432, for example, along with one or more action response-buttons 434 corresponding to action responses 408 respectively available for the current-action request 432.

### B. Workflow Ensemble System

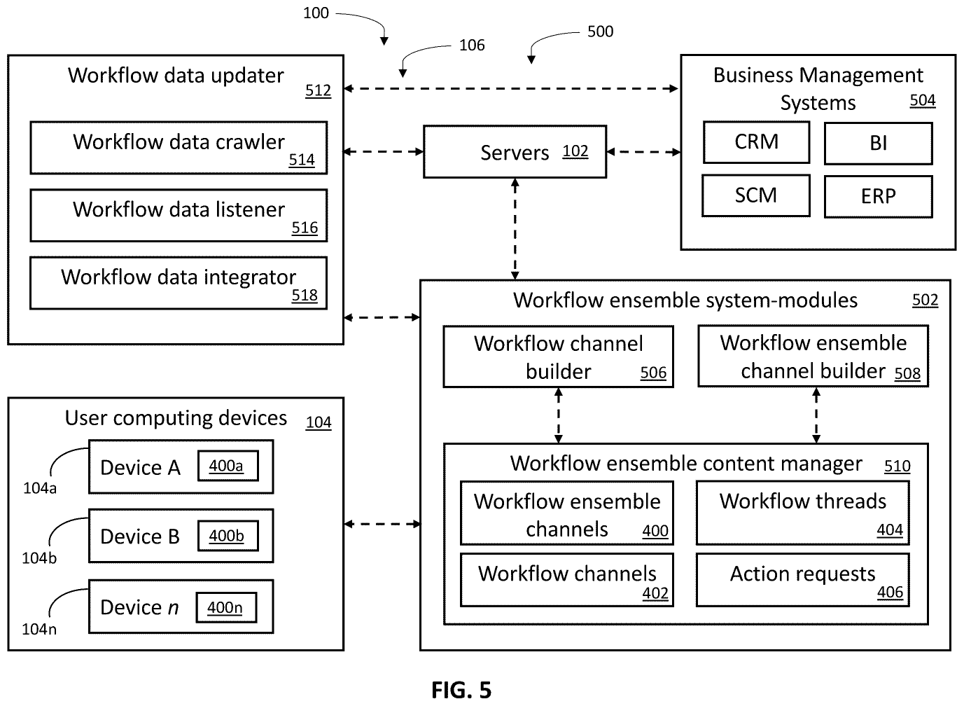

Referring to FIG. 5, aspects and features of a workflow ensemble system 500 are further described. The workflow ensemble system 500 may include and/or define one or more features of the group-based communication system 100. As shown in FIG. 5, a workflow ensemble system 500 may include one or more workflow ensemble system-modules 502. The one or more workflow ensemble system-modules 502 may perform various functions associated with providing workflow content to respective user computing devices 104, including automatically generating workflow ensemble channels 400 for the respective user computing devices 104. Additionally, or in the alternative, one or more workflow ensemble system-modules 502 may generate the workflow ensemble channels 400 based at least in part on user inputs.

The workflow ensemble system-modules 502 may include functional components and data implemented on one or more computing devices that include at least one processor, at least one computer-readable medium, at least one communication interface, and at least one input/output device, as respectively described, for example, with reference to FIG. 1. The one or more computing devices of the workflow ensemble system-modules 502 may include, and/or may be communicatively coupled with, one or more of the severs 102 of the group-based communication system 100. The workflow ensemble system 500 may utilize the one or more workflow ensemble system-modules 502 automatically generate the one or more workflow ensemble channels 400 for respective users, for example, based at least in part on workflow content stored on the one or more servers 102 of the group-based communication system 100.

In one example, the workflow ensemble system 500 may include and/or may interface with one or more business management systems 504. The business management systems 504 may respectively include functional components and data implemented on one or more computing devices that include at least one processor, at least one computer-readable medium, at least one communication interface, and at least one input/output device, as respectively described, for example, with reference to FIG. 1.

The workflow ensemble system-modules 502 may automatically generate the one or more workflow ensemble channels 400 for respective users, for example, based at least in part on workflow content stored on the one or more computing devices of the business management systems 504. The one or more computing devices of the business management systems 504 may include, and/or may be communicatively coupled with, one or more of the severs 102 of the group-based communication system 100.

The workflow ensemble system-modules 502 may include at least one of a workflow channel-builder 506, a workflow ensemble channel-builder 508, or a workflow ensemble content manager 510. Additionally, the workflow ensemble system 500 may include a workflow data updater 512. The workflow data updater 512 may be included among the workflow ensemble system-modules 502. Alternatively, the workflow data updater 512 may be provided separately from the workflow ensemble system-modules 502. For example, the workflow ensemble system-modules 502 (e.g., the workflow channel-builder 506, the workflow ensemble channel-builder 508, and the workflow ensemble content manager 510) may be implemented on a first one or more computing devices, and the workflow data updater 512 may be implemented on a second one or more computing devices. Alternatively, the workflow data updater 512 may be implemented on the first one or more computing devices, for example, together with the workflow ensemble system-modules 502.

In one example, the workflow channel-builder 506 may automatically generate one or more workflow channels 402 based at least in part on workflow content stored on one or more of the servers 102 associated with the group-based communication system 100 and/or the one or more business management systems 504. For example, the workflow channel-builder 506 may automatically generate a workflow channel 402 responsive to a new or updated workflow associated with the group-based communication system 100 and/or the one or more business management systems 504. Additionally, or in the alternative, one or more workflow channels 402 may be generated at least partially by a user, for example, based on one or more user inputs from the user. The user inputs may include workflow content input by a user from a user computing device 104, for example, via the user interface 200 of the group-based communication system 100. The user inputs may include workflow content provided to at least one of the workflow ensemble system-modules 502, such as the workflow channel-builder 506, for the purpose of generating a workflow channel 402. Additionally, or in the alternative, the user inputs may include direct messages 222 among users. The workflow channel-builder 506 may extract workflow content from one or more direct messages 222 and generate a workflow channel 402 based at least in part on the extracted workflow content. Additionally, or in the alternative, the user inputs may be provided to a business management system 504, for example, via an input/output device associated with the business management system 504.

The business management system 504 may include one or more business management modules. The one or more business management modules may respectively define part of the business management system 504. Additionally, or in the alternative, the one or more business management modules may respectively define a stand-alone system that includes respectively distinct functional components and/or data implemented on one or more computing devices. By way of example, the one or more business management modules may include at least one of: a customer relationship management system (CRM system), a supply chain management system (SCM system), a business intelligence system (BI system), an enterprise resource planning system (ERP system), a sales management system, a contract management system, a licensing management system, a business development system, a scheduling system, an accounting system, a financial reporting system, a project management system, an inventory management system, an operations management system, a production management system, a manufacturing management system, an invoicing system, a payment system, a marketing system, a strategic planning system, an e-commerce system, a service resource planning system, a process management system, a human-resource management system, a social media management system, a time management system, or a government operation system.

In one example, the workflow ensemble channel-builder 508 may automatically manage one or more workflow ensemble channels 400 for respective users based at least in part on workflow content associated with respective workflow channels 402. The workflow ensemble channel-builder 508 may provide for inclusion in the respective workflow ensemble channels 400, the workflow content that satisfies the one or more ensemble-relevance parameters. Such workflow content may sometimes be referred to as system-generated workflow content. By way of example, the system-generated workflow content may be presented in the workflow ensemble channel 400 as a workflow channel 402, a workflow thread 404, and/or an action request 406. The system-generated workflow content may be stored on one or more of the servers 102 associated with the group-based communication system 100 and/or the one or more business management systems 504.

The workflow ensemble channel-builder 508 may determine workflow content relevant to a respective user based on one or more ensemble-relevance parameters. The workflow ensemble channel-builder 508 may determine the ensemble-relevance parameters based at least in part on workflow content stored on one or more of the servers 102 associated with the group-based communication system 100 and/or the one or more business management systems 504. Additionally, or in the alternative, the workflow ensemble channel-builder 508 may determine the ensemble-relevance parameters based at least in part on one or more user inputs from the user. The user inputs may include workflow content input by a user from a user computing device 104, for example, via the user interface 200 of the group-based communication system 100. The user inputs may include and/or specify ensemble-relevance parameters applicable to the workflow ensemble channel 400 for the respective user. Additionally, or in the alternative, the user inputs may include and/or specify ensemble-relevance parameters provided to at least one of the workflow ensemble system-modules 502, such as the workflow ensemble channel-builder 508, for the purpose of generating a workflow ensemble channel 400. Additionally, or in the alternative, the user inputs may include direct messages 222 among users. The workflow ensemble channel-builder 508 may determine the ensemble-relevance parameters from one or more direct messages 222. Additionally, or in the alternative, the user inputs may be provided to a business management system 504, for example, via an input/output device associated with the business management system 504. The user inputs provided to the business management system 504 may include and/or specify ensemble-relevance parameters. Additionally, or in the alternative, the workflow ensemble channel-builder 508 may determine ensemble-relevance parameters from workflow content included in user inputs by a user to the business management system 504.

The workflow ensemble content manager 510 may interface with the user computing devices 104, for example, to provide workflow content to the respective user computing devices 104, including workflow ensemble channels 400, workflow channels 402, workflow threads 404, and/or action requests 406. Additionally, or in the alternative, the workflow ensemble content manager 510 may receive user inputs from the respective user computing devices 104, including, for example, action responses 408, direct messages 222, and/or user inputs associated with generating workflow channels 402 and/or generating workflow ensemble channels 400.

The workflow data updater 512 may perform data management functions and operations associated with the one or more of the servers 102 of the group-based communication system 100 and/or business management systems 504. The data management functions may include identification, extraction, tagging, integration, aggregation, and the like. In one example, the workflow data updater 512 may include at least a workflow data crawler 514, a workflow data listener 516, a workflow data integrator 518. The workflow data crawler 514 may systematically search data stored in a datastore 124 (FIG. 1) associated with the one or more of the servers 102 of the group-based communication system 100 and/or business management systems 504, for example, to determine workflow content that satisfies ensemble-relevance parameters for respective workflow ensemble channels 400. The workflow data listener 516 may listen for specific events relevant to the workflow ensemble system 500, such as changes, updates, additions, or deletions to workflow data, or the like. For example, the workflow data listener 516 may determine occurrences of relevance on one or more of the servers 102 of the group-based communication system 100 and/or business management systems 504, such as occurrences of a workflow being added, deleted, or updated. Additionally, or in the alternative, the workflow data listener 516 may determine occurrences of relevant activity associated with the workflow ensemble system 500, such as updates, additions, or deletions, or the like with respect to workflow channels 402, workflow threads 404, action requests 406, direct messages 222, or the like, and/or updates, additions, or deletions to the datastore 124 corresponding to activity associated with the workflow ensemble system 500. The workflow data integrator 518 may perform various data integration operations, such as combining and unifying data associated with the workflow ensemble system 500 and data stored on one or more of the servers 102 of the group-based communication system 100 and/or business management systems 504.

In one example, the workflow ensemble system-modules 502 may interface with the respective user computing devices 104, such as between the respective user computing devices 104 and the one or more of the servers 102 of the group-based communication system 100 and/or the business management systems 504. Additionally, or in the alternative, the workflow data updater 512 may interface with the one or more of the servers 102, such as between the workflow ensemble system-modules 502 and the one or more of the servers 102.

In one example, the workflow data updater 512 may provide workflow data to and/or receive workflow data from the workflow ensemble system-modules 502. Additionally, or in the alternative, the workflow data updater 512 may provide workflow data to and/or receive workflow data from one or more of the servers 102 of the group-based communication system 100 and/or the business management systems 504. The workflow ensemble system-modules 502 may provide workflow data to the respective user computing devices 104 and/or receive workflow data from the respective user computing devices 104. Additionally, or in the alternative, the workflow data updater 512 may prompt the workflow ensemble system-modules 502 to receive data from the one or more of the servers 102 and/or to transmit data to the one or more of the servers 102 in association with operations of the workflow ensemble system 500.

### C. Ensemble-Relevance Parameters

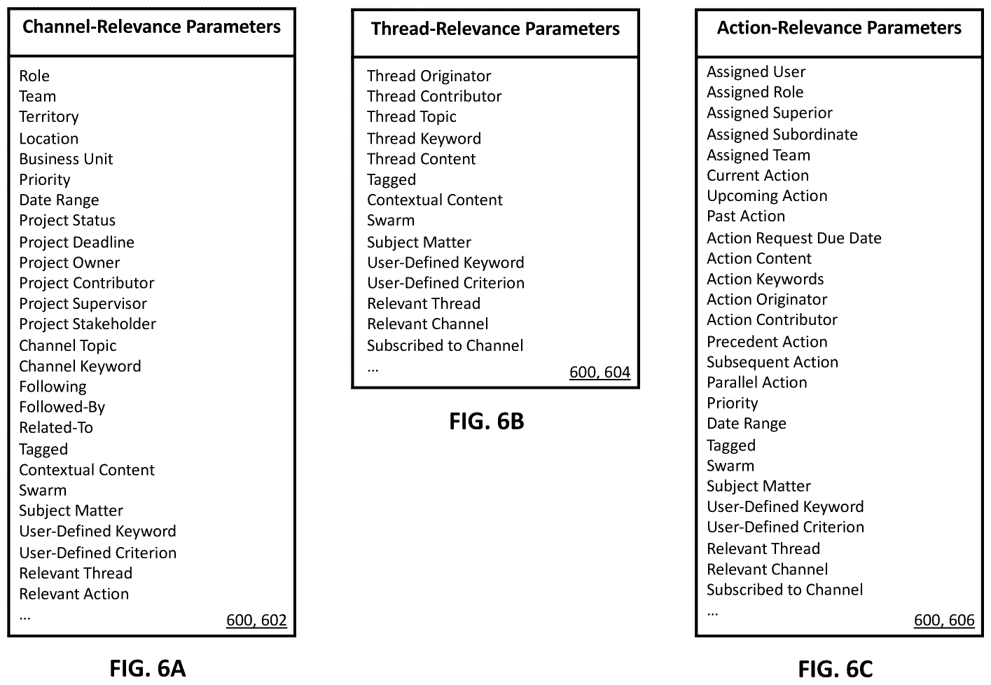

Referring now to FIGS. 6A-6C, ensemble-relevance parameters 600 are further described. The ensemble-relevance parameters 600 may include at least one of: channel-relevance parameters 602, thread-relevance parameters 604, or action-relevance parameters 606. Workflow content may be determined as relevant with respect to a respective user based at least in part on one or more ensemble-relevance parameters 600 associated with the respective user. A workflow channel 402 may be determined as relevant based at least in part on one or more channel-relevance parameters 602. A workflow thread 404 may be determined as relevant based at least in part on one or more thread-relevance parameters 604. An action request 406, an action response 408, and/or a response status 410 may be determined as relevant based at least in part on one or more action-relevance parameters 606. Additionally, or in the alternative, workflow content, such as a workflow channel 402, a workflow thread 404, an action request 406, an action response 408, and/or a response status 410 may be determined as relevant based at least in part on a combination of one or more channel-relevance parameters 602, thread-relevance parameters 604, and/or action-relevance parameters 606. The ensemble-relevance parameters 600 may be stored in a relational database or the like, such as in a datastore 124 (FIG. 1). The relational database may associate respective ensemble-relevance parameters 600 with users and/or with workflow content. The relational database may include a data ensemble that defines workflow content associated with a workflow ensemble channel 400 for a respective user.

By way of example, a channel-relevance parameter 602 may include at least one of the following associated with a workflow channel 402: a role, a team, a territory, a location, a business unit, a priority, a date range, a project status, a project deadline, a project owner, a project contributor, a project supervisor, a project stakeholder, a channel topic, a channel keyword, a following status, a followed-by status, a related-to status, a tagged status, an item of contextual content, a swarm parameter, a subject matter parameter, a user-defined channel keyword, a user-defined channel criterion, a relevant thread status, or a relevant action status. A relevant thread status may refer to an existence of a workflow thread 404 associated with the workflow channel 402, with respect to which the workflow thread 404 satisfies at least one ensemble-relevance parameter 600 such as at least one thread-relevance parameter 604. A relevant action status may refer to an existence of an action request 406 (and/or an action response 408 and/or a response status 410) associated with the workflow channel 402, with respect to which the action request 406 (and/or the action responses 408 and/or the response status 410) satisfies at least one ensemble-relevance parameter 600 such as at least one action-relevance parameter 606.

By way of example, a thread-relevance parameter 604 may include at least one of the following associated with a workflow thread 404: a thread originator, a thread contributor, a thread topic, a thread keyword, an item of thread content, a tagged status, an item of contextual content, a user-defined thread keyword, a user-defined thread criterion, a relevant channel status, a relevant action status, or a subscribed-to-channel status. A relevant channel status may refer to an existence of a workflow channel 402 associated with the workflow thread 404, with respect to which the workflow channel 402 satisfies at least one ensemble-relevance parameter 600 such as at least one channel-relevance parameter 602. A subscribed-to-channel status may refer to an existence of a workflow thread 404 associated with a workflow channel 402 to which a user is subscribed. Additionally, or in the alternative, a thread-relevance parameter 604 may include any one or more of the channel-relevance parameters 602, as applied with respect to a workflow thread 404.

By way of example, an action-relevance parameter 606 may include at least one of the following associated with an action request 406 (and/or an action responses 408 and/or a response status 410): an assigned user, an assigned role, an assigned superior, an assigned subordinate, an assigned team, a current-action-status, an upcoming-action-status, a past-action-status, an action due date, an item of content, a keyword, an originator, a contributor, a related precedent action, a related subsequent action, a related parallel action, a priority, a date range, a tagged status, a user-defined action keyword, a user-defined action criterion, a relevant channel status, a relevant thread status, or a subscribed-to-channel status. Additionally, or in the alternative, an action-relevance parameter 606 may include any one or more of the thread-relevance parameters 604 and/or any one or more of the channel-relevance parameters 602, as applied with respect to an action request 406 (and/or an action response 408 and/or a response status 410).

In one example, the workflow ensemble channels 400 may respectively include system-generated workflow content that is distinctive and/or unique to a respective user. The distinctive and/or unique character of a respective workflow ensemble channel 400 may be attributable at least in part to the ensemble-relevance parameters 600 used to generate or identify the respective workflow ensemble channel 400. Additionally, or in the alternative, workflow ensemble channels 400 associated with respective users may share one or more commonalities, for example, based on one or more common ensemble-relevance parameters 600 as among the respective users.

In one example, a user may be automatically subscribed to workflow channels 402 based at least in part on one or more ensemble relevance parameters 600, for example, when the one or more ensemble-relevance parameters 600 are satisfied with respect to the user. For example, a user may be automatically subscribed to a workflow channel 402 when the one or more ensemble-relevance parameters 600 indicate that the workflow channel 402 is relevant to the user. In one example, a user may be automatically subscribed to a workflow channel 402 when the workflow channel 402 includes a workflow thread 404 and/or an action request 406 that are relevant to the user, as indicated, for example, by the one or more ensemble-relevance parameters. By way of example, a user may be automatically subscribed to a workflow channel 402 when a workflow associated with the workflow channel 402 has been initiated. Additionally, or in the alternative, a user may be automatically subscribed to a workflow channel 402 when the user is tagged in a workflow thread 404 and/or when an action request 406 is assigned to the user. In one example, a user may be automatically subscribed to a workflow channel 402 based at least in part on a response status 410 of an action request 406. For example, a user may be automatically subscribed to a workflow channel 402 when the response status 410 indicates that the action request 406 is in-queue or pre-queue with respect to the user. A workflow channel 402 to which the user is automatically subscribed may be added to the workflow ensemble channel 400 associated with the user.

Additionally, or in the alternative, a user may be automatically unsubscribed from a workflow channel 402 based at least in part on one or more ensemble relevance parameters 600, for example, when the respective ensemble-relevance parameters 600 are unsatisfied with respect to the user. For example, a user may be automatically unsubscribed from a workflow channel 402 when the one or more ensemble-relevance parameters 600 indicate that the workflow channel 402 is not relevant and/or is no longer relevant to the user. In one example, a user may be automatically unsubscribed from a workflow channel 402 when the workflow channel 402 does not include and/or no longer includes any workflow threads 404 and/or action requests 406 that are relevant to the user, as indicated, for example, by the one or more ensemble-relevance parameters. By way of example, a user may be automatically unsubscribed from a workflow channel 402 based at least in part on a response status 410 of an action request 406. For example, a user may be automatically unsubscribed from a workflow channel 402 when the response status 410 indicates that the action request 406 is post-queue with respect to the user. Additionally, or in the alternative, a user may be automatically unsubscribed from a workflow channel 402 when a workflow associated with the workflow channel 402 has been completed. A workflow channel 402 to which a user is automatically unsubscribed may be removed from the workflow ensemble channel 400 associated with the user.

A workflow thread 404 may be automatically added to a workflow ensemble channel 400 when the ensemble-relevance parameters 600 associated with the workflow thread 404 are satisfied. The workflow thread 404 may be added to the workflow ensemble channel 400 in association with one or more workflow channels 402 to which the user is subscribed, such as automatically subscribed. A workflow thread 404 may be automatically removed from a workflow ensemble channel 400 when the ensemble-relevance parameters 600 associated with the workflow thread 404 are unsatisfied.

An action request 406 (and/or an action response 408 and/or a response status 410) may be automatically added to a workflow ensemble channel 400 when the ensemble-relevance parameters 600 associated with the action request 406 (and/or the action responses 408 and/or the response status 410) are satisfied. The action request 406 (and/or the action responses 408 and/or the response status 410) may be added to the workflow ensemble channel 400 in association with one or more workflow channels 402 to which the user is subscribed, such as automatically subscribed. An action request 406 (and/or an action response 408 and/or a response status 410) may be automatically removed from a workflow ensemble channel 400 when the ensemble-relevance parameters 600 associated with the action request 406 (and/or the action responses 408 and/or the response status 410) are unsatisfied.

In one example, a workflow channel 402, a workflow thread 404, and/or an action request 406 may be generated for a swarm. Additionally, or in the alternative, swarming may be included in a workflow channel 402, a workflow thread 404, and/or an action request 406. A swarm may be generated, and/or swarming may be included, based at least in part on one or more ensemble-relevance parameters 600. In one example, the one or more ensemble-relevance parameters 600 utilized to generate a swarm may include a subject matter parameter. The subject matter parameter may indicate one or more types of subject matter, such as one or more areas of subject matter expertise. The swarm may include a plurality of users selected based at least in part on one or more ensemble-relevance parameters 600 associated with the respective user. For example, the plurality of users may be invited to the swarm generated for the workflow channel 402 based at least in part on an association between the respective user and the one or more types of subject matter indicated by the subject matter parameter. In one example, a user may be automatically subscribed to a workflow channel 402 that includes a swarm to which the user has been invited and/or to which the user has accepted an invitation. Additionally, or in the alternative, a user may be automatically unsubscribed from a workflow channel 402 upon conclusion of a swarm to which the user was invited and/or to which the user had accepted an invitation. The initiation and/or conclusion of a swarm may be indicated by an action request 406, and/or by one or more ensemble-relevance parameters 600 associated with the action request.

### D. Data Ensembles

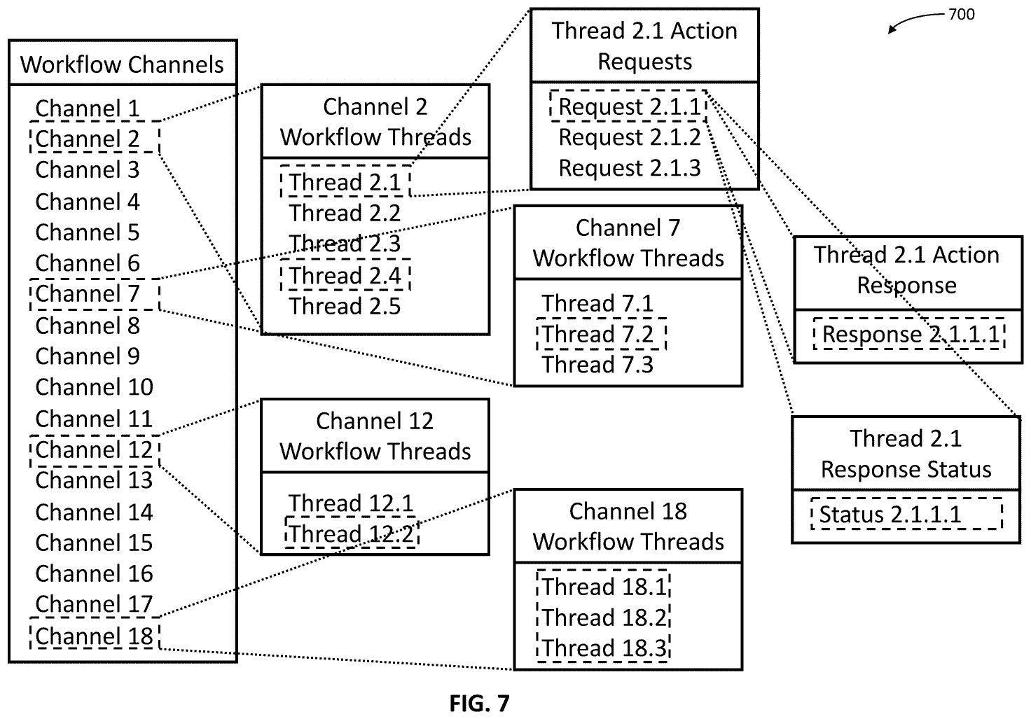

FIG. 7 schematically depicts one example of a data ensemble 700 for a workflow ensemble channel 400. The data ensemble 700 may represent and/or may be determined based at least in part on items of workflow data that satisfy one or more ensemble-relevance parameters 600 associated with the workflow ensemble channel 400. As shown in FIG. 7, the data ensemble may include one or more workflow channels 402 that satisfy one or more ensemble-relevance parameters 600 associated with the respective workflow channel 402. A workflow channel 402 may be excluded from the data ensemble 700 when the one or more ensemble-relevance parameters 600 are unsatisfied with respect to the workflow channel 402. By way of example, as shown in FIG. 7, the data ensemble 700 indicates that one or more ensemble-relevance parameters 600 are satisfied with respect to workflow channels 402 identified as channel 2, channel 7, channel 12, and channel 18.

Additionally, or in the alternative, the data ensemble 700 may include one or more workflow threads 404 that satisfy one or more ensemble-relevance parameters 600 associated with the respective workflow thread 404. In one example, the one or more workflow threads 404 that satisfy the respective ensemble-relevance parameters 600 associated with the respective workflow thread 404 may be associated with a workflow channel 402 that satisfies one or more ensemble-relevance parameters 600 associated with the workflow channel 402. A workflow thread 404 may be excluded from the data ensemble 700 when the one or more ensemble-relevance parameters 600 are unsatisfied with respect to the workflow thread 404.

By way of example, as shown in FIG. 7, the data ensemble 700 indicates that one or more ensemble-relevance parameters 600 are satisfied with respect to workflow threads 404 identified as thread 2.1, thread 2.7, thread 7.2, thread 18.1, thread 18.2, thread 18.3, and thread 12.2. As shown, the workflow threads 404 identified as thread 2.1 and thread 2.7 are associated with the workflow channel 402 identified as channel 2. The workflow thread 404 identified as thread 7.2 is associated with the workflow channel 402 identified as channel 7. The workflow thread 404 identified as thread 12.2 is associated with the workflow channel 402 identified as channel 12. The workflow threads 404 identified as thread 18.1, thread 18.2, and thread 18.3 are associated with the workflow channel 402 identified as channel 18.

Additionally, or in the alternative, the data ensemble may include one or more action requests 406 that satisfy one or more ensemble-relevance parameters 600 associated with the action request 406. In one example, the one or more action requests 406 that satisfy the respective ensemble-relevance parameters 600 associated with the respective action request 406 may be associated with a workflow thread 404 that satisfies one or more ensemble-relevance parameters 600 associated with the workflow thread 404. An action request 406 may be excluded from the data ensemble 700 when the one or more ensemble-relevance parameters 600 are unsatisfied with respect to the action request 406. Additionally, or in the alternative, the data ensemble may include one or more action responses 408 and/or one or more response statuses 410 that respectively satisfy one or more ensemble-relevance parameters 600 associated therewith. In one example, the one or more action responses 408 and/or response statuses 410 that satisfy the respective ensemble-relevance parameters 600 may be associated with a workflow thread 404 that satisfies one or more ensemble-relevance parameters 600 associated with the workflow thread 404. An action response 408 and/or a response status 410 may be excluded from the data ensemble 700 when the one or more ensemble-relevance parameters 600 are unsatisfied with respect thereto.

By way of example, as shown in FIG. 7, the data ensemble 700 indicates that one or more ensemble-relevance parameters 600 are satisfied with respect to an action request 406 identified as request 2.1.1. As shown, the action request 406 identified as request 2.1.1 is associated with the workflow thread 402 identified as thread 2.1. As further shown, the data ensemble 700 indicates that one or more ensemble-relevance parameters 600 are satisfied with respect to an action response 408 identified as response 2.1.1.1, and with respect to a response status 410 identified as status 2.1.1.1. As shown, the action response 408 identified as response 2.1.1.1 and the response status 410 identified as status 2.1.1.1 are associated with the action request 406 identified as request 2.1.1.

### E. Workflow Ensemble Builder-Interfaces

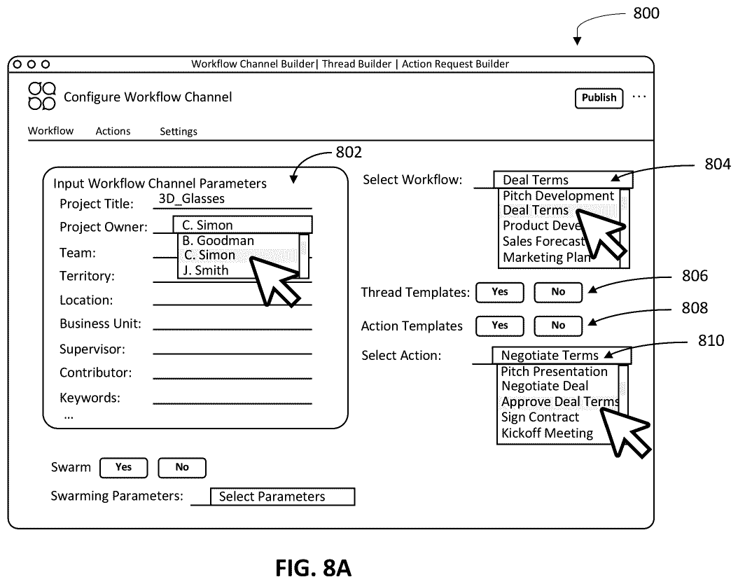

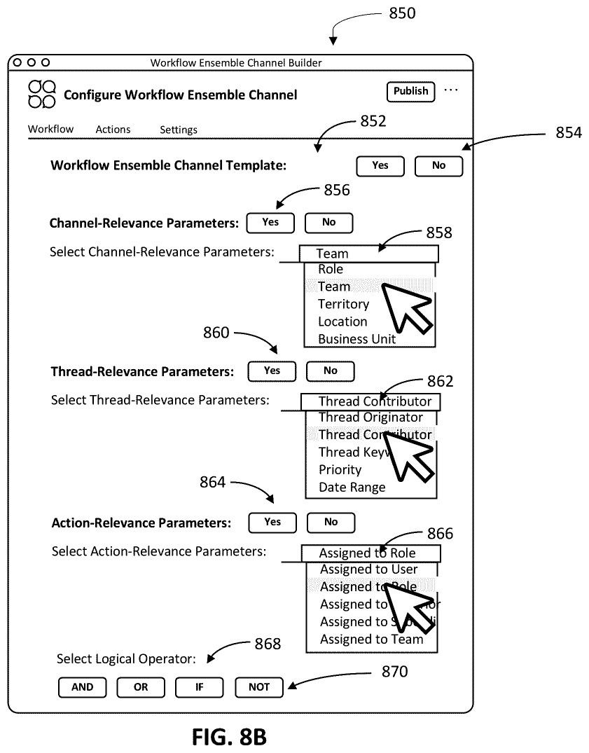

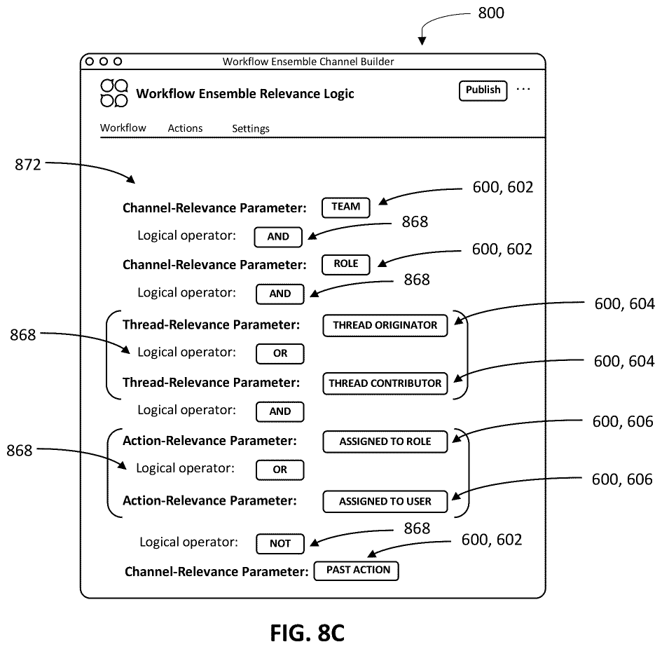

A workflow ensemble system 500 may include one or more workflow ensemble builder-interfaces. As shown in FIG. 8A, a workflow ensemble system 500 may include a workflow channel-builder-interface 800. Additionally, or in the alternative, as shown in FIG. 8B, a workflow ensemble system 500 may include a workflow ensemble channel-builder-interface 850. The workflow channel-builder-interface 800 and/or the workflow ensemble channel-builder-interface 850 may define a portion of the user interface 200 for the workflow ensemble system 500. Additionally, or in the alternative, the workflow channel-builder-interface 800 and/or the workflow ensemble channel-builder-interface 850 may be accessible from a user interface for the one or more servers associated with the one or more business management systems 504 (FIG. 5).

In one example, as shown in FIG. 8A a workflow channel-builder-interface 800 may allow a user to configure a workflow channel 402, such as a new workflow channel 402. The workflow channel-builder-interface 800 may include a channel parameter-pane 802 configured to allow a user to input parameters associated with the workflow channel 402, such as channel-relevance parameters 602, for example, as by way of a drop-down menu. Additionally, or in the alternative, the workflow channel-builder-interface 800 may allow a user to input thread relevance-parameters 604 and/or action-relevance parameters 606. The workflow channel-builder-interface 800 may allow a user to select a workflow associated with the workflow channel 402, for example, by way of a workflow-selection menu 804. One or more ensemble-relevance parameters 600 may be automatically determined based at least in part on the workflow associated with the workflow channel 402.

Additionally, or in the alternative, the workflow channel-builder-interface 800 may allow a user to select one or more thread templates associated with the workflow channel 402, for example, by way of one or more thread template-section buttons 806. One or more workflow threads 404 may be automatically generated based at least in part on a thread template selected in association with the workflow channel 402. Additionally, or in the alternative, one or more ensemble-relevance parameters 600 may be automatically determined based at least in part on the one or more workflow threads 404 and/or the thread template associated with the workflow channel 402.

Additionally, or in the alternative, the workflow channel-builder-interface 800 may allow a user to select one or more action templates associated with the workflow channel 402, for example, by way of one or more action template-section buttons 808. One or more action requests 406 may be automatically generated based at least in part on an action template selected in association with the workflow channel 402. Additionally, or in the alternative, one or more action requests 406 may be selected, for example, by way of an action request-selection menu 810. One or more ensemble-relevance parameters 600 may be automatically determined based at least in part on the one or more action requests 406 and/or the action template associated with the workflow channel 402.

By way of example, FIG. 8A shows a workflow channel 402 being created for a project titled 3D_Glasses, with respect to which C. Simon is being identified as the project owner. As further shown, the workflow channel 402 is associated with a workflow pertaining to deal terms, and includes an action request 406 for approving deal terms.

In one example, as shown in FIG. 8B a workflow ensemble channel-builder-interface 850 may allow a user to configure a workflow ensemble channel 400, such as a new workflow ensemble channel 400. The workflow ensemble channel-builder-interface 850 may include an ensemble parameter-pane 852 configured to allow a user to input parameters associated with the workflow ensemble channel 400, such as ensemble-relevance parameters 600, for example, by way of one or more drop-down menus.

As shown, the workflow ensemble channel-builder-interface 850 may allow a user to select one or more workflow ensemble channel-templates associated with the workflow ensemble channel 400, for example, by way of one or more ensemble template-section buttons 854. One or more workflow threads 404 may be automatically generated based at least in part on a workflow ensemble channel-template selected in association with the workflow ensemble channel 400. Additionally, or in the alternative, one or more ensemble-relevance parameters 600 may be automatically determined based at least in part on the workflow ensemble channel-template selected in association with the workflow ensemble channel 400.

In one example, the workflow channel-builder-interface 800 may allow a user to select ensemble-relevance parameters 600. For example, one or more channel-relevance parameters 602 may be selected by way of one or more channel-relevance parameter-selection buttons 856. One or more channel-relevance parameters 602 may be automatically determined, and/or the user may select one or more channel-relevance parameters 602, for example, by way of a channel-relevance parameter-selection menu 858. Additionally, or in the alternative, one or more thread-relevance parameters 604 may be selected by way of one or more thread-relevance parameter-selection buttons 860. One or more thread-relevance parameters 604 may be automatically determined, and/or the user may select one or more thread-relevance parameters 604, for example, by way of a thread-relevance parameter-selection menu 862. Additionally, or in the alternative, one or more action-relevance parameters 606 may be selected by way of one or more action-relevance parameter-selection buttons 864. One or more action-relevance parameters 606 may be automatically determined, and/or the user may select one or more action-relevance parameters 606, for example, by way of an action-relevance parameter-selection menu 866.

In one example, the workflow channel-builder-interface 800 may allow a user to select one or more logical operators 868 to link a plurality of ensemble-relevance parameters 600, for example, by way of one or more ensemble logic-selection buttons 870. As shown, example logical operators 868 may include AND, OR, IF, and/or NOT. The AND logical operator 868 may require a first ensemble-relevance parameter 600 and a second ensemble relevance-parameter 600. The OR logical operator 868 may require a first ensemble-relevance parameter 600 or a second ensemble relevance-parameter 600. The IF logical operator 868 may require a first ensemble-relevance parameter 600 if a second ensemble-relevance parameter 600 is satisfied. The NOT logical operator 868 may require a first ensemble-relevance parameter 600 when a second ensemble-relevance parameter 600 is not satisfied.

Referring to FIG. 8C, a plurality of ensemble-relevance parameters 600 may be linked to one another by one or more logical operators 868 to define ensemble-relevance logic 872. The ensemble-relevance logic 872 may be used to determine relevant workflow content for a workflow ensemble channel 400. FIG. 8C shows one example of ensemble-relevance logic 872 that includes a plurality of ensemble-relevance parameters 600 linked by logical operators 868 that may be utilized to determine relevant workflow content for a workflow ensemble channel 400.

By way of example, as shown in FIG. 8C, the ensemble-relevance logic 872 may include an AND logical operator 868 linking a first ensemble-relevance parameter 600 and a second ensemble relevance-parameter 600. The first ensemble-relevance parameter 600 may be a first channel-relevance parameter 602 and the second ensemble-relevance parameter 600 may be a second channel-relevance parameter 602. Additionally, or in the alternative, as shown, the ensemble-relevance logic 872 may include an AND logical operator 868 linking one or more additional ensemble-relevance parameters 600. For example, the ensemble-relevance logic 872 may include an AND logical operator 868 linking the second ensemble-relevance parameter 600 with a third ensemble-relevance parameter 600 or a fourth ensemble-relevance parameter 600. The third ensemble-relevance parameter 600 may be a third thread-relevance parameter 604 and the fourth ensemble-relevance parameter 600 may be a fourth thread-relevance parameter 604. The third ensemble-relevance parameter 600, such as the third thread-relevance parameter 604, may be linked to the fourth ensemble-relevance parameter 600, such as the fourth thread-relevance parameter 604, by an OR logical operator 868. Additionally, or in the alternative, as shown, the ensemble-relevance logic 872 may include an AND logical operator 868 linking yet another one or more additional ensemble-relevance parameters 600. For example, the ensemble-relevance logic 872 may include an AND logical operator 868 linking the third and/or fourth ensemble-relevance parameters 600 with a fifth ensemble-relevance parameter 600 or a sixth ensemble-relevance parameter 600. The fifth ensemble-relevance parameter 600 may be a fifth action-relevance parameter 606 and the sixth ensemble-relevance parameter 600 may be a sixth action-relevance parameter 606. The fifth ensemble-relevance parameter 600, such as the fifth action-relevance parameter 606, may be linked to the sixth ensemble-relevance parameter 600, such as the sixth thread-relevance parameter 604, by an OR logical operator 868.

In one example, the workflow channel-builder-interface 800 described with reference to FIG. 8A, and/or the workflow ensemble channel-builder-interface 850 described with reference to FIG. 8B, may be implemented at least partially as one or more automated features of a workflow ensemble system 500. The one or more automated features may be implemented in the workflow ensemble system 500 in addition, or in the alternative, to features of the user interface 200 for the workflow ensemble system 500. For example, features of the user interface 200 for the workflow ensemble system 500 may include counterpart automated features. The automated features may be implemented in connection with the workflow ensemble system 500 and/or one or more of the servers 102 associated with the one or more business management systems 504 (FIG. 5).

### III. Workflow Management

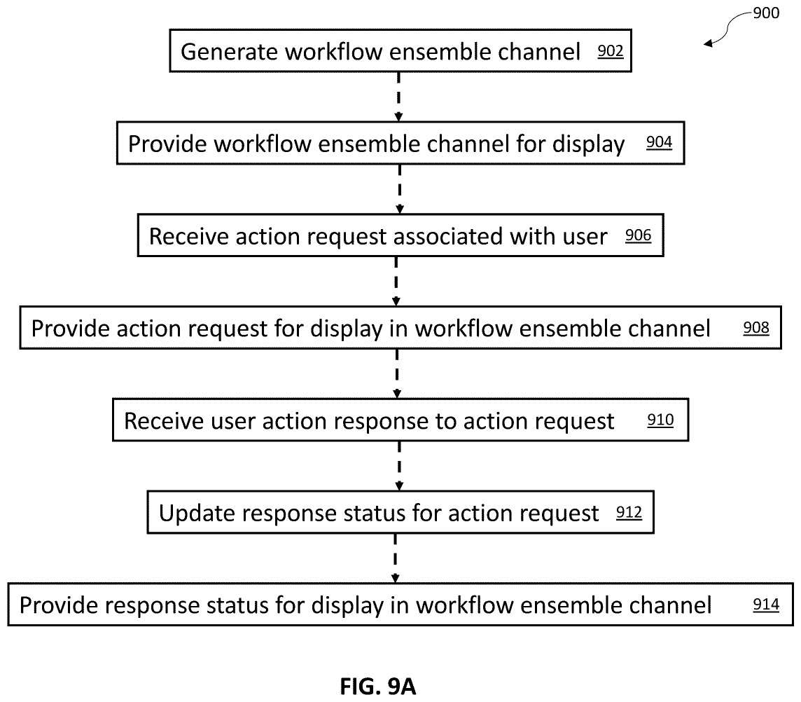

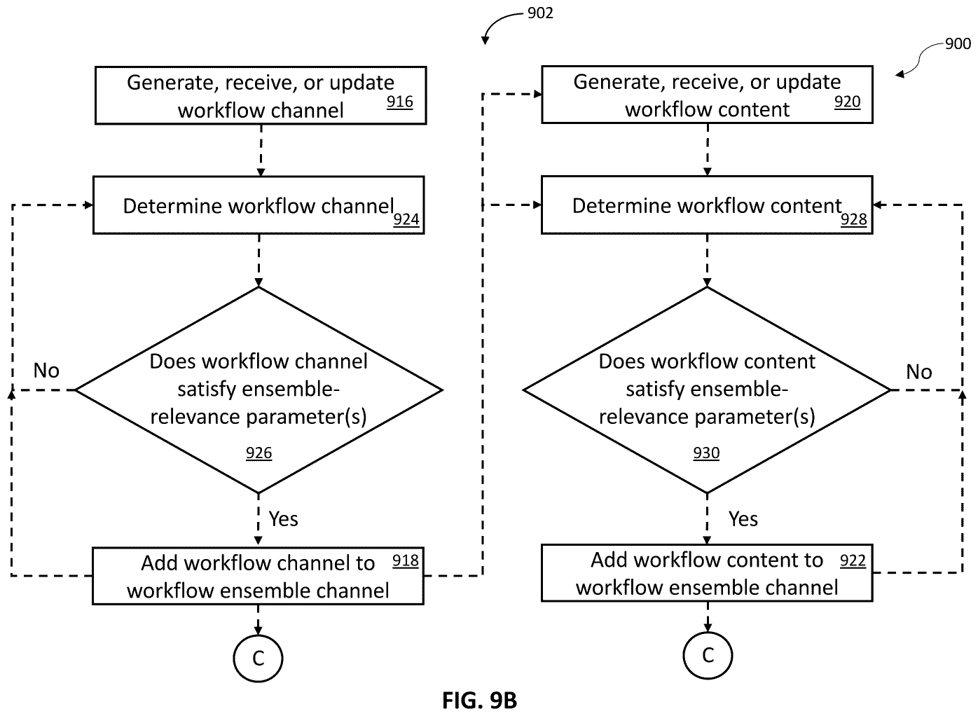

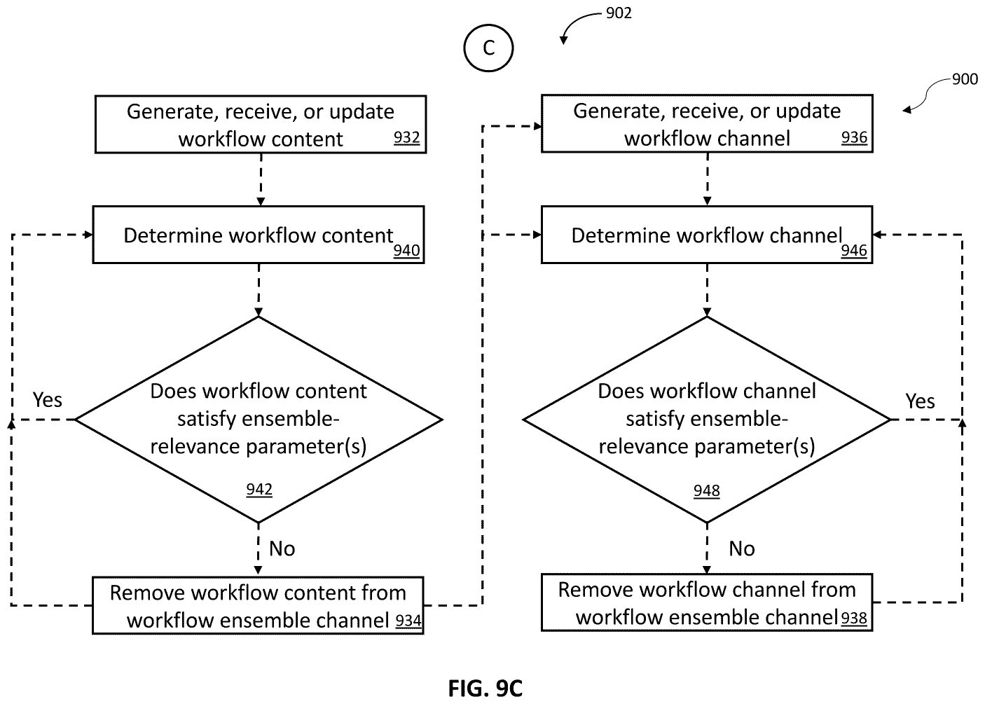

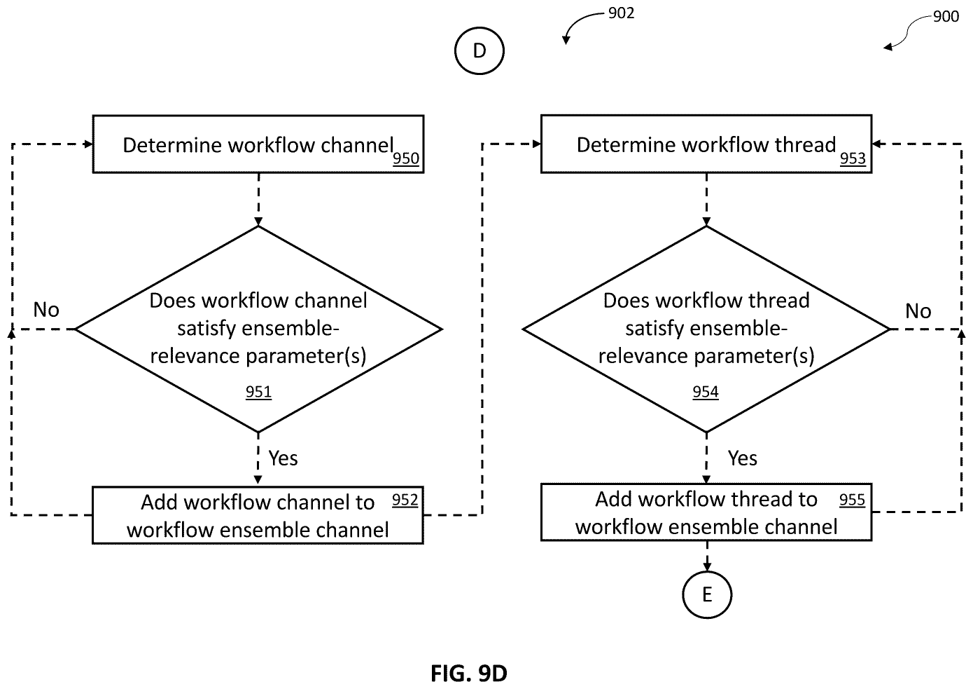

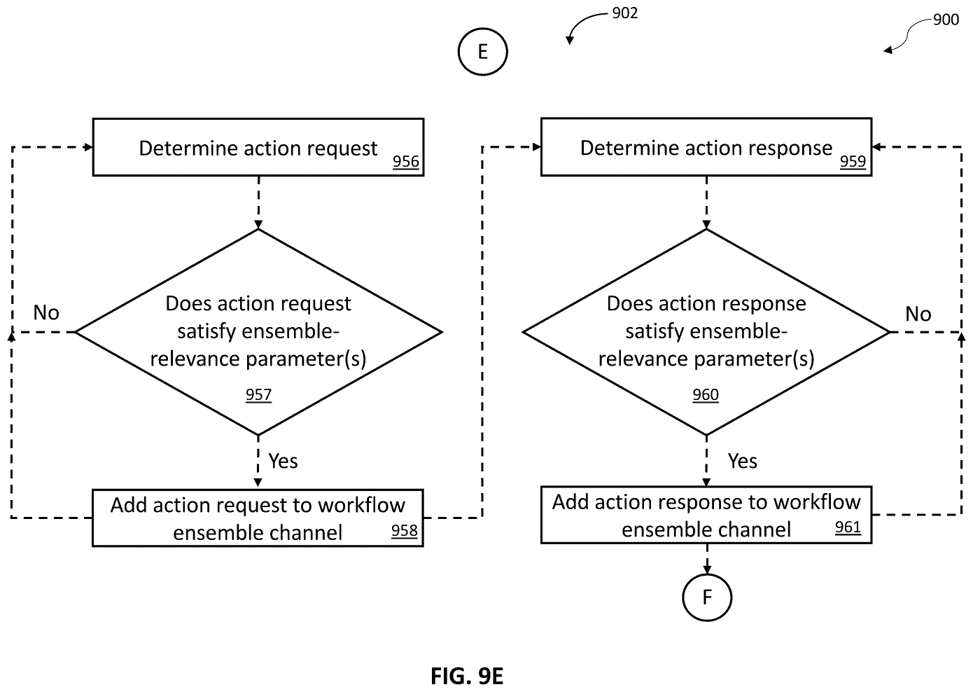

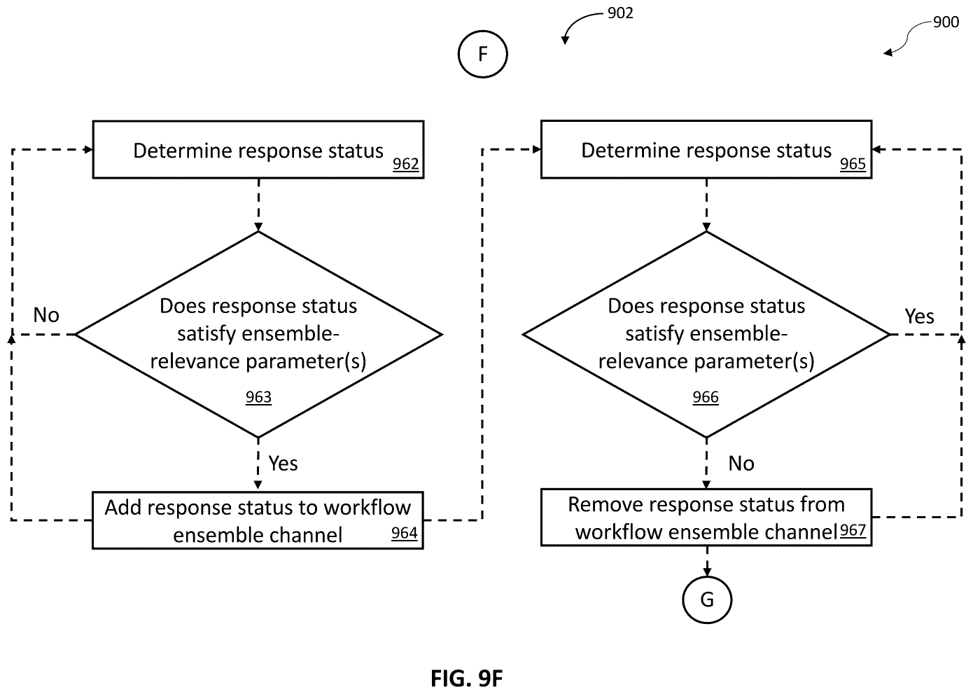

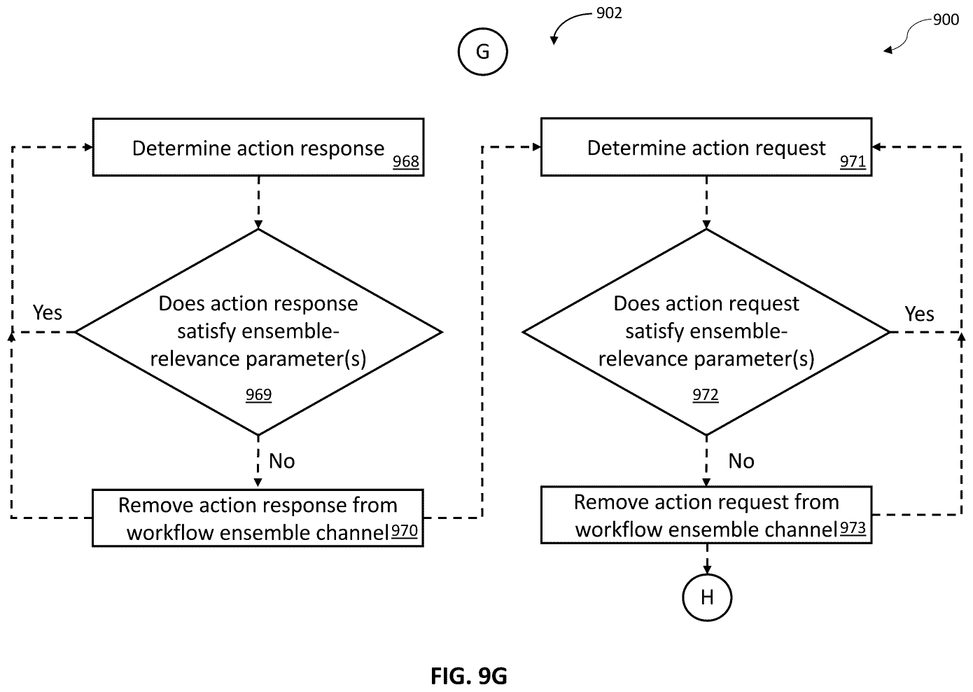

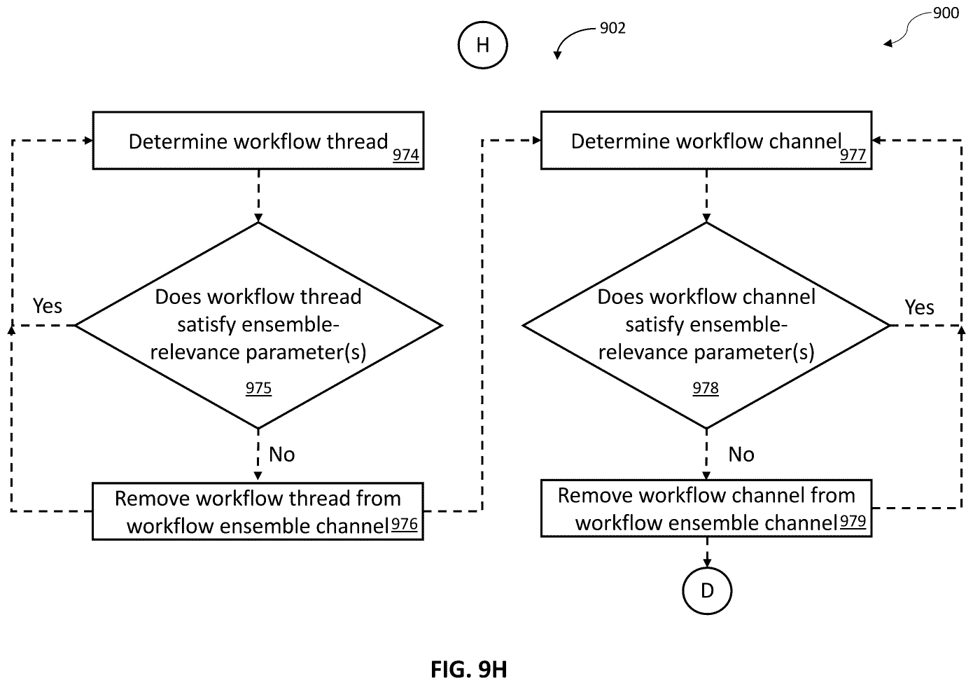

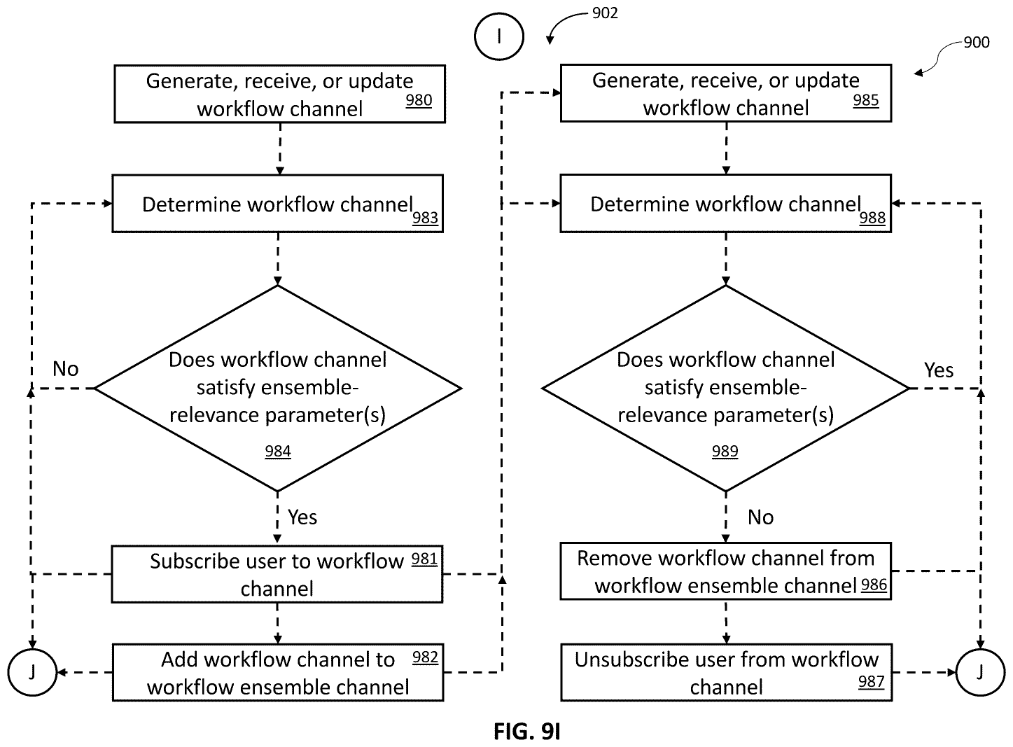

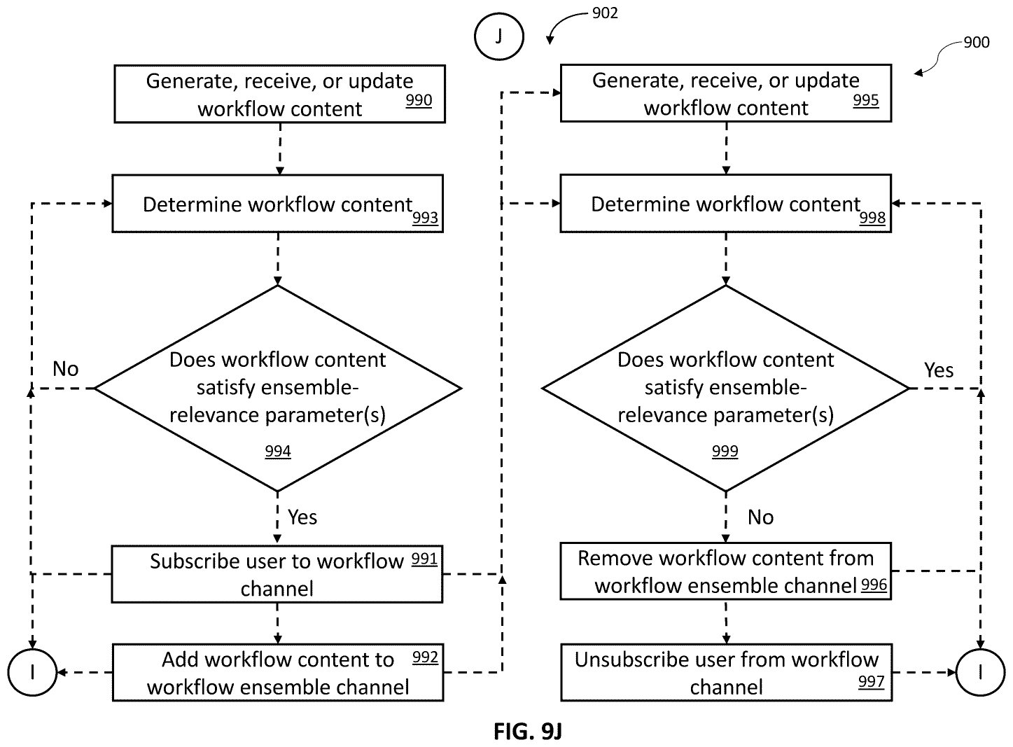

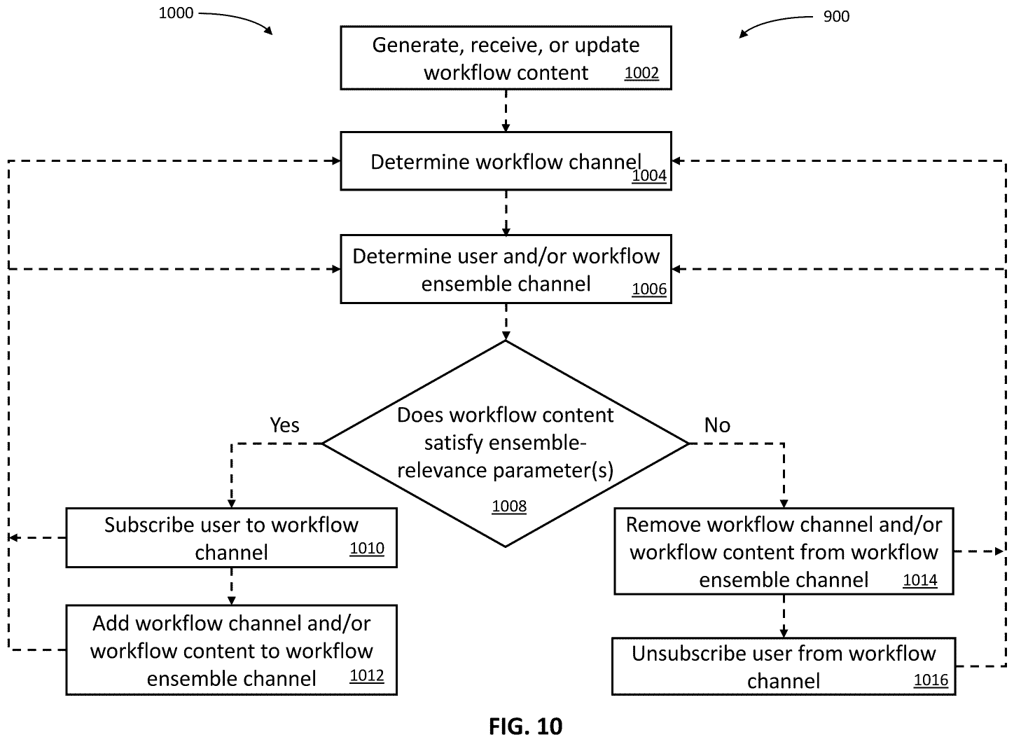

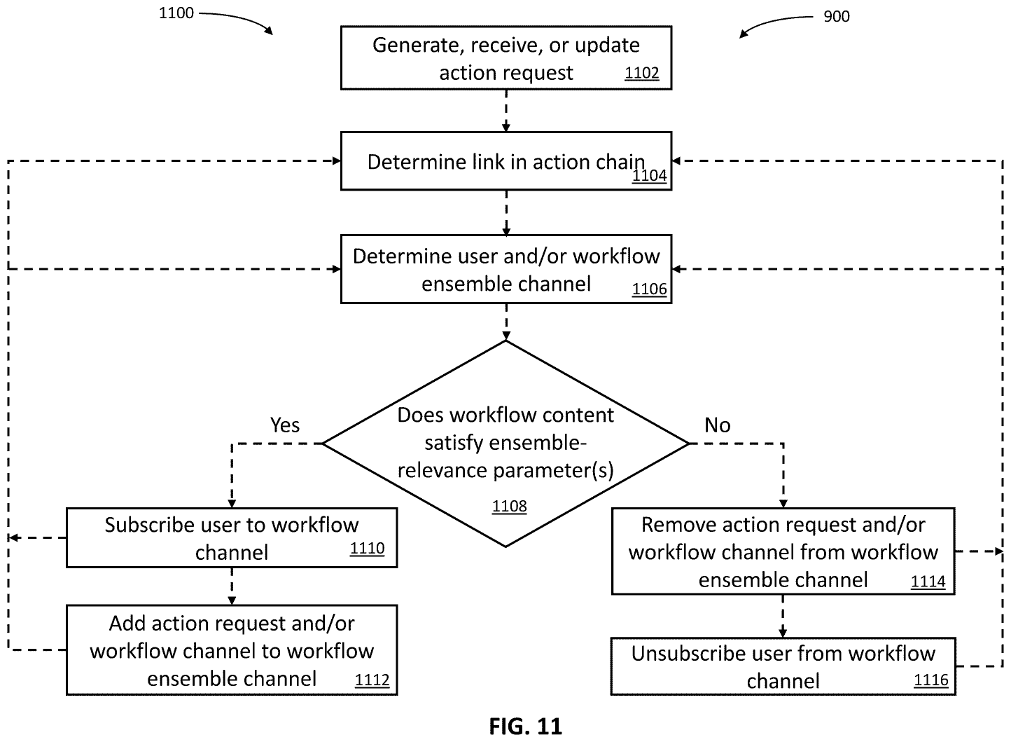

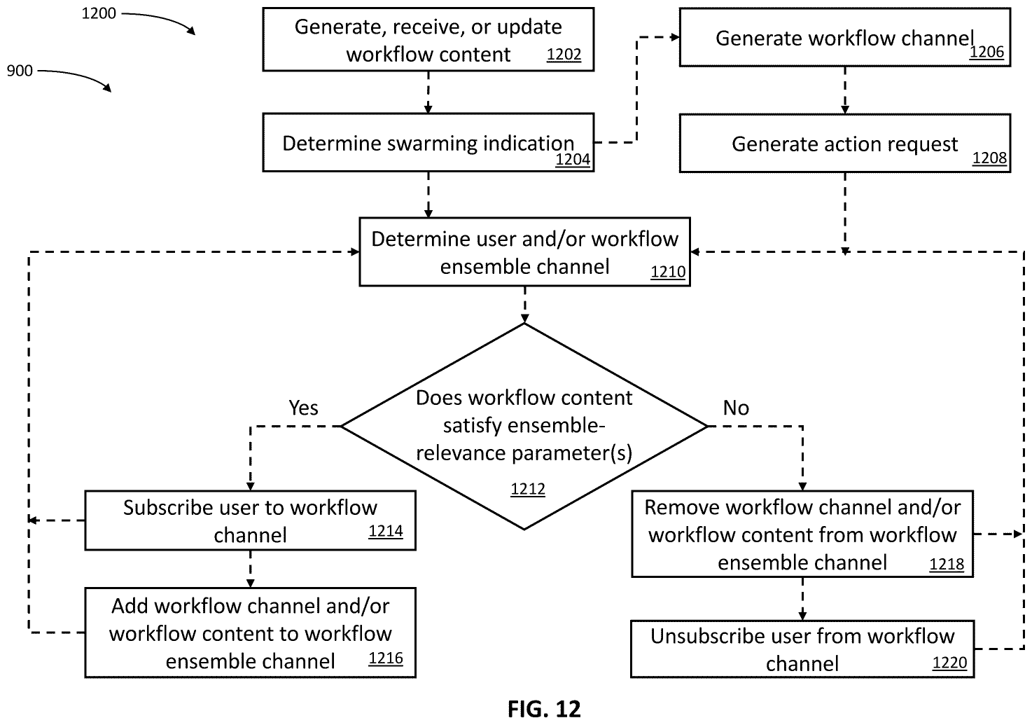

Referring to FIGS. 9A-9J, FIG. 10, FIG. 11, and FIG. 12, example methods 900 of managing a workflow are described. In one example, a method 900 of managing a workflow may include generating a workflow ensemble channel 400, for example, as described with reference to FIGS. 9A-9J. Additionally, or in the alternative, a method 900 of managing a workflow may include user subscription management with respect to a workflow ensemble channel 400, for example, as described with reference to FIG. 10. Additionally, or in the alternative, a method 900 of managing a workflow may include action chain management with respect to a workflow ensemble channel 400, for example, as described with reference to FIG. 11. Additionally, or in the alternative, a method 900 of managing a workflow may include workflow swarming with respect to a workflow ensemble channel 400, for example, as described with reference to FIG. 12.

### A. Generating Workflow Ensemble Channels

One example of a method 900 of managing a workflow may include one or more features described with reference to FIG. 9A. In one example, a method 900 of managing a workflow may include a method of generating a workflow ensemble channel 400 for one or more users, such as a method of generating a respectively distinctive and/or unique workflow ensemble channel 400 for respective ones of a plurality of users. One example of a method 900 of generating a workflow ensemble channel 400 may include one or more features described with reference to FIG. 9A. Additionally, or in the alternative, a method 900 of managing a workflow and/or generating a workflow ensemble channel 400 may include one or more features described with reference to FIGS. 9B-9J. For example, a method 900 of managing a workflow and/or generating a workflow ensemble channel 400 may include generating workflow content for a workflow ensemble channel 400, including generating, adding, removing, and/or updating workflow content with respect to the workflow ensemble channel 400, for example, as described with reference to FIGS. 9B-9J.

In at least one example, as described with reference to FIGS. 9B and 9C, a method 900 of managing a workflow and/or a method of generating a workflow ensemble channel 400 may include a method of generating, receiving, and/or updating at least one of: a workflow channel 402, or workflow content, and respectively adding or removing the workflow channel 402 or the workflow content from the workflow ensemble channel 400. For example, as described with reference to FIGS. 9D-9H, a method 900 of managing a workflow and/or a method of generating a workflow ensemble channel 400 may include a method of adding and/or removing from a workflow ensemble channel 400, at least one of: a workflow channel 402, a workflow thread 404, an action request 406, an action response 408, or a response status 410. Additionally, or in the alternative, as described with reference to FIGS. 9I and 9J, a method 900 of managing a workflow and/or a method of generating a workflow ensemble channel 400 may include a method of subscribing and/or unsubscribing one or more users from a workflow channel 402.

Referring to FIG. 9A, a method 900 of managing a workflow may include, at block 902, generating a workflow ensemble channel 400 for at least one user. The workflow ensemble channel 400 may be generated at least in part via a group-based communication system 100 and/or a workflow ensemble system 500. The workflow ensemble channel 400 may include a subset of workflow threads 404 from a plurality of workflow channels 402. The subset of workflow threads 404 for the user may be identified or otherwise generated based at least in part on one or more ensemble-relevance parameters 600, such as at least one thread-relevance parameter 604. At block 904, the method 900 may include providing the workflow ensemble channel 400 for display in a user interface 200 on a user computing device 401 of the at least one user.

In one example, a method 900 of managing a workflow may include, at block 906, determining an action request 406 associated with the user for a workflow thread 404 from among the subset of workflow threads 404. The action request 406 may be determined to satisfy at least one action-relevance parameter 606. The action request 406 may be determined at least in part via a group-based communication system 100 and/or a workflow ensemble system 500. At block 908, responsive to determining that the action request 406 satisfies the at least one action-relevance parameter 606, the method 900 may include providing the action request 406 for display in the workflow ensemble channel 400.

In one example, a method 900 of managing a workflow may include, at block 910, receiving an action response 408 to the action request 406. The action response 408 may be received via the group-based communication system 100 and/or the workflow ensemble system 500. At block 912, responsive to the action response 408, the method 900 may include updating a response status 410 for the action request 406. At block 914, the method 900 may include providing the response status 410 for display in the workflow ensemble channel 400.

As shown in FIG. 9B, a method 900 may include, at block 916, generating, receiving and/or updating a workflow channel 402. The workflow channel 402 may be generated, received and/or updated at least in part automatically by a group-based communication system 100 and/or a workflow ensemble system 500, and/or at least in part responsive to a user input from a user computing device 104 associated with the group-based communication system 100 and/or the workflow ensemble system 500. At block 918, the method 900 may include adding the workflow channel 402 to the workflow ensemble channel 400. The workflow channel 402 may be added to the workflow ensemble channel 400 responsive to generating, receiving, and/or updating the workflow channel 402, at block 916. Additionally, or in the alternative, at block 920, the method 900 may include generating, receiving and/or updating one or more items of workflow content. The one or more items of workflow content may include at least one of: a workflow thread 404, an action request 406, an action response 408, and/or a response status 410. The one or more items of workflow content may be generated, received and/or updated at least in part automatically by a group-based communication system 100 and/or a workflow ensemble system 500, and/or at least in part responsive to a user input from a user computing device 104 associated with the group-based communication system 100 and/or the workflow ensemble system 500. At block 922, the method 900 may include adding the workflow content to the workflow ensemble channel 400. The workflow content may be added to the workflow ensemble channel 400 responsive to adding the workflow channel 402 to the workflow ensemble channel 400, at block 918, and/or responsive to generating, receiving, and/or updating the workflow channel 402, at block 916.

In one example, the method 900 may include, at block 924, determining one or more workflow channels 402, and at block 926, determining whether a respective workflow channel 402 satisfies one or more ensemble-relevance parameters 600 associated with the workflow channel 402. As shown, a workflow channel 402 may be added to the workflow ensemble channel 400 at block 918 responsive to determining that the workflow channel 402 satisfies the one or more ensemble-relevance parameters 600 at block 926. Additionally, or in the alternative, responsive to determining that a workflow channel 402 does not satisfy the one or more ensemble-relevance parameters 600 at block 926, the method 900 may include determining another workflow channel 402 at block 924. Additionally, or in the alternative, another workflow channel 402 may be determined at block 924 responsive to adding a workflow channel 402 to the workflow ensemble channel 400 at block 918.

In one example, the method 900 may include, at block 928, determining one or more items of workflow content, and at block 930, determining whether a respective item of workflow content satisfies one or more ensemble-relevance parameters 600 associated with the workflow content. As shown, an item of workflow content may be added to the workflow ensemble channel 400 at block 922 responsive to determining that the item of workflow content satisfies one or more ensemble-relevance parameters 600 at block 930. Additionally, or in the alternative, responsive to determining that an item of workflow content does not satisfy one or more ensemble-relevance parameters 600 at block 930, the method 900 may include determining another item of workflow content at block 928. Additionally, or in the alternative, another item of workflow content may be determined at block 928 responsive to adding an item of workflow content to the workflow ensemble channel 400 at block 922.

In one example, the example method 900 described with reference to FIG. 9B may continue with and/or include one or more features described with reference to FIG. 9C, as indicated by block C. As shown in FIG. 9C, a method 900 may include removing one or more items of workflow content and/or one or more workflow channels 402 from a workflow ensemble channel 400. The one or more items of workflow content and/or the one or more workflow channels 402 may be removed responsive to an update to the respective workflow content or workflow channel 402, and/or responsive to determining that the respective workflow content or workflow channel 402 does not satisfy one or more ensemble-relevance parameters 600.

As shown in FIG. 9C, in one example, a method 900 may include generating, receiving, and/or updating an item of workflow content, at block 932. The item of workflow content may include a workflow thread 404, an action request 406, an action response 408, or a response status 410. The item of workflow content may be generated, received, and/or updated at least in part automatically by a group-based communication system 100 and/or a workflow ensemble system 500, and/or at least in part responsive to a user input from a user computing device 104 associated with the group-based communication system 100 and/or the workflow ensemble system 500. At block 934, the method 900 may include removing the item of workflow content from the workflow ensemble channel 400. The item of workflow content may be removed from the workflow ensemble channel 400 responsive to generating, receiving, and/or updating an item of workflow channel 402, at block 932. Additionally, or in the alternative, at block 936, the method 900 may include generating, receiving, and/or updating a workflow channel 402. The workflow channel 402 may be generated, received, and/or updated at least in part automatically by a group-based communication system 100 and/or a workflow ensemble system 500, and/or at least in part responsive to a user input from a user computing device 104 associated with the group-based communication system 100 and/or the workflow ensemble system 500. At block 938, the method 900 may include removing the workflow channel 402 from the workflow ensemble channel 400. The workflow channel 402 may be removed from the workflow ensemble channel 400 responsive to removing the item of workflow content from the workflow ensemble channel 400, at block 934, and/or responsive to generating, receiving, and/or updating the item of workflow content, at block 932.

In one example, method 900 may include, at block 940, determining one or more items of workflow content, and at block 942, determining whether a respective item of workflow content satisfies one or more ensemble-relevance parameters 600 associated with the workflow content. As shown, an item of workflow content may be removed from the workflow ensemble channel 400 at block 934 responsive to determining that the item of workflow content does not satisfy one or more ensemble-relevance parameters 600 at block 942. Additionally, or in the alternative, responsive to determining that an item of workflow content satisfies one or more ensemble-relevance parameters 600 at block 942, the method 900 may include determining another item of workflow content at block 940. Additionally, or in the alternative, another item of workflow content may be determined at block 940 responsive to removing an item of workflow content from the workflow ensemble channel 400 at block 934.

In one example, the method 900 may include, at block 946, determining one or more workflow channels 402, and at block 948, determining whether a respective workflow channel 402 satisfies one or more ensemble-relevance parameters 600 associated with the workflow channel 402. As shown, a workflow channel 402 may be removed from the workflow ensemble channel 400 at block 938 responsive to determining that the workflow channel 402 does not satisfy one or more ensemble-relevance parameters 600 at block 948. Additionally, or in the alternative, responsive to determining that a workflow channel 402 satisfies one or more ensemble-relevance parameters 600 at block 948, the method 900 may include determining another workflow channel 402 at block 946. Additionally, or in the alternative, another workflow channel 402 may be determined at block 946 responsive to removing a workflow channel 402 from the workflow ensemble channel 400 at block 938.

Referring to FIGS. 9D-9H, in one example method 900, adding an item of workflow content to a workflow ensemble channel 400 may prompt adding another item of workflow content to the workflow ensemble channel 400. Additionally, or in the alternative, removing an item of workflow content from a workflow ensemble channel 400 may prompt removing another item of workflow content to the workflow ensemble channel 400. Additionally, or in the alternative, adding a first item of workflow content to a workflow ensemble channel 400 may prompt removing a second item of workflow content from the workflow ensemble channel 400, and/or removing a third item of workflow content from a workflow ensemble channel 400 may prompt adding a fourth item of workflow content to the workflow ensemble channel 400.

As shown in FIGS. 9D-9H, an example method 900 may include determining whether a plurality of items of workflow content satisfy one or more ensemble-relevance parameters 600 according to a workflow content hierarchy. In one example, the workflow content hierarchy may include adding a workflow channel 402 to a workflow ensemble channel 400 prompting a determination as to whether one or more workflow threads 404 respectively satisfy one or more ensemble-relevance parameters 600. Additionally, or in the alternative, the workflow content hierarchy may include adding a workflow thread 404 to a workflow ensemble channel 400 prompting a determination as to whether one or more action requests 406 respectively satisfy one or more ensemble-relevance parameters 600. Additionally, or in the alternative, the workflow content hierarchy may include adding an action request 406 to a workflow ensemble channel 400 prompting a determination as to whether one or more action responses 408 respectively satisfy one or more ensemble-relevance parameters 600. Additionally, or in the alternative, the workflow content hierarchy may include adding an action response 408 to a workflow ensemble channel 400 prompting a determination as to whether one or more response statuses 410 respectively satisfy one or more ensemble-relevance parameters 600.

Additionally, or in the alternative, in one example, the workflow content hierarchy may include removing a response status 410 from a workflow ensemble channel 400 prompting a determination as to whether one or more action responses 408 respectively satisfy one or more ensemble-relevance parameters 600. Additionally, or in the alternative, the workflow content hierarchy may include removing a response status 410 from a workflow ensemble channel 400 prompting a determination as to whether one or more action responses 408 respectively satisfy one or more ensemble-relevance parameters 600. Additionally, or in the alternative, the workflow content hierarchy may include removing an action response 408 from a workflow ensemble channel 400 prompting a determination as to whether one or more action requests 406 respectively satisfy one or more ensemble-relevance parameters 600. Additionally, or in the alternative, the workflow content hierarchy may include removing an action request 406 from a workflow ensemble channel 400 prompting a determination as to whether one or more workflow threads 404 respectively satisfy one or more ensemble-relevance parameters 600. Additionally, or in the alternative, the workflow content hierarchy may include removing a workflow thread 404 from a workflow ensemble channel 400 prompting a determination as to whether one or more workflow channels 402 respectively satisfy one or more ensemble-relevance parameters 600.

As shown in FIG. 9D, in one example, the method 900 may include, at block 950, determining a workflow channel 402, and at block 951, determining whether the workflow channel 402 satisfies one or more ensemble-relevance parameters 600 associated with the workflow channel 402. The workflow channel 402 may be determined at block 951 periodically and/or responsive to a workflow channel 402 having been generated, received, and/or updated. In one example, the workflow channel 402 may be determined at least in part by a workflow data updater 512, such as a workflow data crawler 514, a workflow data listener 516, and/or a workflow data integrator 518 (FIG. 5). As shown, a workflow channel 402 may be added to the workflow ensemble channel 400 at block 952 responsive to determining that the workflow channel 402 satisfies the one or more ensemble-relevance parameters 600 at block 951. Additionally, or in the alternative, responsive to determining that the workflow channel 402 does not satisfy the one or more ensemble-relevance parameters 600 at block 951, the method 900 may include determining another workflow channel 402 at block 950. Additionally, or in the alternative, the method 900 may proceed to block 953 responsive to adding a workflow channel 402 to the workflow ensemble channel 400 at block 952.

In one example, as further shown in FIG. 9D, the method 900 may include, at block 953, determining a workflow thread 404, and at block 954, determining whether the workflow thread 404 satisfies one or more ensemble-relevance parameters 600 associated with the workflow thread 404. The workflow thread 404 may be determined at block 953 responsive to an item of workflow content being added to the workflow ensemble channel 400, such as responsive to a workflow channel 402 being added to the workflow ensemble channel 400 at block 952. Additionally, or in the alternative, workflow thread 404 may be determined at block 953 periodically and/or responsive to a workflow thread 404 having been generated, received, and/or updated. In one example, the workflow thread 404 may be determined at least in part by a workflow data updater 512, such as a workflow data crawler 514, a workflow data listener 516, and/or a workflow data integrator 518 (FIG. 5). As shown, a workflow thread 404 may be added to the workflow ensemble channel 400 at block 955 responsive to determining that the workflow thread 404 satisfies the one or more ensemble-relevance parameters 600 at block 954. Additionally, or in the alternative, responsive to determining that the workflow thread 404 does not satisfy the one or more ensemble-relevance parameters 600 at block 954, the method 900 may include determining another workflow thread 404 at block 953. Additionally, or in the alternative, the method 900 may continue with and/or include one or more features described with reference to FIG. 9E, as indicated by block E, responsive to adding a workflow thread 404 to the workflow ensemble channel 400 at block 955.

As shown in FIG. 9E, in one example, the method 900 may include, at block 956, determining an action request 406, and at block 957, determining whether the action request 406 satisfies one or more ensemble-relevance parameters 600 associated with the action request 406. The action request 406 may be determined at block 956 responsive to an item of workflow content being added to the workflow ensemble channel 400, such as responsive to a workflow thread 404 being added to the workflow ensemble channel 400 at block 955 (FIG. 9D). Additionally, or in the alternative, the action request 406 may be determined at block 956 periodically and/or responsive to an action request 406 having been generated, received, and/or updated. In one example, the action request 406 may be determined at least in part by a workflow data updater 512, such as a workflow data crawler 514, a workflow data listener 516, and/or a workflow data integrator 518 (FIG. 5). As shown, an action request 406 may be added to the workflow ensemble channel 400 at block 958 responsive to determining that the action request 406 satisfies the one or more ensemble-relevance parameters 600 at block 957. Additionally, or in the alternative, responsive to determining that the action request 406 does not satisfy the one or more ensemble-relevance parameters 600 at block 957, the method 900 may include determining another action request 406 at block 956. Additionally, or in the alternative, the method 900 may proceed to block 959 responsive to adding an action request 406 to the workflow ensemble channel 400 at block 958.

In one example, as further shown in FIG. 9E, the method 900 may include, at block 959, determining an action response 408, and at block 960, determining whether the action response 408 satisfies one or more ensemble-relevance parameters 600 associated with the action response 408. The action response 408 may be determined at block 959 responsive to an item of workflow content being added to the workflow ensemble channel 400, such as responsive to an action request 406 being added to the workflow ensemble channel 400 at block 958. Additionally, or in the alternative, the action response 408 may be determined at block 959 periodically and/or responsive to an action response 408 having been generated, received, and/or updated. In one example, the action response 408 may be determined at least in part by a workflow data updater 512, such as a workflow data crawler 514, a workflow data listener 516, and/or a workflow data integrator 518 (FIG. 5). As shown, an action response 408 may be added to the workflow ensemble channel 400 at block 961 responsive to determining that the action response 408 satisfies the one or more ensemble-relevance parameters 600 at block 960. Additionally, or in the alternative, responsive to determining that the action response 408 does not satisfy the one or more ensemble-relevance parameters 600 at block 960, the method 900 may include determining another action response 408 at block 959. Additionally, or in the alternative, the method 900 may continue with and/or include one or more features described with reference to FIG. 9F, as indicated by block F, responsive to adding an action response 408 to the workflow ensemble channel 400 at block 961.

As shown in FIG. 9F, in one example, the method 900 may include, at block 962, determining a response status 410, and at block 963, determining whether the response status 410 satisfies one or more ensemble-relevance parameters 600 associated with the response status 410. The response status 410 may be determined at block 962 responsive to an item of workflow content being added to the workflow ensemble channel 400, such as responsive to an action response 408 being added to the workflow ensemble channel 400 at block 961 (FIG. 9E). Additionally, or in the alternative, the response status 410 may be determined at block 962 periodically and/or responsive to a response status 410 having been generated, received, and/or updated. In one example, the response status 410 may be determined at least in part by a workflow data updater 512, such as a workflow data crawler 514, a workflow data listener 516, and/or a workflow data integrator 518 (FIG. 5). As shown, a response status 410 may be added to the workflow ensemble channel 400 at block 964 responsive to determining that the response status 410 satisfies the one or more ensemble-relevance parameters 600 at block 963. Additionally, or in the alternative, responsive to determining that the response status 410 does not satisfy the one or more ensemble-relevance parameters 600 at block 963, the method 900 may include determining another response status 410 at block 962. Additionally, or in the alternative, the method 900 may proceed to block 965 responsive to adding a response status 410 to the workflow ensemble channel 400 at block 964.

In one example, as further shown in FIG. 9F, the method 900 may include, at block 965 determining a response status 410, and at block 966, determining whether the response status 410 satisfies one or more ensemble-relevance parameters 600 associated with the response status 410. The response status 410 may be determined at block 965 responsive to an item of workflow content being added to the workflow ensemble channel 400, such as responsive to a response status 410 being added to the workflow ensemble channel 400 at block 964. Additionally, or in the alternative, the response status 410 may be determined at block 965 periodically and/or responsive to a response status 410 having been generated, received, and/or updated. In one example, the response status 410 may be determined at least in part by a workflow data updater 512, such as a workflow data crawler 514, a workflow data listener 516, and/or a workflow data integrator 518 (FIG. 5). As shown, a response status 410 may be removed from the workflow ensemble channel 400 at block 967 responsive to determining that the response status 410 does not satisfy the one or more ensemble-relevance parameters 600 at block 966. Additionally, or in the alternative, responsive to determining that the response status 410 satisfies the one or more ensemble-relevance parameters 600 at block 966, the method 900 may include determining another response status 410 at block 965. Additionally, or in the alternative, the method 900 may continue with and/or include one or more features described with reference to FIG. 9G, as indicated by block G, responsive to removing a response status 410 from the workflow ensemble channel 400 at block 967.

As shown in FIG. 9G, in one example, the method 900 may include, at block 968, determining an action response 408, and at block 969, determining whether the action response 408 satisfies one or more ensemble-relevance parameters 600 associated with the action response 408. The action response 408 may be determined at block 968 responsive to an item of workflow content being removed from the workflow ensemble channel 400, such as responsive to a response status 410 being removed from the workflow ensemble channel 400 at block 967 (FIG. 9F). Additionally, or in the alternative, the action response 408 may be determined at block 968 periodically and/or responsive to an action response 408 having been generated, received, and/or updated. In one example, the action response 408 may be determined at least in part by a workflow data updater 512, such as a workflow data crawler 514, a workflow data listener 516, and/or a workflow data integrator 518 (FIG. 5). As shown, an action response 408 may be removed from the workflow ensemble channel 400 at block 970 responsive to determining that the action response 408 does not satisfy the one or more ensemble-relevance parameters 600 at block 969. Additionally, or in the alternative, responsive to determining that the action response 408 satisfies the one or more ensemble-relevance parameters 600 at block 969, the method 900 may include determining another action response 408 at block 968. Additionally, or in the alternative, the method 900 may proceed to block 971 responsive to removing an action response 408 from the workflow ensemble channel 400 at block 970.

In one example, as further shown in FIG. 9G, the method 900 may include, at block 971 determining an action request 406, and at block 972, determining whether the action request 406 satisfies one or more ensemble-relevance parameters 600 associated with the action request 406. The action request 406 may be determined at block 971 responsive to an item of workflow content being removed from the workflow ensemble channel 400, such as responsive to an action response 408 being removed from the workflow ensemble channel 400 at block 970. Additionally, or in the alternative, the action request 406 may be determined at block 971 periodically and/or responsive to an action request 406 having been generated, received, and/or updated. In one example, the action request 406 may be determined at least in part by a workflow data updater 512, such as a workflow data crawler 514, a workflow data listener 516, and/or a workflow data integrator 518 (FIG. 5). As shown, an action request 406 may be removed from the workflow ensemble channel 400 at block 973 responsive to determining that the action request 406 does not satisfy the one or more ensemble-relevance parameters 600 at block 972. Additionally, or in the alternative, responsive to determining that the action request 406 satisfies the one or more ensemble-relevance parameters 600 at block 972, the method 900 may include determining another action request 406 at block 971. Additionally, or in the alternative, the method 900 may continue with and/or include one or more features described with reference to FIG. 9H, as indicated by block H, responsive to removing an action request 406 from the workflow ensemble channel 400 at block 973.

As shown in FIG. 9H, in one example, the method 900 may include, at block 974, determining a workflow thread 404, and at block 975, determining whether the workflow thread 404 satisfies one or more ensemble-relevance parameters 600 associated with the workflow thread 404. The workflow thread 404 may be determined at block 974 responsive to an item of workflow content being removed from the workflow ensemble channel 400, such as responsive to an action request 406 being removed from the workflow ensemble channel 400 at block 973 (FIG. 9G). Additionally, or in the alternative, the workflow thread 404 may be determined at block 974 periodically and/or responsive to a workflow thread 404 having been generated, received, and/or updated. In one example, the workflow thread 404 may be determined at least in part by a workflow data updater 512, such as a workflow data crawler 514, a workflow data listener 516, and/or a workflow data integrator 518 (FIG. 5). As shown, a workflow thread 404 may be removed from the workflow ensemble channel 400 at block 976 responsive to determining that the workflow thread 404 does not satisfy the one or more ensemble-relevance parameters 600 at block 975. Additionally, or in the alternative, responsive to determining that the workflow thread 404 satisfies the one or more ensemble-relevance parameters 600 at block 975, the method 900 may include determining another workflow thread 404 at block 974. Additionally, or in the alternative, the method 900 may proceed to block 977 responsive to removing a workflow thread 404 from the workflow ensemble channel 400 at block 976.

In one example, as further shown in FIG. 9H, the method 900 may include, at block 977 determining a workflow channel 402, and at block 978, determining whether the workflow channel 402 satisfies one or more ensemble-relevance parameters 600 associated with the workflow channel 402. The workflow channel 402 may be determined at block 977 responsive to an item of workflow content being removed from the workflow ensemble channel 400, such as responsive to a workflow thread 404 being removed from the workflow ensemble channel 400 at block 976. Additionally, or in the alternative, the workflow channel 402 may be determined at block 977 periodically and/or responsive to a workflow channel 402 having been generated, received, and/or updated. In one example, the workflow channel 402 may be determined at least in part by a workflow data updater 512, such as a workflow data crawler 514, a workflow data listener 516, and/or a workflow data integrator 518 (FIG. 5). As shown, a workflow channel 402 may be removed from the workflow ensemble channel 400 at block 979 responsive to determining that the workflow channel 402 does not satisfy the one or more ensemble-relevance parameters 600 at block 978. Additionally, or in the alternative, responsive to determining that the workflow channel 402 satisfies the one or more ensemble-relevance parameters 600 at block 978, the method 900 may include determining another workflow channel 402 at block 977. Additionally, or in the alternative, the method 900 may continue with and/or include one or more features described with reference to FIG. 9D, as indicated by block D, responsive to removing a workflow channel 402 from the workflow ensemble channel 400 at block 979.

Referring to FIGS. 9I and 9J, in one example, a method 900 of managing a workflow and/or a method of generating a workflow ensemble channel 400 for at least one user may include subscribing and/or unsubscribing the at least one user from a workflow channel 402. One or more features of subscribing and/or unsubscribing the at least one user from a workflow channel 402, such as described with reference to one or more of FIGS. 9I and 9J, may be included in block 902 described with reference to FIG. 9A.

As shown in FIG. 9I, a method 900 may include, at block 980, generating, receiving and/or updating a workflow channel 402. The workflow channel 402 may be generated, received and/or updated at least in part automatically by a group-based communication system 100 and/or a workflow ensemble system 500, and/or at least in part responsive to a user input from a user computing device 104 associated with the group-based communication system 100 and/or the workflow ensemble system 500. At block 981, the method 900 may include subscribing a user to the workflow channel 402, such as automatically subscribing the user to the workflow channel 402. The user may be subscribed to the workflow channel 402 at least in part automatically by a group-based communication system 100 and/or a workflow ensemble system 500, and/or at least in part responsive to a user input from a user computing device 104 associated with the group-based communication system 100 and/or the workflow ensemble system 500. In one example, the method 900 may include, at block 982, adding the workflow channel 402 to the workflow ensemble channel 400 associated with the user, for example, responsive to subscribing the user to the workflow channel 402 at block 981. The user may be subscribed to the workflow channel 402 at block 981, and/or the workflow channel 402 may be added to the workflow ensemble channel 400 associated with the user at block 982, responsive to generating, receiving, and/or updating the workflow channel 402, at block 980.

In one example, the method 900 may include, at block 983, determining one or more workflow channels 402, and at block 984, determining whether a respective workflow channel 402 satisfies one or more ensemble-relevance parameters 600 associated with the user. As shown, a user may be subscribed to a workflow channel 402 at block 981, and/or a workflow channel 402 may be added to the workflow ensemble channel 400 associated with the user at block 982, responsive to determining that the workflow channel 402 satisfies the one or more ensemble-relevance parameters 600 associated with the user at block 984. Additionally, or in the alternative, responsive to determining that a workflow channel 402 does not satisfy the one or more ensemble-relevance parameters 600 at block 984, the method 900 may include determining another workflow channel 402 at block 983. Additionally, or in the alternative, another workflow channel 402 may be determined at block 983 responsive to subscribing the user to a workflow channel 402 at block 981 and/or responsive to adding a workflow channel 402 to the workflow ensemble channel 400 associated with the user at block 982.

As further shown in FIG. 9I, in one example, a method 900 may include generating, receiving, and/or updating a workflow channel 402, at block 985. At block 986, the method 900 may include removing the workflow channel 402 from the workflow ensemble channel 400. In one example, the method 900 may include, at block 987, unsubscribing a user from the workflow channel 402, such as automatically unsubscribing the user from the workflow channel 402. The user may be unsubscribed from the workflow channel 402 at least in part automatically by a group-based communication system 100 and/or a workflow ensemble system 500, and/or at least in part responsive to a user input from a user computing device 104 associated with the group-based communication system 100 and/or the workflow ensemble system 500. The user may be unsubscribed from the workflow channel 402 at block 987, for example, responsive to removing the workflow channel 402 from the workflow ensemble channel 400 at block 981. Additionally, or in the alternative, the workflow channel 402 may be removed from the workflow ensemble channel 400 associated with the user at block 986, and/or the user may be unsubscribed to the workflow channel 402 at block 987, responsive to generating, receiving, and/or updating the workflow channel 402, at block 985. In one example, the method 900 may include, at block 988, determining one or more workflow channels 402, and at block 989, determining whether a respective workflow channel 402 satisfies one or more ensemble-relevance parameters 600 associated with the user. As shown, a workflow channel 402 may be removed from the workflow ensemble channel 400 associated with the user at block 986, and/or the user may be unsubscribed from the workflow channel 402 at block 987, responsive to determining that the workflow channel 402 does not satisfy the one or more ensemble-relevance parameters 600 associated with the user at block 989. Additionally, or in the alternative, responsive to determining that a workflow channel 402 satisfies the one or more ensemble-relevance parameters 600 associated with the user at block 989, the method 900 may include determining another workflow channel 402 at block 988. Additionally, or in the alternative, another workflow channel 402 may be determined at block 988 responsive to removing a workflow channel 402 from the workflow ensemble channel 400 at block 986, and/or responsive to unsubscribing the user from the workflow channel 402 at block 987.

In one example, the example method 900 described with reference to FIG. 9I may continue with and/or include one or more features described with reference to FIG. 9J, as indicated by block J. The example method 900 may continue and/or include one or more features described with reference to FIG. 9J responsive subscribing a user to a workflow channel 402 at block 981, and/or responsive unsubscribing a user from a workflow channel 402 at block 987. Additionally, or in the alternative, the example method 900 may continue and/or include one or more features described with reference to FIG. 9J responsive to adding a workflow channel 402 to a workflow ensemble channel 400 associated with a user at block 982, and/or responsive to removing a workflow channel 402 from a workflow ensemble channel 400 associated with a user at block 986. As shown in FIG. 9J, a method 900 may include subscribing and/or unsubscribing a user with respect to a workflow channel 402 responsive to generating, receiving, and/or updating one or more items of workflow content, responsive to a determination as to whether the respective item of workflow content satisfies one or more ensemble-relevance parameters 600 associated with the user, and/or responsive to adding or removing the one or more items of workflow content with respect to a workflow ensemble channel 400 associated with the user.

In at least one example, as shown in FIG. 9J, a method 900 may include, at block 990, generating, receiving and/or updating one or more items of workflow content. The one or more items of workflow content may be generated, received and/or updated at least in part automatically by a group-based communication system 100 and/or a workflow ensemble system 500, and/or at least in part responsive to a user input from a user computing device 104 associated with the group-based communication system 100 and/or the workflow ensemble system 500. The one or more items of workflow content may include at least one of: a workflow thread 404, an action request 406, an action response 408, and/or a response status 410. At block 991, the method 900 may include subscribing a user to at least one workflow channel 402, such as automatically subscribing the user to the at least one workflow channel 402. The user may be subscribed to the at least one workflow channel 402 at least in part automatically by a group-based communication system 100 and/or a workflow ensemble system 500, and/or at least in part responsive to a user input from a user computing device 104 associated with the group-based communication system 100 and/or the workflow ensemble system 500. In one example, the method 900 may include, at block 992, adding the workflow channel 402 to the workflow ensemble channel 400 associated with the user, for example, responsive to subscribing the user to the workflow channel 402 at block 991. The user may be subscribed to the workflow channel 402 at block 991, and/or the workflow channel 402 may be added to the workflow ensemble channel 400 associated with the user at block 992, responsive to generating, receiving, and/or updating the one or more items of workflow content, at block 990.

In one example, method 900 may include, at block 993, determining an item of workflow content, and at block 994, determining whether the item of workflow content satisfies one or more ensemble-relevance parameters 600 associated with the user. As shown, a user may be subscribed to a workflow channel 402 at block 991, and/or a workflow channel 402 may be added to the workflow ensemble channel 400 associated with the user at block 992, responsive to determining that the item of workflow content satisfies the one or more ensemble-relevance parameters 600 associated with the user at block 994. Additionally, or in the alternative, responsive to determining that a workflow channel 402 does not satisfy the one or more ensemble-relevance parameters 600 associated with the user at block 994, the method 900 may include determining another item of workflow content at block 993. Additionally, or in the alternative, another item of workflow content may be determined at block 993 responsive to subscribing the user to a workflow channel 402 at block 991 and/or responsive to adding a workflow channel 402 to the workflow ensemble channel 400 associated with the user at block 992.

As further shown in FIG. 9J, in one example, a method 900 may include generating, receiving, and/or updating one or more items of workflow content, at block 995. At block 996, the method 900 may include removing one or more items of workflow content from a workflow ensemble channel 400 associated with the user. In one example, the method 900 may include, at block 997, unsubscribing the user from the workflow channel 402, such as automatically unsubscribing the user from the workflow channel 402. The user may be unsubscribed from the workflow channel 402 at least in part automatically by a group-based communication system 100 and/or a workflow ensemble system 500, and/or at least in part responsive to a user input from a user computing device 104 associated with the group-based communication system 100 and/or the workflow ensemble system 500. The user may be unsubscribed from the workflow channel 402 at block 997, for example, responsive to removing the workflow content from the workflow ensemble channel 400 at block 991. Additionally, or in the alternative, the workflow content may be removed from the workflow ensemble channel 400 associated with the user at block 996, and/or the user may be unsubscribed to the workflow channel 402 at block 997, responsive to generating, receiving, and/or updating the workflow channel 402, at block 995. In one example, method 900 may include, at block 998, determining one or more items of workflow content, and at block 999, determining whether a respective item of workflow content satisfies one or more ensemble-relevance parameters 600 associated with the user. As shown, an item of workflow content may be removed from the workflow ensemble channel 400 associated with the user at block 996, and/or the user may be unsubscribed from a workflow channel 402 at block 997, responsive to determining that the respective item of workflow content does not satisfy the one or more ensemble-relevance parameters 600 associated with the user at block 999. Additionally, or in the alternative, responsive to determining that a respective item of workflow content satisfies the one or more ensemble-relevance parameters 600 associated with the user at block 999, the method 900 may include determining another item of workflow content at block 998. Additionally, or in the alternative, another item of workflow content may be determined at block 998 responsive to removing an item of workflow content from the workflow ensemble channel 400 associated with the user at block 996, and/or responsive to unsubscribing the user from the workflow channel 402 at block 997.

In one example, the example method 900 described with reference to FIG. 9J may continue with and/or include one or more features described with reference to FIG. 9I, as indicated by block I. The example method 900 may continue and/or include one or more features described with reference to FIG. 9I responsive subscribing a user to a workflow channel 402 at block 991, and/or responsive unsubscribing a user from a workflow channel 402 at block 997. Additionally, or in the alternative, the example method 900 may continue and/or include one or more features described with reference to FIG. 9I responsive to adding a workflow channel 402 to a workflow ensemble channel 400 associated with a user at block 992, and/or responsive to removing a workflow channel 402 from a workflow ensemble channel 400 associated with a user at block 996.

### B. User Subscription Management

Referring to FIG. 10, a method 900 of managing a workflow may include a method 1000 of user subscription management. As shown, a method 1000 of user subscription management may include subscribing and/or unsubscribing users with respect to workflow channels 402 based at least in part on one or more ensemble-relevance parameters 600. Additionally, or in the alternative, as shown, a method 1000 of user subscription management may include adding and/or removing workflow content with respect to a workflow ensemble channel 400 associated with a respective user based at least in part on one or more ensemble-relevance parameters 600.

As shown in FIG. 10, subscribing and/or unsubscribing a user with respect to a workflow channel 402 may prompt additionally subscribing and/or unsubscribing another one or more users with respect to the workflow channel 402 and/or with respect to another one or more workflow channels 402. Additionally, or in the alternative, subscribing and/or unsubscribing a user with respect to a workflow channel 402 may prompt adding and/or removing workflow content with respect to a workflow ensemble channel 400 associated with the user and/or with respect to another one or more users. Additionally, or in the alternative, adding and/or removing workflow content with respect to a workflow ensemble channel 400 may prompt additionally adding and/or removing workflow content with respect to another one or more workflow ensemble channels 400. Additionally, or in the alternative, adding and/or removing workflow content with respect to a workflow ensemble channel 400 may prompt subscribing and/or unsubscribing one or more users with respect to one or more workflow channels 402.

In one example, as shown in FIG. 10, a method 1000 may include, at block 1002, generating, receiving, and/or updating workflow content. Workflow content that has been generated and/or updated may be determined at block 1002 at least in part by a workflow data updater 512, such as a workflow data crawler 514, a workflow data listener 516, and/or a workflow data integrator 518 (FIG. 5). At block 1004, the method 1000 may include determining one or more workflow channels 402 associated with the workflow content, and at block 1006, the method 1000 may include determining one or more users associated with the respective workflow channel 402 and/or one or more workflow ensemble channels 400 associated with the respective workflow channel 402. For a respective user, and/or for a respective workflow ensemble channel 400, the method 1000 may include, at block 1008, determining whether the workflow content satisfies one or more ensemble relevance parameters 600.

In one example, as shown, at block 1010, a user may be subscribed to a workflow channel 402 responsive to determining that the workflow content associated with the workflow channel 402 satisfies the one or more ensemble-relevance parameters 600 at block 1008. Additionally, or in the alternative, at block 1012, the workflow channel 402 and/or the workflow content may be added to a workflow ensemble channel 400 associated with the user responsive to determining that the workflow content associated with the workflow channel 402 satisfies the one or more ensemble-relevance parameters 600 at block 1008. After subscribing the user to the workflow channel 402 at block 1010, and/or after adding the workflow channel 402 and/or workflow content to the workflow ensemble channel 400 at block 1012, the method 1000 may include determining another user and/or another workflow ensemble channel 400 associated with the respective workflow channel 402, at block 1006. Additionally, or in the alternative, the method 1000 may include determining another workflow channel 402 associated with the workflow content, at block 1004.

In one example, as shown, at block 1014, a user may be unsubscribed from a workflow channel 402 responsive to determining that the workflow content associated with the workflow channel 402 does not satisfy the one or more ensemble-relevance parameters 600 at block 1008. Additionally, or in the alternative, at block 1016, the workflow channel 402 and/or the workflow content may be removed from a workflow ensemble channel 400 associated with the user responsive to determining that the workflow content associated with the workflow channel 402 does not satisfy the one or more ensemble-relevance parameters 600 at block 1008. After removing the workflow channel 402 and/or workflow content from the workflow ensemble channel 400 at block 1014, and/or after unsubscribing the user from the workflow channel 402 at block 1016, the method 1000 may include determining another user and/or another workflow ensemble channel 400 associated with the respective workflow channel 402, at block 1006. Additionally, or in the alternative, the method 1000 may include determining another workflow channel 402 associated with the workflow content, at block 1004.

### C. Action Chains

Referring to FIG. 11, a method 900 of managing a workflow may include a method 1100 of action chain management. As shown, a method of action chain management may include adding and/or removing action requests 406 (and/or an action response 408 and/or a response status 410) with respect to workflow ensemble channels 400 associated with respective users based at least in part on one or more ensemble-relevance parameters 600. Additionally, or in the alternative, as shown, a method 1100 of action chain management may include subscribing and/or unsubscribing users with respect to workflow channels 402 associated with an action request 406 (and/or an action response 408 and/or a response status 410) based at least in part on one or more ensemble-relevance parameters 600.

As shown in FIG. 11, a user may be subscribed and/or unsubscribed with respect to a workflow channel 402 based at least in part on an action request 406 corresponding to a link in an action chain 428 (FIG. 4C) satisfying one or more ensemble-relevance parameters 600. Additionally, or in the alternative, workflow content, such as an action request 406 (and/or an action response 408 and/or a response status 410) may be added and/or removed with respect to a workflow ensemble channel 400 associated with a respective user based at least in part on an action request 406 corresponding to a link in an action chain 428 satisfying one or more ensemble-relevance parameters 600. In one example, subscribing and/or unsubscribing a user with respect to an action request 406 corresponding to a link in an action chain 428 may prompt additionally subscribing and/or unsubscribing another one or more users with respect to another one or more action requests 406 corresponding to the link in the action chain 428 and/or another one or more links in the action chain 428. Additionally, or in the alternative, adding and/or removing workflow content such as an action request 406 with respect to a workflow ensemble channel 400 associated with a user may prompt additionally adding and/or removing additional workflow content such as another one or more action requests 406 with respect to another one or more workflow ensemble channels 400 respectively associated with another one or more users.

In one example, as shown in FIG. 11, a method 1100 may include, at block 1102, generating, receiving, and/or updating workflow content, such as an action request 406 (and/or an action response 408 and/or a response status 410). Workflow content that has been generated and/or updated may be determined at block 1102 at least in part by a workflow data updater 512, such as a workflow data crawler 514, a workflow data listener 516, and/or a workflow data integrator 518 (FIG. 5). At block 1104, the method 1100 may include determining an action chain 428 and/or a link in an action chain 428 associated with the workflow content, such as the action request 406, and at block 1106, the method 1100 may include determining one or more users associated with the link in an action chain 428 and/or one or more workflow ensemble channels 400 associated with the link in an action chain 428. Block 1104 may additionally include determining a workflow channel 402 associated with the action chain 428. For a respective user, and/or for a respective workflow ensemble channel 400, the method 1100 may include, at block 1108, determining whether the workflow content, such as the action request 406, satisfies one or more ensemble relevance parameters 600.

In one example, as shown, at block 1110, a user may be subscribed to a workflow channel 402 responsive to determining that the workflow content, such as the action request 406, associated with the action chain 428 and/or the link in the action chain 428 satisfies the one or more ensemble-relevance parameters 600 at block 1108. Additionally, or in the alternative, at block 1112, the workflow channel 402 and/or the workflow content, such as the action request 406, associated with the action chain 428 and/or the link in the action chain 428 may be added to the workflow ensemble channel 400 associated with the respective user responsive to determining that the one or more ensemble-relevance parameters 600 are satisfied at block 1108. After subscribing the user to the workflow channel 402 at block 1110, and/or after adding the workflow channel 402 and/or workflow content to the workflow ensemble channel 400 at block 1112, the method 1100 may include determining another user and/or another workflow ensemble channel 400, at block 1106. Additionally, or in the alternative, the method 1100 may include determining another action chain 428 and/or another link in the action chain 428, at block 1104.

In one example, as shown, at block 1114, a workflow channel 402 and/or workflow content, such as an action request 406, associated with an action chain 428 and/or a link in the action chain 428 may be removed from a workflow ensemble channel 400 associated with a respective user responsive to determining that the workflow content, such as the action request 406, associated with the action chain 428 and/or the link in the action chain 428 does not satisfy the one or more ensemble-relevance parameters 600 at block 1108. Additionally, or in the alternative, at block 1116, a user may be unsubscribed from a workflow channel 402 responsive to determining that the one or more ensemble-relevance parameters 600 are not satisfied at block 1108. After removing the workflow channel 402 and/or workflow content from the workflow ensemble channel 400 at block 1114, and/or after unsubscribing the user from the workflow channel 402 at block 1116, the method 1100 may include determining another user and/or another workflow ensemble channel 400, at block 1106. Additionally, or in the alternative, the method 1100 may include determining another action chain 428 and/or another link in the action chain 428, at block 1104.

### D. Workflow Swarming

Referring to FIG. 12, a method 900 of managing a workflow may include a method 1200 of workflow swarming. As shown, a method 1200 of workflow swarming may include determining a swarming indication based at least in part on an item of workflow content, and generating additional items of workflow content, such as workflow channels 402 and/or action requests responsive to the swarming indication. The swarming indication may include a prompt to assemble a swarm of users. The swarming indication may include a prompt to generate a workflow channel 402 and/or a workflow thread 404 for swarming with respect to a topic of interest, a prompt to identify a plurality of users possessing relevant subject matter expertise pertaining to the topic of interest, and/or a prompt to generate one or more action requests 406 for swarming with respect to a topic of interest. The action requests 406 may include an invitation to join the swarm and/or a task associated with the swarm. Additionally, or in the alternative, as shown, a method 1200 of workflow swarming may include subscribing and/or unsubscribing users with respect to workflow channels 402 associated with swarming based at least in part on one or more ensemble-relevance parameters 600.

As shown in FIG. 12, a user may be subscribed and/or unsubscribed with respect to a workflow channel 402 based at least in part on a swarming indication and/or workflow content associated with a swarming indication satisfying one or more ensemble-relevance parameters 600. Additionally, or in the alternative, workflow content may be added and/or removed with respect to a workflow ensemble channel 400 associated with a respective user based at least in part on a swarming indication and/or workflow content associated with a swarming indication satisfying one or more ensemble-relevance parameters 600. In one example, subscribing and/or unsubscribing a user with respect to an action request 406 corresponding to a swarming indication and/or workflow content associated with a swarming indication may prompt additionally subscribing and/or unsubscribing another one or more users with respect to the swarming indication and/or workflow content associated with the swarming indication. Additionally, or in the alternative, adding and/or removing workflow content to a workflow ensemble channel 400 associated with a user responsive to the swarming indication may prompt adding and/or removing additional workflow content with respect to another one or more workflow ensemble channels 400 respectively associated with another one or more users.

In one example, as shown in FIG. 12, a method 1200 may include, at block 1202, generating, receiving, and/or updating workflow content, and at block 1204, the method 1200 may include determining a swarming indication associated with the workflow content. The swarming indication may indicate that swarming is being requested and/or that one or more users are being invited to swarm with respect to the workflow content. The workflow content may include an action request 406 and the swarm may be requested at least in part for the purpose of responding to the action request. The users invited to the swarm may be selected based at least in part on the nature of the action request 406. For example, one or more subject matter parameters may be associated with the swarming indication. The subject matter parameters may identify one or more areas of subject matter expertise requested for the swarm. One or more users may be associated with one or more subject matter parameters, for example, based at least in part on capabilities of a respective user with respect to one or more areas of subject matter expertise. One or more users may be identified, selected, and/or invented to the swarm based at least in part on the one or more subject matter parameters associated with the respective user. The workflow content, subject matter parameters, and/or users associated with the swarming indication may be determined at block 1202 or 1204, respectively, at least in part by a workflow data updater 512, such as a workflow data crawler 514, a workflow data listener 516, and/or a workflow data integrator 518 (FIG. 5).

In one example, at block 1206, the method 1200 may include generating a workflow channel 402 responsive to the swarming indication determined at block 1204. The workflow channel 402 may be generated at least in part for swarming activities associated with the swarming indication, such as for messages and/or communications among users participating in the swarm. Additionally, or in the alternative, the method 1200 may include, at block 1208, generating one or more action requests 406 and/or other workflow content responsive to the swarming indication determined at block 1204. The one or more action requests 406 and/or other workflow content may be generated at least in part for swarming activities associated with the swarming indication. For example, an action request 406 generated at block 1208 responsive to the swarming indication may include an invitation to the swarm. Additionally, or in the alternative, an action request 406 generated at block 1208 responsive to the swarming indication may include a task to be performed in connection with the swarm.

In one example, the method 1200 may include, and at block 1210, determining one or more users and/or one or more workflow ensemble channels 400 associated with the swarming indication determined at block 1204. Block 1210 may additionally include determining a workflow channel 402, an action request 406, and/or other workflow content respectively generated at block 1206 or block 1208 responsive to the swarming indication. For a respective user, and/or for a respective workflow ensemble channel 400, the method 1200 may include, at block 1212, determining whether the swarming indication and/or workflow content satisfies one or more ensemble relevance parameters 600.

In one example, as shown, at block 1214, a user may be subscribed to a workflow channel 402 responsive to determining that the swarming indication and/or workflow content satisfies the one or more ensemble-relevance parameters 600 at block 1212. Additionally, or in the alternative, at block 1216, the workflow channel 402, the action request 406, and/or the other workflow content associated with the swarming indication may be added to the workflow ensemble channel 400 associated with the respective user responsive to determining that the one or more ensemble-relevance parameters 600 are satisfied at block 1212. After subscribing the user to the workflow channel 402 at block 1214, and/or after adding the workflow channel 402, action request 406, and/or workflow content to the workflow ensemble channel 400 at block 1216, the method 1200 may include determining another user and/or another workflow ensemble channel 400, at block 1210.

In one example, as shown, at block 1218, a workflow channel 402, and action request 406, and/or other workflow content associated with the swarming indication may be removed from a workflow ensemble channel 400 associated with a respective user responsive to determining that the swarming indication and/or workflow content satisfies the one or more ensemble-relevance parameters 600 at block 1212. Additionally, or in the alternative, at block 1220, a user may be unsubscribed from a workflow channel 402 responsive to determining that the one or more ensemble-relevance parameters 600 are not satisfied at block 1212. After removing the workflow channel 402 and/or workflow content from the workflow ensemble channel 400 at block 1218, and/or after unsubscribing the user from the workflow channel 402 at block 1220, the method 1200 may include determining another user and/or another workflow ensemble channel 400, at block 1210.

Having thus described various embodiments of the invention, what is claimed as new and desired to be protected by Letters Patent includes the following:

1. A method of managing a workflow, the method comprising:
generating a workflow ensemble channel for a user comprising a subset of workflow threads from a plurality of workflow channels, the subset of workflow threads for the user based on at least one channel-relevance parameter,
wherein the user to has been automatically subscribed to the plurality of workflow channels based on the at least one channel-relevance parameter;
providing the workflow ensemble channel for display in a group-based communication system interface on a client device of the user;
receiving an action request associated with the user for a workflow thread of the subset of workflow threads;
responsive to determining that the action request satisfies at least one action-relevance parameter, providing the action request for display in the workflow ensemble channel,
receiving, from the user and via the group-based communication system interface, a user action response to the action request;
responsive to the user action response, updating a response status for the action request; and
providing the response status for display in the workflow ensemble channel.

2. The method of claim 1, wherein the action request is further provided for display in a workflow channel associated with the workflow thread.

3. The method of claim 1, further comprising:
responsive to the user action response, automatically causing the user to be unsubscribed from a workflow channel associated with the workflow thread.

4. The method of claim 1, further comprising:
determining a swarming indication based on group-based communication system content; and
generating the action request responsive to the swarming indication,
wherein the action request comprises an invitation for the user to join a swarm associated with at least one of the plurality of workflow channels.

5. The method of claim 1, further comprising:
responsive to the user action response, determining a next action request associated with an additional user, wherein the next action request satisfies at an additional action-relevance parameter associated with the additional user; and
responsive to determining that the next action request satisfies the additional action-relevance parameter, providing the next action request for display in an additional workflow ensemble channel, the additional workflow ensemble channel having been generated for the additional user,
wherein the additional workflow ensemble channel comprises the workflow thread, and
wherein the action request defines a link in an action chain associated with the workflow and the next action request defines an additional link in the action chain.

6. The method of claim 5, further comprising:
receiving, from the additional user and via the group-based communication system interface, a next action response responsive to the next action request;
responsive to the next action response, updating a next response status for the next action request;
providing the next response status for display in the workflow ensemble channel for the user; and
providing the next response status for display in the additional workflow ensemble channel for the additional user.

7. The method of claim 1, wherein the action request comprises a request to approve or reject deal terms.

8. A workflow management system, comprising:
at least one processor; and
one or more non-transitory computer-readable media storing computer-executable instructions that, when executed, cause the at least one processor to perform a method of managing a workflow, the method comprising:
generating a workflow ensemble channel for a user comprising a subset of workflow threads from a plurality of workflow channels, the subset of workflow threads for the user based on at least one channel-relevance parameter,
wherein the user to has been automatically subscribed to the plurality of workflow channels based on the at least one channel-relevance parameter;
providing the workflow ensemble channel for display in a group-based communication system interface on a client device of the user;
receiving an action request associated with the user for a workflow thread of the subset of workflow threads;
responsive to determining that the action request satisfies at least one action-relevance parameter, providing the action request for display in the workflow ensemble channel,
receiving, from the user and via the group-based communication system interface, a user action response to the action request;
responsive to the user action response, updating a response status for the action request; and
providing the response status for display in the workflow ensemble channel.

9. The workflow management system of claim 8, wherein the action request is further provided for display in a workflow channel associated with the workflow thread.

10. The workflow management system of claim 8, the method further comprising:
responsive to the user action response, automatically causing the user to be unsubscribed from a workflow channel associated with the workflow thread.

11. The workflow management system of claim 8, the method further comprising:
determining a swarming indication based on group-based communication system content; and
generating the action request responsive to the swarming indication,
wherein the action request comprises an invitation for the user to join a swarm associated with at least one of the plurality of workflow channels.

12. The workflow management system of claim 8, the method further comprising:
responsive to the user action response, determining a next action request associated with an additional user, wherein the next action request satisfies at an additional action-relevance parameter associated with the additional user; and
responsive to determining that the next action request satisfies the additional action-relevance parameter, providing the next action request for display in an additional workflow ensemble channel, the additional workflow ensemble channel having been generated for the additional user,
wherein the additional workflow ensemble channel comprises the workflow thread, and
wherein the action request defines a link in an action chain associated with the workflow and the next action request defines an additional link in the action chain.

13. The workflow management system of claim 12, the method further comprising:
receiving, from the additional user and via the group-based communication system interface, a next action response responsive to the next action request;
responsive to the next action response, updating a next response status for the next action request;
providing the next response status for display in the workflow ensemble channel for the user; and
providing the next response status for display in the additional workflow ensemble channel for the additional user.

14. The workflow management system of claim 8, wherein the action request comprises a request to approve or reject deal terms.

15. One or more non-transitory computer-readable media storing computer-executable instructions that, when executed, cause at least one processor to perform a method of managing a workflow, the method comprising:
generating a workflow ensemble channel for a user comprising a subset of workflow threads from a plurality of workflow channels, the subset of workflow threads for the user based on at least one channel-relevance parameter,
wherein the user to has been automatically subscribed to the plurality of workflow channels based on the at least one channel-relevance parameter;
providing the workflow ensemble channel for display in a group-based communication system interface on a client device of the user;
receiving an action request associated with the user for a workflow thread of the subset of workflow threads;
responsive to determining that the action request satisfies at least one action-relevance parameter, providing the action request for display in the workflow ensemble channel,
receiving, from the user and via the group-based communication system interface, a user action response to the action request;
responsive to the user action response, updating a response status for the action request; and
providing the response status for display in the workflow ensemble channel.

16. The one or more non-transitory computer-readable media of claim 15, the method further comprising:
responsive to the user action response, automatically causing the user to be unsubscribed from a workflow channel associated with the workflow thread.

17. The one or more non-transitory computer-readable media of claim 15, the method further comprising:
determining a swarming indication based on group-based communication system content; and
generating the action request responsive to the swarming indication,
wherein the action request comprises an invitation for the user to join a swarm associated with at least one of the plurality of workflow channels.

18. The one or more non-transitory computer-readable media of claim 15, the method further comprising:
responsive to the user action response, determining a next action request associated with an additional user, wherein the next action request satisfies at an additional action-relevance parameter associated with the additional user; and
responsive to determining that the next action request satisfies the additional action-relevance parameter, providing the next action request for display in an additional workflow ensemble channel, the additional workflow ensemble channel having been generated for the additional user,
wherein the additional workflow ensemble channel comprises the workflow thread, and
wherein the action request defines a link in an action chain associated with the workflow and the next action request defines an additional link in the action chain.

19. The one or more non-transitory computer-readable media of claim 18, the method further comprising:
receiving, from the additional user and via the group-based communication system interface, a next action response responsive to the next action request;
responsive to the next action response, updating a next response status for the next action request;
providing the next response status for display in the workflow ensemble channel for the user; and
providing the next response status for display in the additional workflow ensemble channel for the additional user.

20. The one or more non-transitory computer-readable media of claim 15, wherein the action request comprises a request to approve or reject deal terms.
